(19) United States
(12) Patent Application Publication
(10) Pub. No.: US 2026/0059267 A1
(43) Pub. Date: Feb. 26, 2026

(54) METHODS AND APPARATUS FOR IMPLEMENTING LOCATION SHARING USING RICH COMMUNICATION SERVICES

(71) Applicant: Charter Communications Operating, LLC, St. Louis, MO (US)

(72) Inventors: Vinayak K. Thotton Veettil, Parker, CO (US); William K. Logan, Overland Park, KS (US)

(21) Appl. No.: 18/826,076

(22) Filed: Sep. 5, 2024

Related U.S. Application Data
(60) Provisional application No. 63/686,925, filed on Aug. 26, 2024.

(51) Int. Cl. H04W 4/029; H04W 4/12

(52) U.S. Cl. CPC H04W 4/029; H04W 4/12

(57) ABSTRACT

The present invention relates to methods and apparatus for implementing location sharing using Rich Communications Services. An exemplary method includes the steps of: generating, at a first communications device, location information for the first communications device; and determining, by the first communications device, whether or not to share the location information for the first communications device with a second communications device based on one or more Rich Communications Services (RCS) location sharing criteria. In some embodiments, the method further includes the step of sharing the location information with the second communications device using Rich Communications Services messaging in response to determining, by the first communications device, to share the location information for the first communications device with the second communications device based on the one or more Rich Communications Services (RCS) location sharing criteria.

### RELATED APPLICATIONS

The present application claims the benefit of U.S. Provisional Patent Application Ser. No. 63/686,925 which was filed on Aug. 26, 2024. The aforementioned application is hereby expressly incorporated by reference in its entirety.

### FIELD OF INVENTION

The present invention relates to methods and apparatus for implementing location sharing using Rich Communications Services.

### BACKGROUND OF THE INVENTION

End user devices which support Rich Communications Services (RCS) protocol are capable of initiating, maintaining, and modifying a Rich Communications Services (RCS) session. These RCS sessions can be utilized to share and update a user's location with other user devices which are part of the session. However, the management of when, how, and to whom, a user's location information should be shared and what particular information should be shared using the RCS protocol is not well defined. Also there is a need for determining how RCS location sharing can be implemented to minimize impacts on the devices and networks which use location sharing services.

From the foregoing, it should be understood that there is a need for new and/or improved methods and/or apparatus for managing the sharing of end user devices' and/or users' location information using the RCS protocol. There is a further need for new and/or improved apparatus and/or methods which determine criteria and/or rules for when, how, and to whom RCS location information sharing among devices should be implemented. There is a further need for new and/or improved methods and apparatus for using RCS location sharing in connection with providing emergency services. There is a further need for new and/or improved methods and/or apparatus for implementing regulatory policies and/or network policies and/or government policies and/or user policies with respect to sharing a user/devices location information especially when the policies may conflict.

### SUMMARY OF THE INVENTION

The present invention provides new and/or improved methods and apparatus for implementing location sharing using Rich Communications Services. Various embodiments of the present invention provide new and/or improved methods and/or apparatus for managing the sharing of end user devices' and/or users' location information using the RCS protocol. Various embodiments of the present invention provide new and/or improved apparatus and/or methods which determine criteria and/or rules for when, how, and to whom RCS location information sharing among devices is implemented. Various embodiments of the present invention also provide new and/or improved methods and/or apparatus from optimizing and/or improving network efficiency and operation, device efficiency and operation, and user RCS location sharing experiences by collecting and analyzing RCS sharing data and generating and/or updating rules, criteria, weighting and threshold used to make determinations on when, who and to whom RCS location information should be shared. Various embodiments of the present invention also provide new and/or improved methods and apparatus for communicating RCS location sharing information using, modifying and/or adapting Session Initiation Protocol messages, Session Description Protocol messages, and/or Message Session Relay Protocol messages. Various embodiments of the present invention solve one or more of the problems discussed above.

An exemplary method in accordance with one embodiment of the present invention includes the steps of: generating, at a first communications device, location information for the first communications device; and determining, by the first communications device, whether or not to share said location information for the first communications device with a second communications device based on one or more Rich Communications Services (RCS) location sharing criteria. In some embodiments, the method further includes the additional steps of: detecting the occurrence of an event at the first communications device; and in response to detecting the occurrence of the event at the first communications device, performing said operation of determining, by the first communications device, whether or not to share said location information for the first communications device with a second communications device based on one or more Rich Communications Services (RCS) location sharing criteria.

In some embodiments, the method further includes the step of: sharing said location information with said second communications device using Rich Communications Services messaging in response to determining, by the first communications device, to share said location information for the first communications device with the second communications device based on said one or more Rich Communications Services (RCS) location sharing criteria.

In some embodiments, the method further includes the step of: encrypting, by the first communications device, said location information for the first communications device, prior to sharing said location information of the first communications device with the second communications device.

In some embodiments, the operation of determining, by the first communications device, whether or not to share said location information for the first communications device with a second communications device based on one or more Rich Communications Services (RCS) location sharing criteria is performed by a RCS client application executing on the first communications device. In some embodiments, the step of sharing said location information with said second communications device using Rich Communications Services messaging includes: generating by the RCS client application one or more RCS messages and communicating (e.g., transmitting) said one or more RCS messages to a RCS application server for delivery to the second communications device, said one or more RCS messages including said location information for the first communications device.

In some embodiments, the detected event is one of the following: (i) initiation of RCS registration of the first communications device with the second communications device, (ii) initiation of a RCS session between the first communications device and the second communications device, (iii) receipt of user input at the first communications device indicating a request to share location information for the first communications device with the second communications device, (iv) expiration of a periodic timer (e.g., during a RCS session between the first communications device and the second communications device), (v) receipt of a request at the first communications for location information for the first communications device from the second communications device, (vi) detection of a change in one or more device attributes for the first communications device (e.g., a change above a device attribute threshold level or value for the device attribute of the first device such as a device attribute of speed for the first device having a value greater than a device speed threshold value), (vii) detection of a change in one or more network attributes. In some embodiments, a token is utilized during the exchange of messages between the first communications device and the second communications device for determining whether RCS location information sharing is to be performed. For example, the second communications device may send a RCS location information sharing request to the first communications device requesting RCS location information be shared including a token. The token may, and in some embodiments does, include one or more RCS location sharing criteria and/or rules for the first communications device to share its location information with the second communications device. In some embodiments, information in the token includes an RCS criteria which is a timer value (e.g., 5 minutes) to be used for providing RCS location updates to the second. For example, the first communications device receives a token from the second communications device in an RCS location information request. The token includes a periodic timer value (e.g., 5 minutes). The first communications device uses this periodic timer value to determine the periodicity of updates to the second communications device. In some embodiments, the token further includes a stop time indicating when the first communications device is to cease sending periodic updates to the second communications device (e.g., after 1 hour or at a specific point in time (e.g., date:time such as 8-26-2024 10:00 a.m. local time). In some embodiments, the token in addition to the timer value includes a start time (e.g., date:time format such as 8-26-2024 9:00 a.m. local time) and a stop time (date:time format such as 8-26-2024 10:00 a.m. local time) which indicates when the first communications device is to begin sending RCS location information updates to the second communications device and when to cease sending updates. The expiration of a timer loaded with the timer value at the first communications device being an event indicating that RCS location information sharing is to be determined with respect to the second communications device. In some embodiments, the token and/or at least some of the information included in the token may be encrypted.

In some embodiments, the one or more first communications device attributes include one or more of the following: (i) power or battery level, (ii) received radio frequency power level (e.g., Reference Signal Received Power (RSRP) level), (iii) received radio frequency quality level (e.g., Reference Signal Received Quality (RSRQ), (iv) radio frequency channel quality, (v) type of data being shared during a RCS session, (vi) mobility state of the first communications device (e.g., stationary or moving), (vii) speed and/or direction of movement of the first communications device, (viii) location of the first communications device (e.g., type of environment in which the first communications device is located such as urban, suburban, or rural), (ix) change in location of the first communications device, (x) accuracy of location information (e.g., GPS accuracy), and (xi) Radio Resource Control state (e.g., connected, idle, idle-limited service).

In some embodiments, the step of generating, at the first communications device, location information for the first communications device includes: generating Global Position System (GPS) coordinates for the location of the first communications device.

The present invention is also applicable to apparatus and system embodiments wherein one or more devices implement the steps of the method embodiments. In some apparatus embodiments each of the communications devices, user equipment devices, network equipment devices, routers, wireless base stations, Rich Communications Application Servers, Wi-Fi Access Points, and each of the other apparatus/devices/nodes/entities of the system include one or more processors and/or hardware circuitry, input/output interfaces including receivers and transmitters, and a memory. The memory including instructions when executed by one or more of the processors control the apparatus/device/node of the system to operate to perform the steps and/or functions of various method embodiments of the invention.

The present invention is also applicable to and includes apparatus and systems such as for example, apparatus and systems that implement the steps and/or functions of the method embodiments. For example, a apparatus in accordance with one embodiment of the present invention includes a first communications device including: memory; and a processor that controls the first communications device to perform the following operations: generating, at the first communications device, location information for the first communications device; and determining, by the first communications device, whether or not to share said location information for the first communications device with a second communications device based on one or more Rich Communications Services (RCS) location sharing criteria.

In some embodiments, the process further controls the first communications device to perform the following additional operation of: sharing said location information with said second communications device using Rich Communications Services messaging in response to determining, by the first communications device, to share said location information for the first communications device with the second communications device based on said one or more Rich Communications Services (RCS) location sharing criteria.

While various embodiments have been discussed in the summary above, it should be appreciated that not necessarily all embodiments include the same features and some of the features described above are not necessary but can be desirable in some embodiments. Numerous additional features, embodiments and benefits of various embodiments are discussed in the detailed description which follows.

### BRIEF DESCRIPTION OF THE DRAWINGS

FIG. 1 illustrates an exemplary system in accordance with an embodiment of the present invention.

FIG. 2 illustrates details of an exemplary communications device, e.g., a user equipment device, commercial entity device, government entity device, a Public Safety Access Point device, a mobile device, a cell phone, a smartphone, a wireless tablet, a laptop, a wireless notebook, a computer in accordance with an embodiment of the present invention.

FIG. 3 comprises FIG. 3A, FIG. 3B, and FIG. 3C.

FIG. 3A is the first part of a flowchart of an exemplary method in accordance with an embodiment of the present invention.

FIG. 3B is the second part of a flowchart of an exemplary method in accordance with an embodiment of the present invention.

FIG. 3C is the third part of a flowchart of an exemplary method in accordance with an embodiment of the present invention.

FIG. 4 illustrates a flowchart of an exemplary event based location update periodic event routine 400 in accordance with an embodiment of the present invention.

FIG. 5 illustrates a flowchart of an exemplary event based location update mobility event routine/method in accordance with an embodiment of the present invention.

FIG. 6 illustrates a flowchart of an exemplary event based location update communications device (e.g., UE) attributes/conditions event routine/method in accordance with an embodiment of the present invention.

FIG. 7 illustrates a flowchart of an exemplary event based location update network attributes/conditions event routine/method in accordance with an embodiment of the present invention.

FIG. 8 illustrates a flowchart of an exemplary user initiated position location sharing routine/method in accordance with an embodiment of the present invention.

FIG. 9 illustrates a flowchart of an exemplary RCS request based position location sharing routine/method 900 in accordance with an embodiment of the present invention.

FIG. 10 illustrates a flowchart of an exemplary method of setting and modifying attribute weights and threshold values used for determining RCS location information sharing with other entities.

FIG. 11 is table illustrating an exemplary RCS device profile in accordance with an embodiment of the present invention.

FIG. 12 comprises FIG. 12A, FIG. 12B, FIG. 12C, FIG. 12D, FIG. 12E, and FIG. 12F.

FIG. 12A is the first part of a flowchart of an exemplary method in accordance with an embodiment of the present invention.

FIG. 12B is the second part of a flowchart of an exemplary method in accordance with an embodiment of the present invention.

FIG. 12C is the third part of a flowchart of an exemplary method in accordance with an embodiment of the present invention.

FIG. 12D is a fourth part of a flowchart of an exemplary method in accordance with an embodiment of the present invention.

FIG. 12E is a fifth part of a flowchart of an exemplary method in accordance with an embodiment of the present invention.

FIG. 12F is a sixth part of a flowchart of an exemplary method in accordance with an embodiment of the present invention.

FIG. 13 is a drawing of an exemplary network equipment device, system, server or node, e.g., RCS Application Server, location database system, message database system, OSS device, wireless base station, router, Wi-Fi Access Point, in accordance with an embodiment of the present invention.

FIG. 14 illustrates an exemplary assembly of components for a device in accordance with an embodiment of the present invention.

FIG. 15 comprises FIG. 15A and FIG. 15B.

FIG. 15A is the first part of a signaling diagram which illustrates the steps and signaling of an exemplary method in accordance with an embodiment of the present invention.

FIG. 15B is the second part of a signaling diagram which illustrates the steps and signaling of an exemplary method in accordance with an embodiment of the present invention.

FIG. 16 comprises FIG. 16A and FIG. 16B.

FIG. 16A is the first part of a signaling diagram which illustrates the steps and signaling of an exemplary method in accordance with an embodiment of the present invention.

FIG. 16B is the second part of a signaling diagram which illustrates the steps and signaling of an exemplary method in accordance with an embodiment of the present invention.

FIG. 17 comprises FIG. 17A and FIG. 17B.

FIG. 17A is the first part of a signaling diagram which illustrates the steps and signaling of an exemplary method in accordance with an embodiment of the present invention.

FIG. 17B is the second part of a signaling diagram which illustrates the steps and signaling of an exemplary method in accordance with an embodiment of the present invention.

### DETAILED DESCRIPTION

In an exemplary embodiment of the present invention, a communications device such as an end user device or user equipment device (e.g., mobile communications device, wireless communications device, smartphone, computer, laptop, tablet) which supports the Rich Communications Services (RCS) protocol includes an RCS client application. The RCS client application may be, and in some embodiments is, part of the communications device's operating system and/or another messaging application included on the communications device. The RCS client application is capable of initiating an RCS session utilizing Session Initiation Protocol (SIP) messaging or other signaling methods and/or protocols to perform location sharing and real time location updates with other communications devices and/or entities (e.g., commercial entity communications devices (such as for example network operator communications device(s) or business entity communications devices), other end user devices on the active RCS session, government entity communications devices (such as for example public safety entity communications devices (e.g., 911 operator communications device), or other end users capable of receiving RCS messages.

Exemplary method embodiments of the present invention, manage the sharing of a communications device's location information (e.g., GPS coordinates) based on network and regulatory policies and/or based on user selection or based on events or policies that can be configured and applied based on user consent. Additionally, location updates can be managed during an active session based on events, policies, user selection or other considerations such as communications device attributes (e.g., battery power level, signaling conditions being experienced) and/or network attributes (e.g., type of network to which the communications device is connected and/or identity of network to which the communications device is connected). Once real-time location updating is enabled on a session, location updates can be performed on the RCS session by sending RCS location message updates utilizing SIP protocol messaging or other signaling methods to communicate the communication device's updated location information to other entities on the RCS session. The location information which is shared includes position information which can be in a variety of different forms and include different information such as for example, (i) numerical earth coordinates such as longitude and latitude, (ii) GPS coordinates, (iii) an address (street address, city, state, country), (iv) city, state, (v) name of famous landmark (e.g., Yankee Stadium, World Trade Center, JFK airport, Colosseum, Oxford University, etc.), (vi) name of known structure at a location (e.g., George Washington Bridge, Eiffel Tower, Statue of Liberty, Washington Monument), (vii) coordinates or information corresponding structures and/or markings on a map of an area (e.g., visitor's map of a city, a state or a country or a facility (e.g., building, park, recreational area)); (viii) satellite image of location, (ix) image of location on a map including surrounding area (e.g., an X or a image of person at the location on the map which includes the surrounding area such a streets, roads or paths to other locations on the map (e.g., image of a zoo with an X where the communications device is located and markings indicating the locations of the various animal exhibits in the zoo), and (x) image of location on a map with the location of other communications devices active on the RCS session and have shared their location with the communications device also shown on the map. In addition to position information, the location information which is shared can include speed, heading and/or velocity information and can be shown as images on a map. The images can include actual photos of the location (e.g., street level image of a house or building at the communications device's location or a satellite image of communications device's location.

Once a user of a communications device such as an end user equipment device has initiated from the communications device an RCS session with another communications device (e.g., end user equipment device), network operator communications device, commercial entity communications device (e.g., network operator communications device, business entity communications device, etc.), government entity communications device (e.g., public safety answer point (PSAP) communications device such as an 911 operator call center communications device), the RCS session is utilized to share and update the communications device's and/or user's location information with the entity or entities that the user is attempting to share their location information with.

The initial sharing of location information and/or sharing of updated location information for the communications device and/or user may be, and in some embodiments is, performed based on the detection of the occurrence of various events and/or conditions. The aforementioned events and/or conditions include the following list of events and/or conditions: (1) one time updating of location information at the start of a RCS session event: end user equipment device shares the location of the end user equipment device or provides an update on the location of the end user equipment device (in the case the location was previously shared) at the start of a new RCS session; (2) periodic updating location information event: time based periodic location refresh once the location has been shared which includes sharing the end user equipment device's location if not already shared and then continuing to refresh the location of the end user equipment device based on set periodicity; (3) movement based updating of location information event: in the event motion is detected by the end user equipment device, based on speed and/or other accelerometer and location coordinate considerations, the end user equipment device's location information is shared if not already shared and refreshed if location sharing was previously initiated; (4) UE-attributes based updating of location information event: modifying and adapting location information sharing and location information refresh based on UE-attributes such as for example battery level, battery capacity, Radio Frequency (RF) signal power/quality, RF channel quality, type of data being shared over the RCS session, mobility state of the end user equipment device (stationary or moving), Radio Resource Control (RRC) states-idle, connected, idle-limited service, operator reserved; (5) network attributes based location information updating event: modifying and adapting location information sharing and refresh based on network attributes such as for example: network identity of network to which user equipment device is connected and which is to be used for RCS location sharing, network type of network to which user equipment device is connected and which is to be used for RCS location sharing; (6) threshold based location sharing and updating event: modifying and adapting location sharing and refresh based on thresholds that are set by the user or automatically based on a learning subsystem working to optimize the process including: (a) ability to set a threshold or a group of thresholds into a policy that the user defines to initiate location information or refreshing location information in the case location sharing was previously initiated; (b) ability to manually refresh location if the user wishes to do so at any point during an active RCS session (e.g., via user input at the user equipment device instructing location update sharing be performed with another entity (e.g., user equipment device) and in the case an active RCS session doesn't exist with the other entity, the manual refresh will initiate a new RCS session and share the location information with the other entity (e.g., user equipment device); (c) automatically applied threshold settings and policies based on previous experience or network/Original Equipment Manufacturer implemented policies which are learned and optimized as location information sharing and updates are performed across various scenarios and/or events; (7) network equipment initiated (e.g., Operational Support Systems network equipment initiated) or other communications device/end user equipment device initiated location information sharing or updating request event: (a) ability for other entities (e.g., other communications devices) on the network to initiate a location information sharing or updating request with a end user equipment device and receiving from the end user equipment device with the consent of the end user of the end user equipment device the requested location information, (b) ability for other entities (e.g., other communications devices) on the network to initiate a location information sharing or updating request with a end user equipment device and receiving from the end user equipment device without the consent of the end user of the end user equipment device the requested location information (e.g., government communications devices such as PSAP communications entities requesting location information after an RCS session has been initiated and/or interrupted or terminated before resolution of the reason for the RCS session (e.g., on-going bank robbery, kidnapping, shooting).

In some embodiments, a token is utilized during the exchange of messages between communications devices (e.g., a first communications device and a second communications device) for determining whether RCS location information sharing is to be performed. For example, the second communications device may send a RCS location information sharing request to the first communications device requesting RCS location information be shared. The request may, and in some embodiments does, include a token. The token may, and in some embodiments does, include information for determining whether, how, and when location information is to be shared by the first communications device with the second communications device. In some embodiments, the information included in the token includes one or more RCS location sharing criteria and/or rules for the first communications device to utilize when determining whether or not to share its location information with the second communications device. In some embodiments, information in the token includes an RCS criteria which is a timer value (e.g., 5 minutes) to be used for providing RCS location updates to the second. For example, the first communications device receives a token from the second communications device in an RCS location information request. The token includes a periodic timer value (e.g., 5 minutes). The first communications device uses this periodic timer value to determine the periodicity of updates to the second communications device. In some embodiments, the token further includes a stop time indicating when the first communications device is to cease sending periodic updates to the second communications device (e.g., after 1 hour or at a specific point in time (e.g., date:time such as 8-26-2024 10:00 a.m. local time). In some embodiments, the token in addition to the timer value includes a start time (e.g., date:time format such as 8-26-2024 9:00 a.m. local time) and a stop time (date:time format such as 8-26-2024 10:00 a.m. local time) which indicates when the first communications device is to begin sending RCS location information updates to the second communications device and when to cease sending updates. The expiration of a timer loaded with the timer value at the first communications device being an event indicating that RCS location information sharing is to be determined with respect to the second communications device. In some embodiments, the token and/or at least some of the information included in the token may be encrypted.

In some embodiments of the invention, the RCS client application of the communications device includes an artificial intelligence machine learning component which automatically learns and fine-tunes automatic location information sharing based on threshold values and policies. This process includes training the location sharing and updating algorithms for implementing location information sharing and updating by gathering and/or collecting information for determining the correct weights and threshold values for every location information sharing initiation and update based on historically collected data. In case of different thresholds and policies are applied to a session based on values from the network, OEM, user selections, public safety entity, the correct selection will be applied based on user consent and in the case of an absence of user consent the policy set with the highest priority/weight will be applied. In case of failure to apply the first selection, the policy set with the next highest priority will be attempted and so on all the way to the last policy which may be considered the default setting.

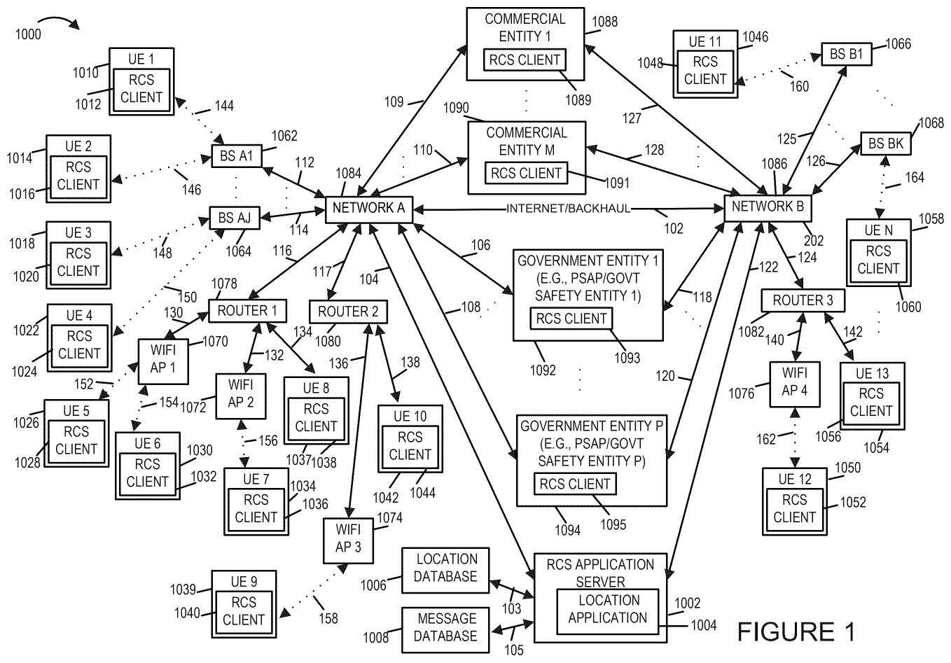

FIG. 1 illustrates elements of an exemplary communications system 1000 in accordance with an embodiment of the present invention. System 100 includes a Rich Communications Service (RCS) Application Server 1002, a location database 1006, a message database 1008, a plurality of user equipment device (i.e., UE 1 1010, UE 2 1014, UE 1018, UE 4 1022, UE 5 1026, UE 6 1030, UE 7 1034, UE 8 1037, UE 9 1039, UE 10 1042, UE 11 1046, UE 12 1050, UE 13 1054, . . . , UE N 1058 (N being an integer greater than 13), a plurality of networks (i.e., network A 1084 and network B 1086), a plurality of wireless base stations (i.e., a first plurality of base stations BS A1 1062, . . . , BS AJ 1064, J being an integer greater than 1 coupled and/or connected to and/or part of network A and a second plurality of base stations BS B1 1066, . . . , BS BK 1068, coupled and/or connected to and/or part of network B, K being an integer greater than 1), a plurality of routers (i.e., router 1 1078 and router 2 1080 coupled and/or connected to network A 1084, and router 3 1082 coupled and/or connected to network B 1086), a plurality of Wi-Fi Access Points (i.e., Wi-Fi Access Point (Wi-Fi AP) 1 1070, Wi-Fi AP 2 1072, Wi-Fi AP 3 1074, Wi-Fi AP 4 1076), a plurality of commercial entities (i.e., commercial entity 1 1088, . . . , commercial entity M 1090, M being an integer greater than 1, a commercial entities being for example communications equipment and/or communications devices operated by businesses and/or non-government entities), a plurality of government entities (i.e., Government Entity 1 1092, . . . , Government Entity P 1094, P being an integer great than 1, Government Entities being communications equipment and/or communications devices operated by the government such as for example Government Public Safety Answering and/or Access Points (PSAP), Government Law Enforcement Departments, Fire Departments, 911 services entities), and a plurality of communications links (i.e., communications links 102, 103, 105, 106, 108, 109, 110, 112, 114, 116, 117, 118, 120, 122, 124, 125, 126, 127, 128, 130, 132, 134, 136, 138, 140, 142, 144, 146, 148, 150, 152, 154, 156, 158, 160, 162, and 164) that couple and/or connect the various elements of the system 1000 together allowing the interchange of signals, data, information and/or messages. The RCS server 1004 includes location application 1004 and provides Rich Communications Services to user equipment devices via a client server relationship. The plurality of user equipment devices of system 1000 include a Rich Communications Services (RCS) client application that allow the user equipment device to utilize Rich Communications Services provided by the RCS Application server 1002 including for example location services such as the sharing of the user equipment device's location with other user equipment devices and/or entities (e.g., commercial entities, government entities). In some embodiments, the commercial entities include network equipment entities which are included in network A, network B and/or coupled and/or connected to network A and/or network B such as for example cloud based Operating Support Systems (OSS) network service entities and/or functions. UE 1 1010, UE 2 1014, UE 1018, UE 4 1022, UE 5 1026, UE 6 1030, UE 7 1034, UE 8 1037, UE 9 1039, UE 10 1042, UE 11 1046, UE 12 1050, UE 13 1054, . . . , UE N 1058 include RCS client application 1012, RCS client application 1016, RCS client application 1020, RCS client application 1024, RCS client application 1028, RCS client application 1032, RCS client application 1036, 1038, 1040, 1044, 1048, 1052, 1056, . . . , 1060 respectively. The RCS Application sever 1002 includes a location application 1004 which provides RCS location services to RCS client applications. In some embodiments, the location application 1004 is part of a presence application that provides presence information in the form of user location information and/or the status of the user (e.g., on-line available, on-line busy, off-line). In some embodiments, the RCS location services are implemented as a separate server instead of an application of the RCS Application server 1002. The RCS Application server will also be referred to herein as RCS server.

The communications link 102 couples and/or connects network A 1084 to network B 1086 and is an Internet communications link. While communications link 102 is shown as a single communications link it may, and typically does, include a plurality of Internet communications links. The Internet connections and/or links 102 can, and typically are, used for backhaul communications between the two networks (i.e., network A 1084 and network B 1086).

The RCS server 1002 is coupled and/or connected to the location database 1006 via communications link 103. The RCS server 1004 is coupled and/or connected to the message database 1008 via communications link 105. The location database 1006 and message database 1008 may be, and in some embodiments are, implemented as database systems that support structured query language SQL. The location database 1006 is used by the RCS server 1002 for storing location information provided to the RCS server (e.g., by user equipment devices and/or other entities such as commercial entities and government entities) to which it is providing RCS services. In some embodiments, the location database 1006 is a presence server and/or a location server including a database which provides RCS location based services to RCS client applications which provide location information and requests to the RCS server 1002.

The message database 1008 is used for storing RCS messages (e.g., text messages from RCS clients) when the destination RCS client is not currently available (e.g., is off-line) for later delivery when the destination RCS client becomes available (e.g., is on-line). In some embodiments, the message database 1008 may be, and in some embodiments is, used for storing RCS client device messages devices (e.g., off RCS client device storage to free up memory on the RCS client device while allowing the user to maintain there text messages).

The RCS server 1002 is coupled to network A 1084 via communications link 104. The RCS server 1002 is coupled to network B 1086 via communications link 122.

Communications links 104, 106, . . . , 108, 109, . . . , 110, 112, . . . , 114, 116, and 117 couple and/or connect network A 1084 to the RCS server 1002, government entity 1 1092, . . . , government entity P 1094, commercial entity 1 1088, . . . , commercial entity M 1090, base station A1 1062, . . . , base station AJ 1064, router 1 1078, router 2 1080 respectively. Communications links 122, 118, . . . , 120, 127, . . . , 128, 125, . . . , 126, and 124 couple and/or connect network B 1088 to the RCS server 1002, government entity 1 1092, . . . , government entity P 1094, commercial entity 1 1088, . . . , commercial entity M 1090, base station B1 1066, . . . , base station BK 1068, and router 3 1082 respectively. Communications links 130, 132, 134 couple and/or connect router 1 1078 to Wi-Fi AP 1 1070, Wi-Fi AP 2 1072, and UE 8 1037 respectively. Communications links 136 and 138 couple and/or connect router 2 1080 to Wi-Fi AP 3 1074 and UE 10 1042 respectively. Communications links 140 and 142 couple router 3 1082 to Wi-Fi AP 4 1076 and UE 13 1060 respectively. Wireless communications links 144, 146 couple and/or connect UE 1 1010 and UE 2 1014 to BS A1 1062 respectively. Wireless communications links 148, 150 couple and/or connect UE 3 1018 and UE 4 1022 to BS AJ 1064 respectively. Communications link 152 and 154 couple and/or connect UE 5 1026 and UE 6 1030 to Wi-Fi AP 1 1070 respectively. Communications link 156 couples and/or connects UE 7 1034 to Wi-Fi AP 2 1072. Communications link 158 couples and/or connects UE 9 1039 to Wi-Fi AP 3 1074. Wireless communications link 160 couples and/or connects UE 11 1046 to base station B1 1066. Wireless communications link 162 couples and/or connects UE 12 1050 to Wi-Fi AP 4 1076. Wireless communications link 164 couples and/or connects UE N 1058 to base station BK 1068.

The communications links 102, 103, 104, 105, 106, . . . , 108, 109, . . . , 110, 112, . . . , 114, 116, 117, 118, . . . , 120, 122, 124, 125, . . . , 126, 127, . . . , 128, 130, 132, 134, 136, 138, 140, and 142 are typically wire, cable, or fiber communications links which provide high speed communications between each of the entities that they connect.

Devices which include a RCS client application such as for example the user equipment devices, commercial entity communications devices, and government entity communications devices of system 1000 are RCS client communications devices also sometimes referred to herein as RCS client devices. The RCS client application in a RCS client device may be, and in some embodiments is, included in a native application of the client device and/or operating system of the device.

In some embodiments, the RCS server is part of network A 1084 or network B 1086. In some embodiments, both network A 1084 and network B 1086 include a RCS server and the operators of network A and network B are RCS server providers.

In some embodiments, one or more of the base stations (BS A1 1062, . . . , BS AJ 1064, and/or router 1 1078 and/or router 2 1080 are coupled and/or connected to the network A via a cable modem system (e.g., BS A1 1062 is coupled/connected to a cable modem which is connected to communications link 112 which is cable link which is connected to a Cable Modem Termination System included in the network A 1084). Similarly, one or more of the base station (BS B1 1066, . . . , BS BK 1068, and/or router 3 1082 is coupled and/or connected to network B 1086 via a cable modem system (e.g., router 3 1082 is connected and/or coupled to a cable modem which is situated between the router 3 and network B 1086 and couples and/or connects the router 3 1082 to the communications link 124 which is a cable link connected and/or coupled to a cable modem termination system included in network B).

In some embodiments, one or more of the base stations (BS A1 1062, . . . , BS AJ 1064, and/or router 1 1078 and/or router 2 1080 are coupled and/or connected to the network A via a fiber optic cable and/or fiber optic network. Similarly, one or more of the base station (BS B1 1066, . . . , BS BK 1068, and/or router 3 1082 is coupled and/or connected to network B 1086 via a fiber optic cable and/or fiber optic network.

While standards for Rich Communications Services are directed to Mobile Network Operators for use with mobile devices such as smart phones which support cellular or Wi-Fi operation, the present invention allows RCS services to be provided to a plurality of different types of devices services regardless of how whether or not they are mobile devices and how they are connected and/or coupled to the RCS application server which is providing the RCS services.

The configuration of system 1000 and the communications links which couple and/or connect the various entities of the system are exemplary and other configurations and network connections can be utilized while practicing various embodiments of the invention.

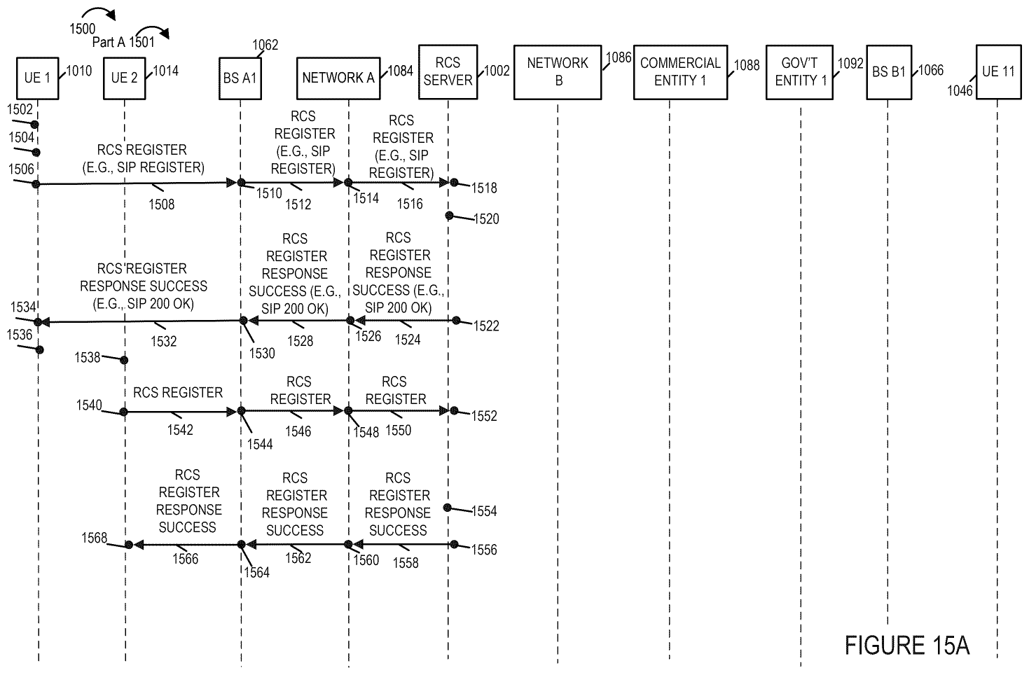

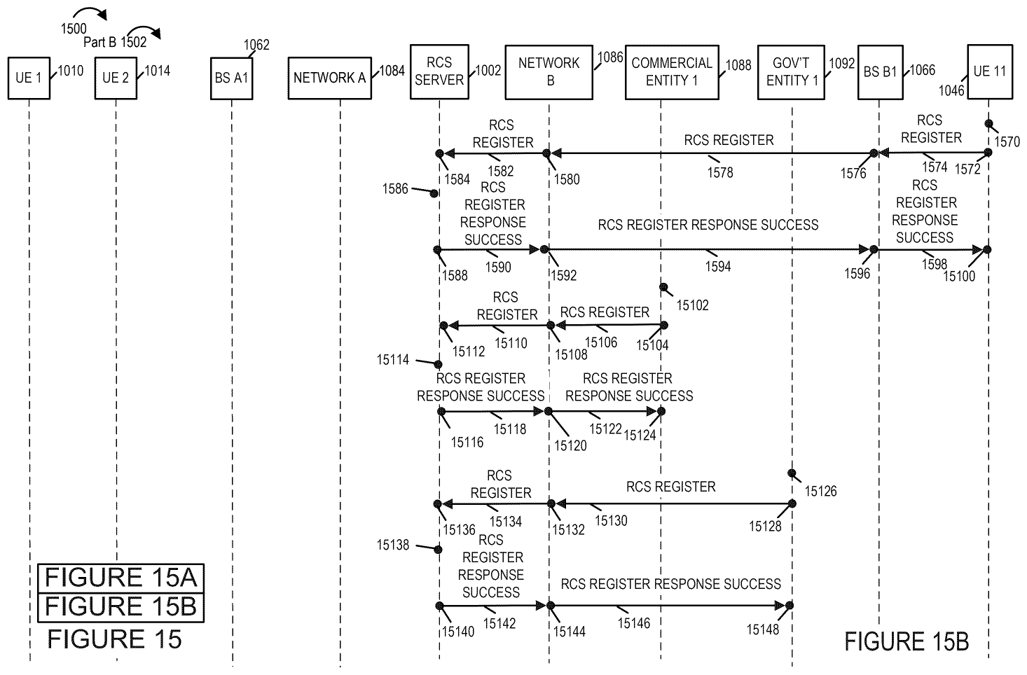

FIG. 15 comprises FIG. 15A and FIG. 15B. FIG. 15A is the first part of a signaling diagram which illustrates the steps and signaling of an exemplary method 1500 in accordance with an embodiment of the present invention. FIG. 15B is the second part of a signaling diagram which illustrates the steps and signaling of an exemplary method 1500 in accordance with an embodiment of the present invention.

The signaling diagram/method 1500 has been shown being implemented using elements of exemplary system 1000 of FIG. 1. While it will be readily understood that additional steps and signaling are performed in connection with communicating information, messages, and packets between devices, the signaling diagram/method 1500 focuses on and discusses the steps and signaling for understanding the invention. Elements or steps with the same reference numbers used in different figures are the same or similar and those elements or steps will not be described in detail again.

It should be understood that the method 1500 is not limited to the exemplary system 1000 and may be, and is used, on other systems including systems with other configurations. The signaling diagram/method 1500 illustrates exemplary signaling and steps for registering RCS client devices in accordance with an exemplary embodiment of the present invention.

Operation commences in start step 1502 shown on FIG. 15A. Operation proceeds from start step 1502 to step 1504. In step 1504, the UE 1 1010 generates a RCS REGISTER request message 1508 (e.g., a SIP REGISTER request message including RCS registration request information and in some embodiments location information). Operation proceeds from step 1504 to step 1506. In step 1506, UE 1 1010 transmits over the air or wirelessly the RCS REGISTER request message 1508 to the base station A1 (BS A1) 1062. Operation proceeds from step 1506 to step 1510. In step 1510, the base station A1 1062 receives the RCS REGISTER message 1508, generates RCS REGISTER message 1512 based on the RCS REGISTER message 1508, and transmits the generated RCS REGISTER message 1512 to network A 1084 (e.g., an Internet Protocol Multimedia Subsystem (IMS) network). Operation proceeds from step 1510 to step 1514. In step 1514, the network A 1084 receives the RCS REGISTER message 1512, generates RCS REGISTER message 1516 based on the RCS REGISTER message 1512, and transmits the generated RCS REGISTER message 1516 to RCS Server 1002. Operation proceeds from step 1514 to step 1518. In step 1518, the RCS Server 1002 receives and processes the RCS REGISTER message 1516. Operation proceeds from step 1518 to step 1520.

In step 1520, the RCS Server 1002 registers UE 1 1010 (e.g., the RCS client application 1012 of UE 1 1010 as being active and available for obtaining and receiving RCS services from the RCS Server 1002. RCS services include for example, RCS sessions (e.g., chat sessions) with other registered RCS entities/devices, RCS messaging (test, images, video messaging), RCS location information sharing (public sharing of location information (e.g., via the RCS server which maintains (e.g., via a location database 1006) and shares location information on each of the registered RCS entities which have their location information sharing setting set to public) and private sharing of location information in which the RCS client application has restricted to which RCS entities and/or types of entities are to be provided its location information and whether the location information will be shared in encrypted form between the UE 1 and the other RCS client applications without the RCS being able to access the location information). In some embodiments, the RCS REGISTER message includes RCS profile information for UE 1 1010 including for example location sharing information (e.g., instructions and/or settings on how, when, and/or with whom its location information is to be shared). In some embodiments such as for example, when the location information is to be shared publicly with other RCS entities by the RCS server 1002, the RCS REGISTER message 1508, 1512, 1516 include location information (e.g., GPS coordinates for the UE 1 1010) which the RCS server 1002 extracts from the received message 1516 and stores in location database 1006. Operation proceeds from step 1520 to step 1522.

In step 1522, the RCS Server 1002 generates and transmits RCS REGISTER RESPONSE message 1524 (e.g., a SIP 200 OK message) to the network A 1084 in response to RCS REGISTER message 1516. The message 1524 includes information indicating that the UE 1 1010 RCS registration with the RCS server 1002 has been successful. Operation proceeds from step 1522 to step 1526. In step 1526, the network A 1084 receives the RCS REGISTER RESPONSE message 1524, generates RCS REGISTER RESPONSE message 1528 based on the RCS REGISTER RESPONSE message 1524, and transmits the generated RCS REGISTER RESPONSE message 1528 to base station A1 1062 in response to RCS REGISTER message 1512. Operation proceeds from step 1526 to step 1530. In step 1530, the base station A1 1062 receives the RCS REGISTER RESPONSE message 1528, generates RCS REGISTER RESPONSE message 1532 based on the RCS REGISTER RESPONSE message 1528, and transmits over the air or wireless the generated RCS REGISTER RESPONSE message 1532 to UE 1 1010 in response to RCS REGISTER message 1508. Operation proceeds from step 1530 to step 1534. In step 1534, UE 1 1010 receives RCS REGISTER RESPONSE message 1532 (e.g., a SIP 200 OK message) from base station A1 1062 in response RCS REGISTER message 1508. Operation proceeds from step 1534 to step 1536. In step 1536, UE 1 1010 (e.g., the RCS client application 1012 of UE 1) processes the received RCS REGISTER RESPONSE message and determines from information contained in the response message that the UE 1 1010 (e.g., the RCS client application 1012 of UE 1 1010) has successfully registered with the RCS server 1002. Operation proceeds from step 1536 to step 1538.

In step 1538, the UE 2 1014 generates a RCS REGISTER request message 1542 (e.g., a SIP REGISTER request message including RCS registration request information and in some embodiments location information). Operation proceeds from step 1538 to step 1540. In step 1540, UE 2 1014 transmits over the air or wirelessly the RCS REGISTER request message 1542 to the base station A1 (BS A1) 1062. Operation proceeds from step 1540 to step 1544. In step 1544, the base station A1 1062 receives the RCS REGISTER message 1542, generates RCS REGISTER message 1546 based on the RCS REGISTER message 1542, and transmits the generated RCS REGISTER message 1546 to network A 1084 (e.g., an Internet Protocol Multimedia Subsystem (IMS) network). Operation proceeds from step 1544 to step 1548. In step 1548, the network A 1084 receives the RCS REGISTER message 1546, generates RCS REGISTER message 1550 based on the RCS REGISTER message 1546, and transmits the generated RCS REGISTER message 1550 to RCS Server 1002. Operation proceeds from step 1548 to step 1552. In step 1552, the RCS Server 1002 receives and processes the RCS REGISTER message 1550. Operation proceeds from step 1552 to step 1554.

In step 1554, the RCS Server 1002 registers UE 2 1014 (e.g., the RCS client application 1016 of UE 2 1014 as being active and available for obtaining and receiving RCS services from the RCS Server 1002. As previously discussed, RCS services include for example, RCS sessions (e.g., chat sessions) with other registered RCS entities/devices, RCS messaging (test, images, video messaging), RCS location information sharing (public sharing of location information (e.g., via the RCS server which maintains (e.g., via a location database 1006) and shares location information on each of the registered RCS entities which have their location information sharing setting set to public) and private sharing of location information in which the RCS client application has restricted to which RCS entities and/or types of entities are to be provided its location information and whether the location information will be shared in encrypted form between the UE 2 and the other RCS client applications without the RCS being able to access the location information). In some embodiments, the RCS REGISTER message includes RCS profile information for UE 2 1014 including for example location sharing information (e.g., instructions and/or settings on how, when, and/or with whom its location information is to be shared). In some embodiments such as for example, when the location information is to be shared publicly with other RCS entities by the RCS server 1002, the RCS REGISTER message 1542, 1546, 1550 include location information (e.g., GPS coordinates for the UE 2 1014) which the RCS server 1002 extracts from the received message 1550 and stores in location database 1006. Operation proceeds from step 1554 to step 1556.

In step 1556, the RCS Server 1002 generates and transmits RCS REGISTER RESPONSE message 1558 (e.g., a SIP 200 OK message) to the network A 1084 in response to RCS REGISTER message 1550. The message 1558 includes information indicating that the UE 2 1014 RCS registration with the RCS server 1002 has been successful. Operation proceeds from step 1556 to step 1560. In step 1560, the network A 1084 receives the RCS REGISTER RESPONSE message 1558, generates RCS REGISTER RESPONSE message 1562 based on the RCS REGISTER RESPONSE message 1558, and transmits the generated RCS REGISTER RESPONSE message 1562 to base station A1 1062 in response to RCS REGISTER message 1546. Operation proceeds from step 1560 to step 1564. In step 1564, the base station A1 1062 receives the RCS REGISTER RESPONSE message 1562, generates RCS REGISTER RESPONSE message 1566 based on the RCS REGISTER RESPONSE message 1562, and transmits over the air or wirelessly the generated RCS REGISTER RESPONSE message 1566 to UE 2 1014 in response to RCS REGISTER message 1542. Operation proceeds from step 1564 to step 1568. In step 1568, UE 2 1014 (e.g., the RCS client application 1016 of UE 2 1014) receives and processes RCS REGISTER RESPONSE message 1566 (e.g., a SIP 200 OK message) from base station A1 1062 in response RCS REGISTER message 1542. UE 2 1014 (e.g., RCS client application 1016) during the processing of the message 1566 determines from information contained in the response message that the UE 2 1014 (e.g., the RCS client application 1016 of UE 2 1014) has successfully registered with the RCS server 1002. Operation proceeds from step 1568 to step 1570.

In step 1570, the UE 11 1046 generates a RCS REGISTER request message 1574 (e.g., a SIP REGISTER request message including RCS registration request information and in some embodiments location information). Operation proceeds from step 1570 to step 1572. In step 1572, UE 11 1046 transmits over the air or wirelessly the RCS REGISTER request message 1574 to the base station B1 (BS B1) 1066. Operation proceeds from step 1572 to step 1576. In step 1576, the base station B1 1066 receives the RCS REGISTER message 1574, generates RCS REGISTER message 1578 based on the RCS REGISTER message 1574, and transmits the generated RCS REGISTER message 1578 to network B 1086 (e.g., an Internet Protocol Multimedia Subsystem (IMS) network). Operation proceeds from step 1576 to step 1580. In step 1580, the network B 1086 receives the RCS REGISTER message 1578, generates RCS REGISTER message 1582 based on the RCS REGISTER message 1578, and transmits the generated RCS REGISTER message 1578 to RCS Server 1002. Operation proceeds from step 1580 to step 1584. In step 1584, the RCS Server 1002 receives and processes the RCS REGISTER message 1582. Operation proceeds from step 1584 to step 1586.

In step 1586, the RCS Server 1002 registers UE 11 1046 (e.g., the RCS client application 1048 of UE 11 1046 as being active and available for obtaining and receiving RCS services from the RCS Server 1002. As previously discussed, RCS services include for example, RCS sessions (e.g., chat sessions) with other registered RCS entities/devices, RCS messaging (test, images, video messaging), RCS location information sharing (public sharing of location information (e.g., via the RCS server which maintains (e.g., via a location database 1006) and shares location information on each of the registered RCS entities which have their location information sharing setting set to public) and private sharing of location information in which the RCS client application has restricted to which RCS entities and/or types of entities are to be provided its location information and whether the location information will be shared in encrypted form between the UE 11 and the other RCS client applications without the RCS being able to access the location information). In some embodiments, the RCS REGISTER message includes RCS profile information for UE 11 1046 including for example location sharing information (e.g., instructions and/or settings on how, when, and/or with whom its location information is to be shared). In some embodiments such as for example, when the location information is to be shared publicly with other RCS entities by the RCS server 1002, the RCS REGISTER message 1574, 1578, 1582 include location information (e.g., GPS coordinates for the UE 11 1046) which the RCS server 1002 extracts from the received message 1582 and stores in location database 1006. Operation proceeds from step 1586 to step 1588.

In step 1588, the RCS Server 1002 generates and transmits RCS REGISTER RESPONSE message 1590 (e.g., a SIP 200 OK message) to the network B 1086 in response to RCS REGISTER message 1582. The message 1590 includes information indicating that the UE 11 1046 RCS registration with the RCS server 1002 has been successful. Operation proceeds from step 1588 to step 1592. In step 1592, the network B 1086 receives the RCS REGISTER RESPONSE message 1590, generates RCS REGISTER RESPONSE message 1594 based on the RCS REGISTER RESPONSE message 1590, and transmits the generated RCS REGISTER RESPONSE message 1594 to base station B1 1066 in response to RCS REGISTER message 1578. Operation proceeds from step 1592 to step 1596. In step 1596, the base station B1 1066 receives the RCS REGISTER RESPONSE message 1594, generates RCS REGISTER RESPONSE message 1598 based on the RCS REGISTER RESPONSE message 1594, and transmits over the air or wirelessly the generated RCS REGISTER RESPONSE message 1598 to UE 11 1046 in response to RCS REGISTER message 1574. Operation proceeds from step 1596 to step 15100. In step 15100, UE 11 1046 (e.g., the RCS client application 1048 of UE 11 1046) receives and processes RCS REGISTER RESPONSE message 1598 (e.g., a SIP 200 OK message) from base station B1 1066 in response RCS REGISTER message 1574. UE 11 1014 (e.g., RCS client application 1016) during the processing of the message 1598 determines from information contained in the response message that the UE 11 1046 (e.g., the RCS client application 1048 of UE 11 1046) has successfully registered with the RCS server 1002. Operation proceeds from step 15100 to step 15104.

In step 15102, the commercial entity 1 communications device (e.g., a commercial business communications device) 1088 generates a RCS REGISTER request message 15106 (e.g., a SIP REGISTER request message including RCS registration request information and in some embodiments location information). Operation proceeds from step 15102 to step 15104. In step 15104, commercial entity 1 communications device 1088 transmits the RCS REGISTER request message 15106 to network B 1086. Operation proceeds from step 15104 to step 15108. In step 15108, the network B 1086 receives the RCS REGISTER message 15106, generates RCS REGISTER message 15110 based on the RCS REGISTER message 15106, and transmits the generated RCS REGISTER message 15106 to RCS Server 1002. Operation proceeds from step 15108 to step 15112. In step 15112, the RCS Server 1002 receives and processes the RCS REGISTER message 15110. Operation proceeds from step 15112 to step 15114.

In step 15114, the RCS Server 1002 registers commercial entity 1 communications device 1088 (e.g., the RCS client application 1089 of commercial entity 1 communications device 1088 as being active and available for obtaining and receiving RCS services from the RCS Server 1002. As previously discussed, RCS services include for example, RCS sessions (e.g., chat sessions) with other registered RCS entities/devices, RCS messaging (test, images, video messaging), RCS location information sharing (public sharing of location information (e.g., via the RCS server which maintains (e.g., via a location database 1006) and shares location information on each of the registered RCS entities which have their location information sharing setting set to public) and private sharing of location information in which the RCS client application has restricted to which RCS entities and/or types of entities are to be provided its location information and whether the location information will be shared in encrypted form between the commercial entity 1 communications device 1088 and the other RCS client applications without the RCS being able to access the location information). In some embodiments, the RCS REGISTER message includes RCS profile information for commercial entity 1 communications device 1088 including for example location sharing information (e.g., instructions and/or settings on how, when, and/or with whom its location information is to be shared). In some embodiments such as for example, when the location information is to be shared publicly with other RCS entities by the RCS server 1002, the RCS REGISTER message 15106 and 15110 include location information (e.g., GPS coordinates for the commercial entity 1 communications device 1088) which the RCS server 1002 extracts from the received message 15110 and stores in location database 1006. Operation proceeds from step 15114 to step 15116.

In step 15116, the RCS Server 1002 generates and transmits RCS REGISTER RESPONSE message 15118 (e.g., a SIP 200 OK message) to the network B 1086 in response to RCS REGISTER message 15110. The message 15118 includes information indicating that the commercial entity 1 communications device 1088 RCS registration with the RCS server 1002 has been successful. Operation proceeds from step 15116 to step 15120. In step 15120, the network B 1086 receives the RCS REGISTER RESPONSE message 15118, generates RCS REGISTER RESPONSE message 15122 based on the RCS REGISTER RESPONSE message 15118, and transmits the generated RCS REGISTER RESPONSE message 15122 to commercial entity 1 communications device 1088 in response to RCS REGISTER message 15106. Operation proceeds from step 15120 to step 15124. In step 15124, commercial entity 1 communications device 1088 (e.g., the RCS client application 1089 of commercial entity 1 communications device 1088) receives and processes RCS REGISTER RESPONSE message 15122 (e.g., a SIP 200 OK message) in response RCS REGISTER message 15106. Commercial entity 1 communications device 1088 (e.g., RCS client application 1089) during the processing of the message 15122 determines from information contained in the response message that the commercial entity 1 communications device 1088 (e.g., the RCS client application 1089 of commercial entity 1 communications device 1088) has successfully registered with the RCS server 1002. Operation proceeds from step 15124 to step 15128.

In step 15126, the government entity 1 communications device (e.g., a Public Safety Answering Point communications device) 1092 generates a RCS REGISTER request message 15130 (e.g., a SIP REGISTER request message including RCS registration request information and in some embodiments location information). Operation proceeds from step 15126 to step 15128. In step 15128, government entity 1 communications device 1092 transmits the RCS REGISTER request message 15130 to network B 1086. Operation proceeds from step 15128 to step 15132. In step 15132, the network B 1086 receives the RCS REGISTER message 15130, generates RCS REGISTER message 15134 based on the RCS REGISTER message 15130, and transmits the generated RCS REGISTER message 15130 to RCS Server 1002. Operation proceeds from step 15132 to step 15136. In step 15136, the RCS Server 1002 receives and processes the RCS REGISTER message 15134. Operation proceeds from step 15136 to step 15138.

In step 15138, the RCS Server 1002 registers government entity 1 communications device 1092 (e.g., the RCS client application 1093 of commercial entity 1 communications device 1092) as being active and available for obtaining and receiving RCS services from the RCS Server 1002. As previously discussed, RCS services include for example, RCS sessions (e.g., chat sessions) with other registered RCS entities/devices, RCS messaging (test, images, video messaging), RCS location information sharing (public sharing of location information (e.g., via the RCS server which maintains (e.g., via a location database 1006) and shares location information on each of the registered RCS entities which have their location information sharing setting set to public) and private sharing of location information in which the RCS client application has restricted to which RCS entities and/or types of entities are to be provided its location information and whether the location information will be shared in encrypted form between the government entity 1 communications device 1092 and the other RCS client applications without the RCS being able to access the location information). In some embodiments, the RCS REGISTER message includes RCS profile information for government entity 1 communications device 1092 including for example location sharing information (e.g., instructions and/or settings on how, when, and/or with whom its location information is to be shared). In some embodiments such as for example, when the location information is to be shared publicly with other RCS entities by the RCS server 1002, the RCS REGISTER message 15130 and 15134 include location information (e.g., GPS coordinates for the government entity 1 communications device 1092) which the RCS server 1002 extracts from the received message 15134 and stores in location database 1006. Operation proceeds from step 15138 to step 15140.

In step 15140, the RCS Server 1002 generates and transmits RCS REGISTER RESPONSE message 15142 (e.g., a SIP 200 OK message) to the network B 1086 in response to RCS REGISTER message 15134. The message 15142 includes information indicating that the government entity 1 communications device 1092 RCS registration with the RCS server 1002 has been successful. Operation proceeds from step 15140 to step 15144. In step 15144, the network B 1086 receives the RCS REGISTER RESPONSE message 15142, generates RCS REGISTER RESPONSE message 15146 based on the RCS REGISTER RESPONSE message 15142, and transmits the generated RCS REGISTER RESPONSE message 15146 to government entity 1 communications device 1092 in response to RCS REGISTER message 15130. Operation proceeds from step 15144 to step 15138. In step 15148, government entity 1 communications device 1092 (e.g., the RCS client application 1093 of government entity 1 communications device 1092) receives and processes RCS REGISTER RESPONSE message 15146 (e.g., a SIP 200 OK message) in response RCS REGISTER message 15130. Government entity 1 communications device 1092 (e.g., RCS client application 1093) during the processing of the message 15146 determines from information contained in the response message that the government entity 1 communications device 1092 (e.g., the RCS client application 1093 of government entity 1 communications device 1092) has successfully registered with the RCS server 1002.

While the commercial entity 1 communications device 1088 and government entity 1 communications device 1092 have been shown in method 1500 using a communications path including network B 1086 to communicate and exchange messages with the RCS Server 1002. Network A 1084 can also be used to communicate and exchange messages (e.g., RCS request and response messages) between the RCS Server 1002 and the commercial entity 1 communications device 1088 and/or government entity 1 communications device 1092.

The method 1500 illustrates the exemplary RCS registration of a plurality of the entities/communications devices with RCS client applications illustrated in system 1000. The other entities/communications devices of system 1000 which include a RCS client application may, and in some embodiments, are registered with the RCS server in the same or similar manner as illustrated in the example registrations of UE 1 1010, UE 2 1014, commercial entity 1 communications device 1088, and government entity 1 communications device 1092. The communications paths for the registering entity/device being dependent on how the communications devices/entities are connected to network A 1084 and/or network B 1086. For example, UEs coupled and/or connected to network A 1084 via a Wi-Fi connection and router would utilize that communications path to communicate and exchange messages with the RCS server. For example, UE 5 1026 would utilize the communications path wireless link 152 to Wi-Fi Access Point 1 1070 to wired communications link 130 to router 1 1078 to wired communications link 116 to network A 1084 to wired communications link 104 to RCS application server 1002 when sending messages to the RCS application server 1002 and a reverse path would be traversed when receiving messages from the RCS application server 1002. Messages (e.g., registration request messages, session request messages, location sharing messages) sent from UE 10 1044 to the RCS server 1002 would traverse the path wireless link 138, router 2 1080, communications link 117, network A 1084, communications link 104 to RCS application server 1002. The same communications path would be traversed in the reverse order for messages sent from the RCS server 1002 to the UE 10 1044.

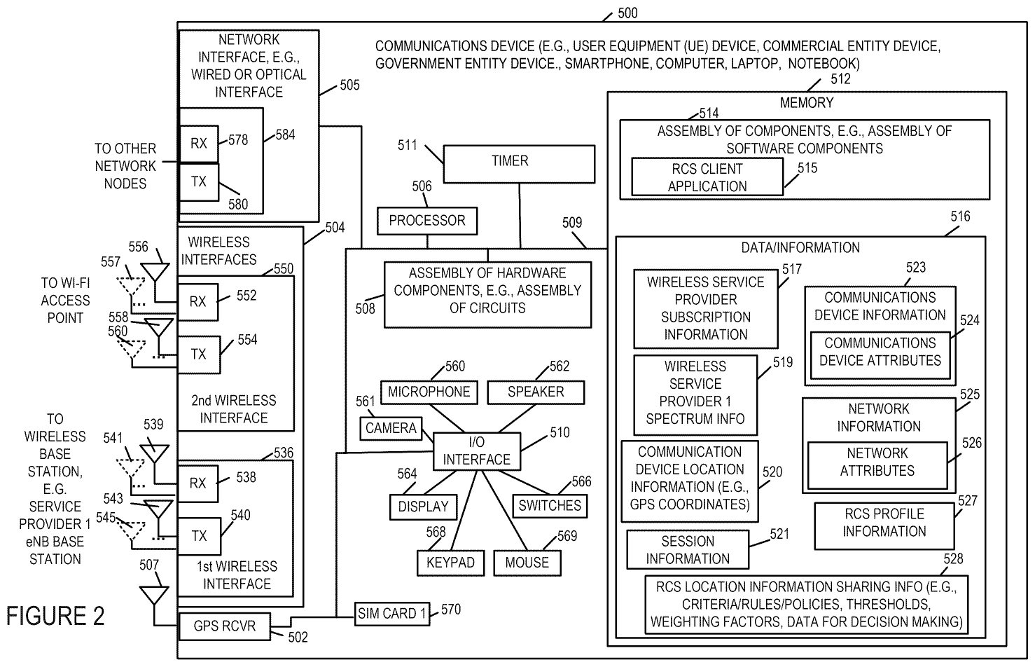

FIG. 2 is a drawing of an exemplary communications device 500 (e.g., a user equipment (UE) device, commercial entity communications device, government entity communications device such as for example a smartphone, wireless communications device, mobile phone, computer, laptop, notebook, tablet) in accordance with an exemplary embodiment. The exemplary communications device 500 is a mobile wireless device, but may be, and in some embodiments is, a non-wireless device in which case it does not have wireless interfaces but does include one or more network interfaces. The exemplary communications device 500 is a wireless device that is enabled to communicate with different wireless base stations utilizing wireless spectrum and/or wireless protocols, e.g., 5G wireless protocol, CBRS wireless protocol, Wi-Fi protocol, or cellular wireless protocol. Exemplary communications device 500 includes wireless interfaces 504, a network interface 505, a processor 506, e.g., a CPU, an assembly of hardware components 508, e.g., an assembly of circuits, and I/O interface 510, a GPS receiver 502 coupled to GPS receive antenna 507, a timer 511, e.g., a reference clock, a SIM card interface 570, and memory 512 coupled together via a bus 509 over which the various elements may interchange data and information. Communications device 500 further includes a microphone 560, camera 561, speaker 562, a display 564, e.g., a touch screen display, switches 566, keypad 568 and mouse 569 coupled to I/O interface 510, via which the various I/O devices (560, 561, 562, 564, 566, 568, 569) may communicate with other elements (502, 504, 505, 506, 508, 512, 570) of the communications device. Network interface 505 includes a receiver 578 and a transmitter 580. The network interface 505 can be coupled to routers within the home or customer premises or to wired (e.g., cable) or optical (e.g., fiber-optic) networks. In some embodiments, receiver 578 and transmitter 580 are part of a transceiver 584.

Wireless interfaces 504 include a plurality of wireless interfaces including first wireless interface 536 and a second wireless interface 550. The first wireless interface 536 is, e.g., used to communicate with wireless base stations in a first service provider's communications network, e.g., cellular, e.g., gNB tower base stations of the first service provider's communications network, e.g., using a first set of spectrum and a first communications protocol corresponding to the first service provider. The second wireless interface 550 is, e.g., used to communicate with a device, e.g., a Wi-Fi Access Point, or in some embodiments a second service provider's communications network. The first wireless interface 536 includes wireless receiver 538 and a wireless transmitter 540. In some embodiments, receiver 538 and transmitter 540 are part of a transceiver. In various embodiments, the first wireless interface 536 includes a plurality of wireless receivers and a plurality of wireless transmitters. Wireless receiver 538 is coupled to a plurality of receive antennas (receive antenna 1 539, . . . , receive antenna M 541, M being an integer greater than 1), via which communications device 500 can receive wireless signals from other wireless communications devices including a wireless base station, e.g., a cellular wireless base station of the first service provider. Wireless transmitter 540 is coupled to a plurality of wireless transmit antennas (transmit antenna 1 543, . . . , transmit antenna N 545, N being an integer greater than 1) via which the communications device 500 can transmit signals to other wireless communications devices including a cellular wireless base station of the first service provider. The antennas 539, . . . , 541 and 543, . . . 545 are typically mounted inside the housing of the wireless device but in some embodiments are located outside the communications device's housing. In some embodiments the various antennas form an antenna array with the antennas pointing in different directions. In some embodiments, one or more of the antennas are included inside the housing of the communications device and the user equipment device includes one or more connections to which exterior antennas may be connected.

The second wireless interface 550 includes wireless receiver 552 and a wireless transmitter 554. In some embodiments, receiver 552 and transmitter 554 are part of a transceiver. In various embodiments, the second wireless interface 550 includes a plurality of wireless receivers and a plurality of wireless transmitters. Wireless receiver 552 is coupled to one or more receive antennas (receive antenna 1 556, . . . , receive antenna M 557), via which communications device 500 can receive wireless signals from other wireless communications devices including, e.g. a Wi-Fi access point or a base station of a second service provider. Wireless transmitter 554 is coupled to one or more wireless transmit antennas (transmit antenna 1 558, . . . , transmit antenna N 560) via which the communications device 500 can transmit signals to other wireless communications devices including, a Wi-Fi access point or another wireless communications device. The communications device network interface 505 may be coupled to LAN or WAN networks or routers so that the communications device can also obtain services via a hardwired connection in addition to through the wireless interfaces, e.g. when the communications device 500 is at a location where such a connection is possible. In some embodiments, the communications device includes a plurality of network interfaces allowing the communications device to be connected via hardwires or cables to multiple networks simultaneously (e.g., Ethernet network interface, cable network interface, optical network interface).

Memory 512 includes an assembly of components 514, e.g., an assembly of software components, and data/information 516. In some embodiments, the assembly of software components 514 includes a Rich Communications Services (RCS) client application component 515 which enables the communications device 500 to receive Rich Communications Services. Data/information 516 includes service provider 1 subscription information 517, e.g. credentials and NAI realm information corresponding to wireless service provide 1. Data/information 516 further includes wireless service provider 1 spectrum information 519 (e.g., spectrum on which the wireless service provider 1 operates, communications device location information 520 (e.g., GPS coordinates received from the GPS receiver 502), session information 521 (session type, session endpoint addresses, data type of session, session state information), communications device information (e.g., power/battery level information, power/battery usage information, power/battery capacity information, signaling information, location information, usage information, connection information, performance metrics, information collected in response to requests from the OSS network equipment and/or base station), network information 525 (network identifier, network type, and network availability information, information on network(s) to which the communications device is connected, information on communications device configurations for priority of network connections and selection when multiple network availability (e.g., wired network interface (highest selection), Wi-Fi network (second highest selection), cellular network (third highest selection and/or default), network identifier for network(s) selected for RCS messaging/sessions and network priority selection if multiple networks are available), RCS profile information 527, and RCS location information sharing information 528 used for determining when, how, and to whom RCS location information is to be shared including for example RCS location sharing criteria 528 including for example, device attribute location sharing criteria, network attribute location sharing criteria, rules (e.g., user defined rules, network defined rules, public safety defined rules, and/or event rules (e.g., different event rules for the occurrence of different events)) to be implemented for determining location sharing, policies to be implemented for determining location sharing, threshold levels and/or values to be employed for determining location sharing (e.g., device attribute threshold levels and/or values), priority weighting assignments values (e.g., for rules, policies and RCS attributes used for making RCS location information sharing decisions), data collected for making the location information sharing decisions (e.g., attribute values), event rules/conditions which can trigger a RCS location information sharing determination, plurality of sets of RCS location information sharing attributes with each set being used for making a RCS location information sharing decision in response to the occurrence of a particular event. The communications device information includes communications device attributes 524. The network information 525 includes network attribute information 526 (e.g., network identifier information, network type).

While the exemplary communications device 500 is enabled to communicate with different wireless systems using different wireless spectrum and/or protocols such as for example a cellular network base station and a Wi-Fi Access Point, the communications device 500 in some embodiments is operated and/or enabled to communicate using only a single wireless protocol such as for example 5G wireless protocol or a single wired or optical network interface.

In some embodiments, the user equipment devices, commercial entity communications devices, government entity communications devices, and end-point devices discussed in the Figures and/or in connection with the embodiments of the present invention are implemented in accordance with communications device 500. For example, UE 1 1010, UE 2 1014, UE 3 1018, UE 4 1022, UE 5 1026, UE 6 1030, UE 7 1034, UE 8 1037, UE 9 1039, UE 10 1042, UE 11 1046, UE 12 1050, UE 13 1054, . . . , UE N 1058, commercial entity 1 communications device 1 1088, . . . , commercial entity M communications device 1090, government entity 1 communications device 1092, . . . , government entity P communications device 1094 in the system 1000 shown in FIG. 1 may be, and in some embodiments are, implemented in accordance with communications device 500.

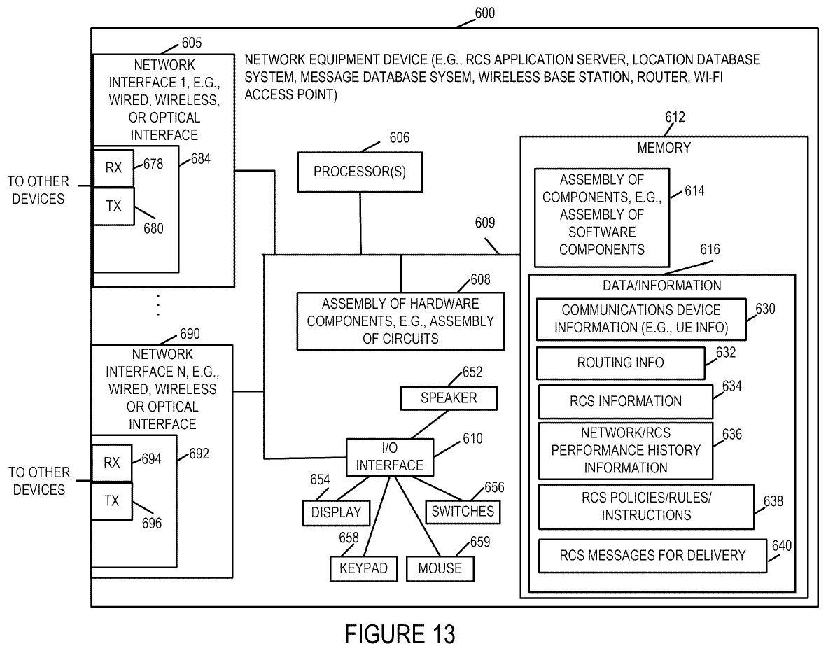

FIG. 13 is a drawing of an exemplary network equipment device, system, server or node, e.g., RCS Application Server, location database system, message database system, OSS device, wireless base station, router, Wi-Fi Access Point, in accordance with an embodiment of the present invention. The network equipment device/system/server/node of FIG. 13 will be referred to as network equipment device 600.

The network equipment device 600 includes a plurality of network interfaces 605, . . . , 690, e.g., a wired, wireless or optical interface, a processor(s) 606 (e.g., one or more processors), e.g., a CPU, an assembly of hardware components 608, e.g., an assembly of circuits, and I/O interface 610 and memory 612 coupled together via a bus 609 over which the various elements may interchange data and information. The network equipment device 600 further includes a speaker 652, a display 654, switches 656, keypad 658 and mouse 659 coupled to I/O interface 610, via which the various I/O devices (652, 654, 656, 658, 659) may communicate with other elements (605, . . . , 690, 606, 608, 612) of the network equipment device 600. Network interface 1 605 (e.g., a wired, wireless, or optical interface) includes a receiver 678 and a transmitter 680. If the network interface 605 is a wireless interface the receiver 678 and transmitter 680 include antennas for receiving and transmitting wireless signals. The network interface 605 is typically used to communicate with other devices/systems/nodes/servers, e.g., communications devices, user equipment devices, core network equipment, OSS, databases (e.g., location database, message database), wireless base stations, routers, Wi-Fi Access Points, commercial entity devices, government entity devices, RCS application server, and cloud system. In some embodiments, receiver 678 and transmitter 680 are part of a transceiver 684. Network interface N 690 (e.g., a wired, wireless, or optical interface) includes a receiver 694 and a transmitter 696. The network interface 690 is typically used to communicate with other devices/systems/nodes/servers, e.g., communications devices, user equipment devices, core network equipment, OSS, databases (e.g., location database, message database), wireless base stations, routers, Wi-Fi Access Points, commercial entity devices, government entity devices, RCS application server, cloud system, etc. In some embodiments, receiver 694 and transmitter 696 are part of a transceiver 692. Memory 612 includes an assembly of component 614, e.g., an assembly of software components, and data/information 616. Data/information 616 includes communications device information 630 (e.g., UE information), routing information 632, Rich Communications Service (RCS) information 634, network, device, and RCS performance history information 636, RCS policies/rules/instructions 638 (e.g., for making RCS location information sharing decisions to be distributed to communications devices and/or used by the network equipment device), and RCS messages for delivery (e.g., RCS messages which are to be forwarded to a destination communications device when the destination communications device is available). In some embodiments, the RCS policies, rules and/or instructions 640 are included in the RCS information. The RCS information 634 includes information for providing and/or implementing RCS location information sharing services including communications devices profile information when the network equipment device is RCS application server. The specific information included in data/information 616 depends on the specific network equipment device implemented. For example, RCS policies, rules and instructions would be included when the network equipment device is a RCS application server but would not be included if the network equipment device was router.

In some embodiments, the network equipment devices discussed in the Figures and/or in connection with the embodiments of the present invention described are implemented in accordance with network equipment device 600. For example, the RCS application server 1002, location database system 1006, message database 1008, wireless base stations of system 1000, the routers of system 1000, the Wi-Fi Access Points of system 1000, and network equipment devices making up network A 1084 and network B 1086 infrastructure of system 1000 shown in FIG. 1, may be, and in some embodiments are, implemented in accordance with the network equipment device 600.

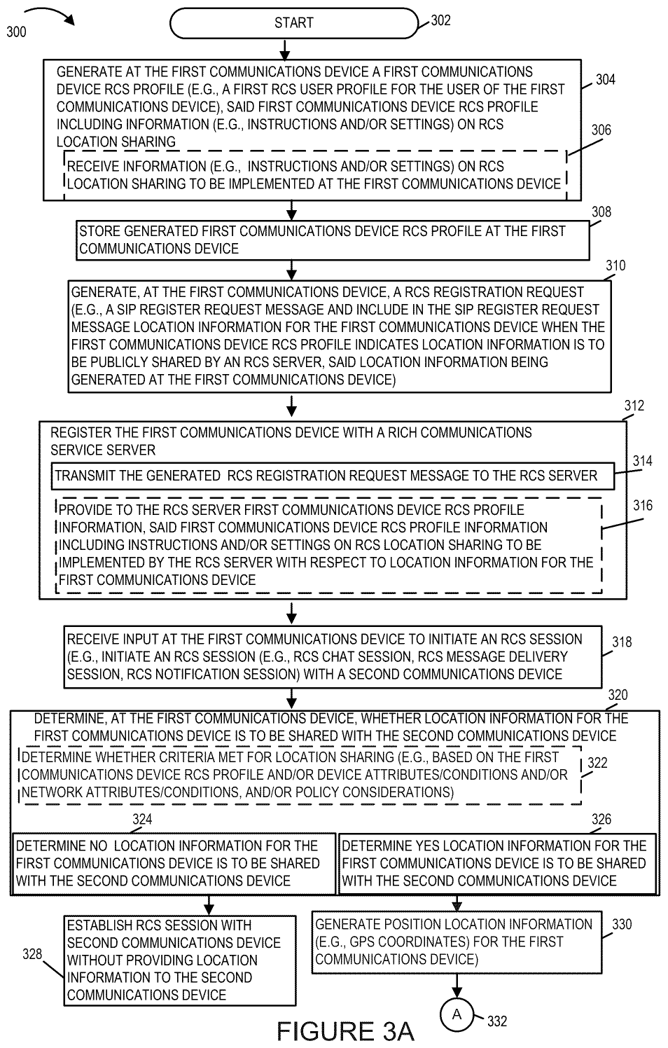

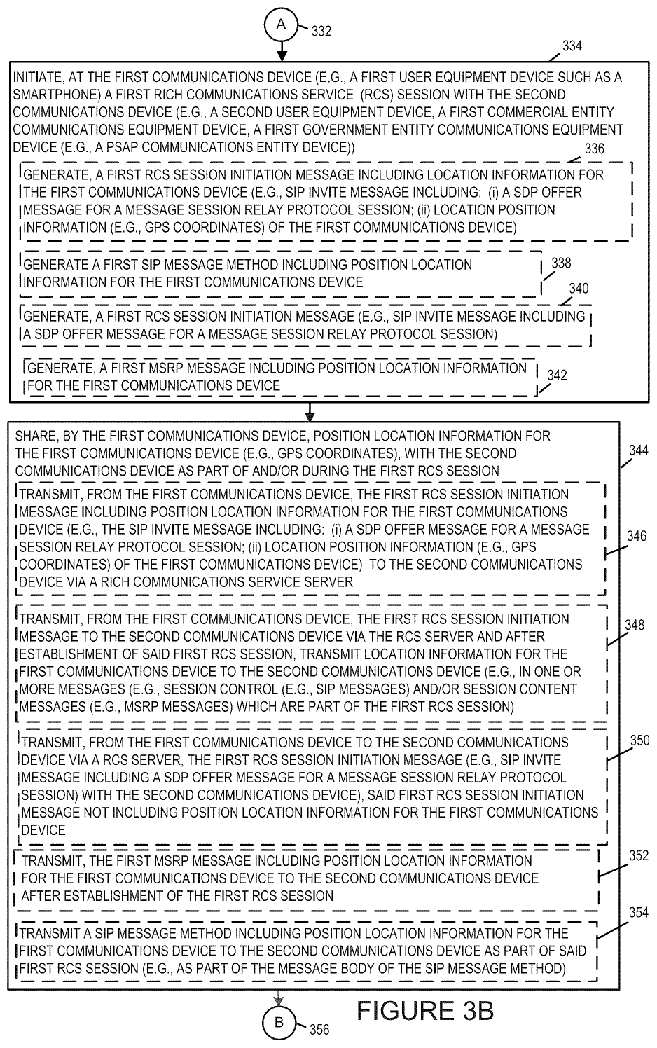

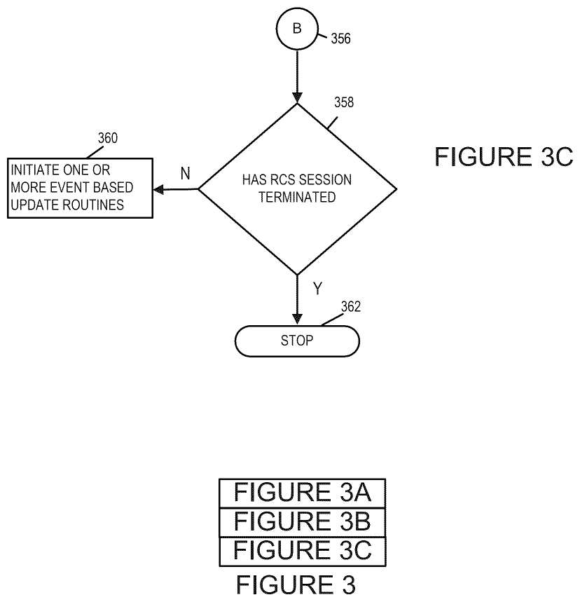

FIG. 3 comprises FIG. 3A, FIG. 3B, and FIG. 3C. FIG. 3A is the first part of a flowchart of an exemplary method 300 in accordance with an embodiment of the present invention. FIG. 3B is the second part of a flowchart of an exemplary method 300 in accordance with an embodiment of the present invention. FIG. 3C is the third part of a flowchart of an exemplary method 300 in accordance with an embodiment of the present invention.

While it will be readily understood that additional steps are performed in connection with communicating information, data, and messages between devices, the method 300 focuses on and discusses the steps for understanding the invention. The method 300 will be discussed in connection with the exemplary system 1000 but is not limited to being implemented on system 1000 and can be implemented on other systems.

Method 300 begins in start step 302 shown on FIG. 3A. Operation proceeds from step 302 to step 304. In step 304, a first communications device Rich Communications Services (RCS) profile (e.g., a first RCS user profile for the user of the first communications device) is generated at and/or by the first communications device (e.g., UE 1 1010). The first communications device RCS profile includes information (e.g., instructions and/or settings) on RCS location sharing for the first communications device. In some embodiments, step 304 includes sub-step 306. In sub-step 306, the first communications device (e.g., an RCS client application (e.g., RCS client 1012) of the first communications device) receives information (e.g., instructions and/or settings) on RCS location sharing to be implemented at the first communications device (e.g., from a user during the configuration of the RCS client application and/or the first communications device and/or during installation of the RCS client application). The information may be, and in some embodiments is received, from a user of the first communications device in response to prompts soliciting configuration information sharing of location information for the first communications device via the RCS client application. Operation proceeds from step 304 to step 306.

In 308, the generated first communications device RCS profile is stored at the first communications device (e.g., in a storage device such as memory included in the first communications device). Operation proceeds from step 308 to step 310.

In step 310, a Rich Communications Services (RCS) registration request message (e.g., a SIP REGISTER request message is generated at the first communications and includes location information for the first communications device when the first communications device RCS profile indicates location information is to be publicly shared by an RCS server with other entities. The location information being generated at the first communications device and being included in a header of the SIP REGISTER request message and/or in the message body portion of the SIP REGISTER request message. In some embodiments, an RCS client application executing on the first communications device (e.g., RCS client 1012 of UE 1 1010) generates the SIP REGISTER request message. Operation proceeds from step 310 to step 312.

In step 312, the first communications device is registered with a Rich Communications Services (RCS) Server (e.g., RCS Application Server 1002). In some embodiments, step 312 includes one or more sub-steps 314 and 316. In sub-step 314, the first communications device transmits the generated RCS registration request message to the RCS server. In sub-step 316, the RCS server is provided first communications device RCS profile information. The first communications device RCS profile information including instructions and/or settings on RCS location sharing to be implemented by the RCS server with respect to location information for the first communications device (e.g., conditions and/or criteria the RCS server is authorized to share the first communications device location information with other communications devices and/or entities such as no restrictions, other communications devices identified by the first communications device (e.g., communications devices on its contact list), communications devices of commercial entities, communications devices of government entities). Operation proceeds from step 312 to step 318.

In step 318 receive input at the first communications device to initiate a Rich Communications Services (RCS) session (e.g., initiate an RCS session such as for example a RCS chat session, RCS message delivery session, RCS notification session) with a second communications device (e.g., a user equipment communications device (e.g., UE 11 1046), a commercial entity communications device (e.g., commercial entity 1 1088) or a government entity communications device (e.g., government entity 1 1092)). Operation proceeds from step 318 to step 320.

In step 320, the first communications device (e.g., the RCS client of the first communications device) determines whether location information for the first communications device is to be shared with the second communications device. In some embodiments, step 320 includes sub-step 322. In sub-step 322, the first communications device determines whether criteria are meth for location sharing (e.g., based on the first communications device RCS profile and/or device attributes/conditions and/or network attributes/condition, and/or policy considerations such as for example whether the second communications device is Public Safety Assess Point communications device (e.g., 911 call center).

In sub-step 324 of step 320, the determination is that the first communications device location information is not to be shared with the second communications device. Operation proceeds from sub-step 324 to step 328. In step 328, an RCS session is established between the first communications device and the second communications device without the first communications device sharing and/or providing location information for the first communications device to the second communications device.

In sub-step 326 of step 320, the determination is that the first communications device location information is to be shared with the second communications device. Operation proceeds from sub-step 326 to step 330.

In step 330, the first communications device generates position location information (e.g., GPS coordinates) for the first communications device. Operation proceeds from step 330 via connection node A 332 to step 334 shown on FIG. 3B.

In step 334, a first RCS session is initiated by the first communication (e.g., by the RCS client application of the first communications device) with the second communications device (e.g., a second user equipment device, a first commercial entity communications equipment device, a first government entity communications equipment device (e.g., a PSAP communications entity device)). In some embodiments, step 334 includes one or more sub-steps 336, 338, 340, and 342. In sub-step 336, generate (e.g., by the RCS client application on the first communications device) a first RCS session initiation message, the first RCS session initiation message including location information for the first communications device (e.g., a SIP INVITE message including: (i) a Session Description Protocol (SDP) offer message for a Message Session Relay Protocol (MSRP) session, (ii) location position information (e.g., GPS coordinates) of the first communications device). In sub-step 338, the first communications device (e.g., the RCS client application of the first communications device) generates a first SIP MESSAGE method including position location information for the first communications device. In sub-step 340, a first RCS session initiation message (e.g., SIP INVITE message including a SDP offer message for a MSRP session is generated by the first communications device. In sub-step 342, a first MSRP message including position location information for the first communications device is generated by the first communications device. Operation proceeds from step 334 to step 344.

In step 344, the first communications device (e.g., the RCS client application of the first communications device) shares position location information for the first communications device (e.g., GPS coordinates) with the second communications device as part of and/or during the first RCS session. In some embodiments, step 344 includes one or more sub-steps 346, 348, 350, 352, and 354. In sub-step 346, the first communications device transmits the first RCS session initiation message including position location information for the first communications devices (e.g., the SIP INVITE message including: (i) a SDP offer message for a MSRP session, (ii) location position information (e.g., GPS coordinates) of the first communications device) to the second communications device via a Rich Communications Services (RCS) server (e.g., RCS application server 1002 of system 1000). In sub-step 348, the first RCS session initiation message is transmitted from the first communications device to the second communications device via the RCS server (e.g., RCS application server 1002); and after establishment of said first RCS session, the location information for the first communications device is transmitted from the first communications to the second communications (e.g., in one or more messages (e.g., session control messages (e.g., SIP messages) and/or session content messages (e.g., MSRP messages) which are part of the first RCS session. In sub-step 350, the first communications device transmits to the second communications device via a RCS server (e.g., RCS application server 1002) the first RCS session initiation message (e.g., a SIP INVITE message including a SDP offer message for a MSRP session with the second communications device). The first RCS session initiation message not including position location information for the first communications device. In sub-step 352, the first communications device transmits the first MSRP message which includes position location information for the first communications device to the second communications device after establishment of the first RCS session. The first MSRP message being received and relayed to the second communications device by the RCS server. In sub-step 354, the first communications device transmits a SIP MESSAGE method which includes position location information for the first communications device to the second communications device as part of the first RCS session (e.g., as part of the message body of the SIP MESSAGE method message. The SIP MESSAGE method is communicated to the second communications device via the RCS server. Operation proceeds from step 344 via connection node B 356 to decision step 358 shown on FIG. 3C.

In decision step 358, the first communications device makes the decision of whether or not the first RCS session has terminated.

When the decision is that the first RCS session has not terminated then operation proceeds from step 358 to step 360. In step 360, the first communications device (e.g., the RCS client application of the first communications device) initiates one or more event based routines. The one or more event based routines include: (i) an event based location update periodic event routine, (ii) an event based location update mobility event routing, (iii) an event based location update communications device (e.g., UE) attributes/conditions event routine, and (iv) an event based location update network attributes/conditions event routine.

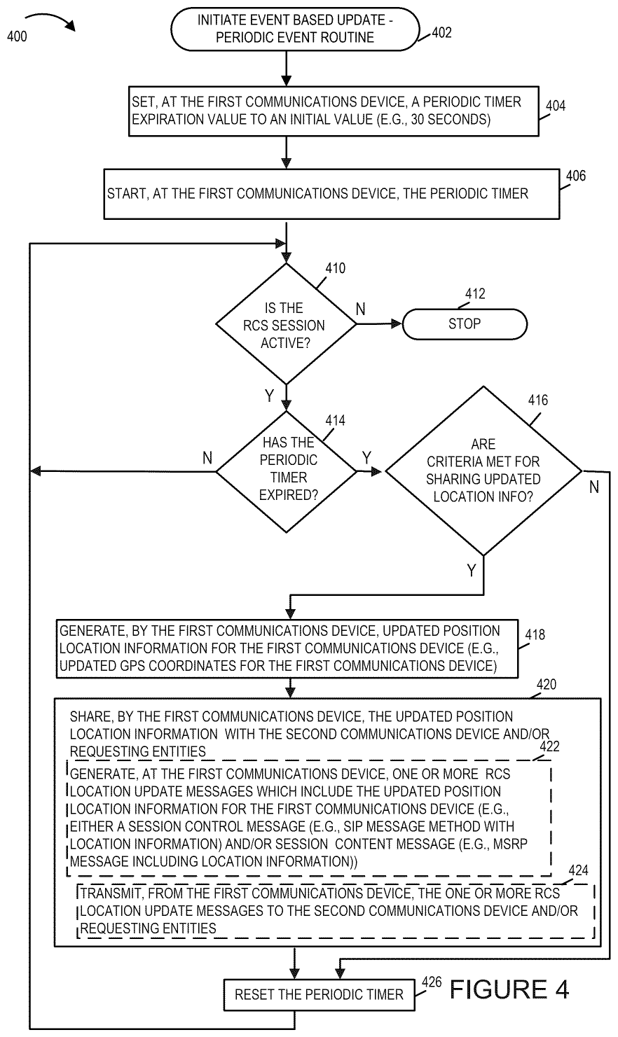

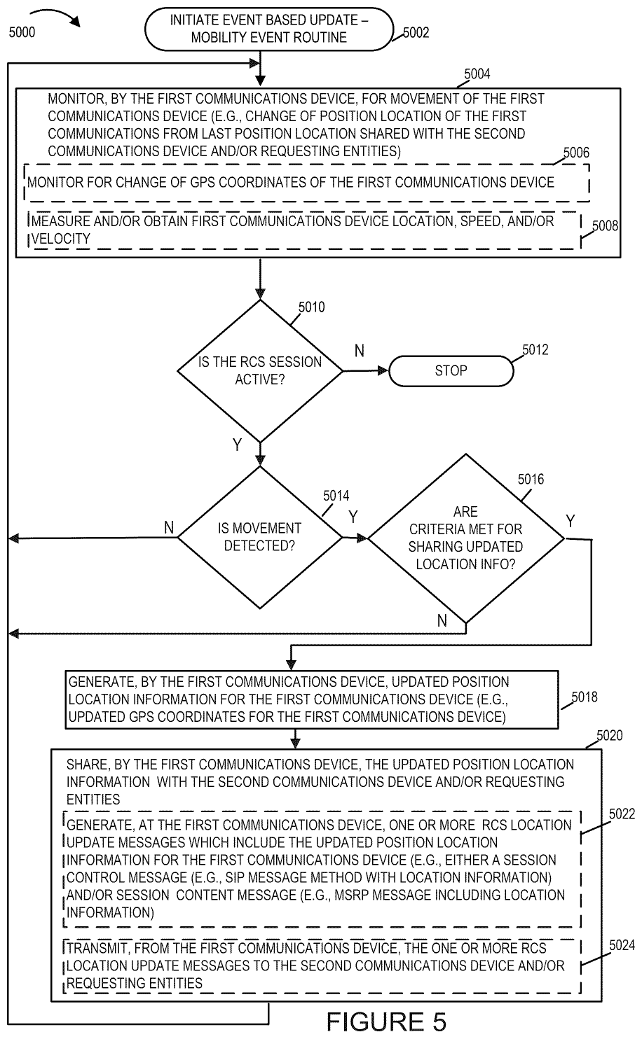

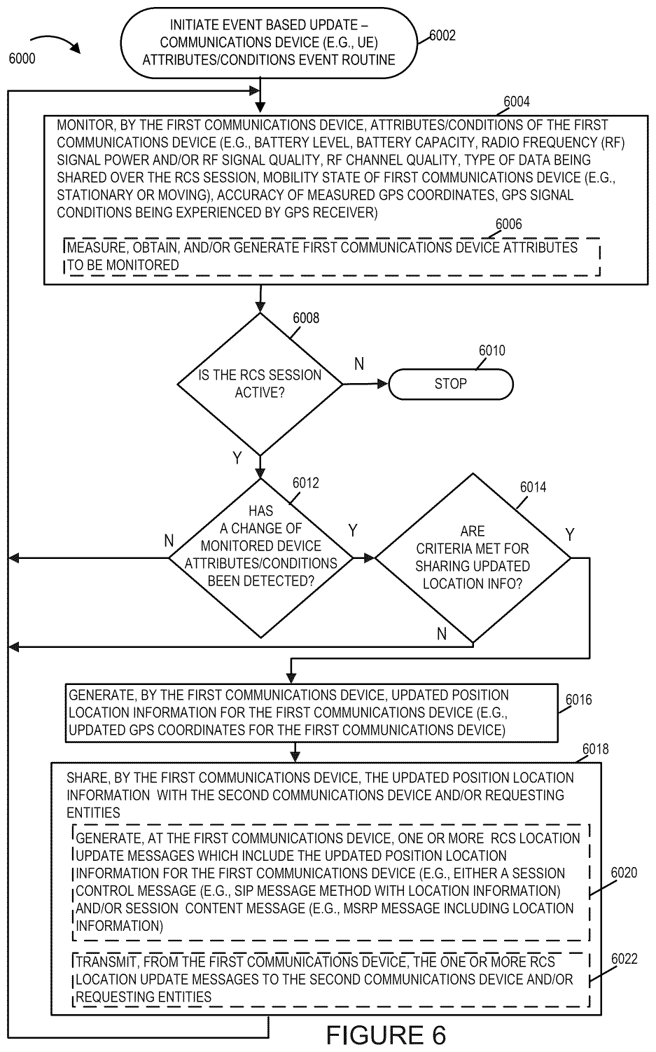

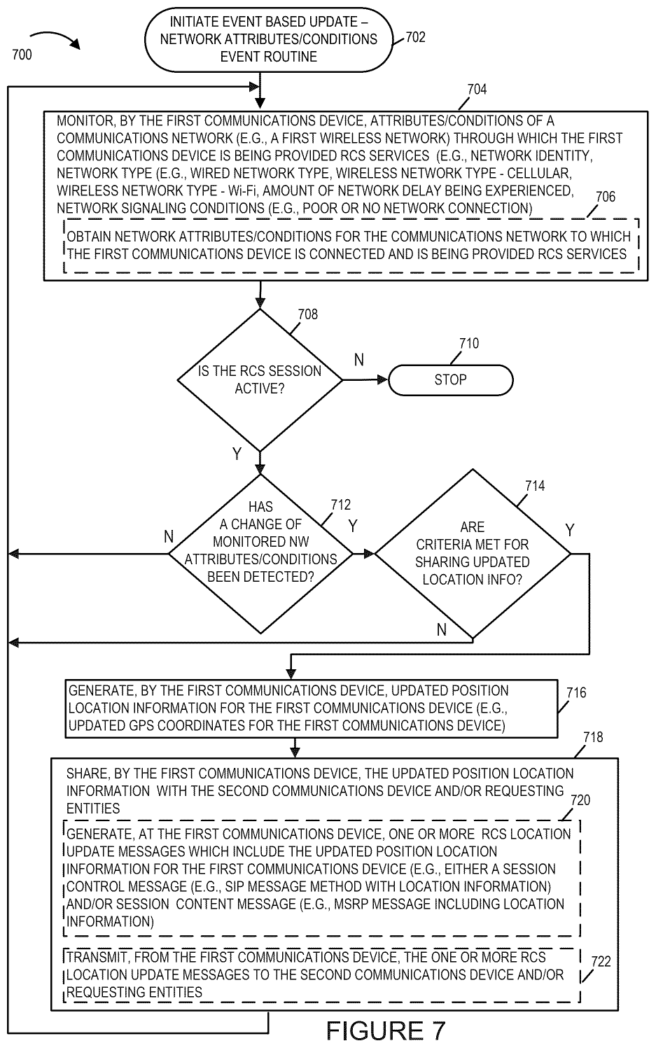

FIG. 4 illustrates a flowchart of an exemplary event based location update periodic event routine 400. FIG. 5 illustrates a flowchart of an exemplary event based location update mobility event routine 5000 in accordance with an embodiment of the present invention. FIG. 6 illustrates a flowchart of an exemplary event based location update communications device (e.g., UE) attributes/conditions event routine 6000 in accordance with an embodiment of the present invention. FIG. 7 illustrates a flowchart of an exemplary event based location update network attributes/conditions event routine 7000 in accordance with an embodiment of the present invention. Each of the routines 400, 5000, 6000, and 7000 are methods and are sometimes referred to as methods herein.

When the decision is that the first RCS session has terminated then operation proceeds from step 358 to stop step 362.

As previously discussed, FIG. 4 illustrates a flowchart of an exemplary event based location update periodic event routine 400. While it will be readily understood that additional steps are performed in connection with communicating information, data, and messages between devices, the routine 400 focuses on and discusses the steps for understanding the invention. The routine 400 will be discussed in connection with the exemplary system 1000 but is not limited to being implemented on system 1000 and can be implemented on other systems.

The exemplary event based location update periodic event routine 400 is initiated by the first communications device (e.g., by the RCS client application executing on the first communications device) in step 402 shown on FIG. 4. Operation proceeds from step 402 to step 404.

In step 404, a periodic timer expiration value is set to an initial value (e.g., 30 seconds) at the first communications device. Operation proceeds from step 404 to step 406. In step 406, the periodic timer at the first communications device is started. In some embodiments, the periodic timer is an RCS location sharing update timer started by the RCS client application which has just established a RCS session and/or just shared location information for the first communications device. In some embodiments the periodic timer is a software timer. In some embodiments, the periodic timer is a hardware timer included in the first communications device. Operation proceeds from step 408 to decision step 410.

In decision step 410, when the first RCS session is not active but has ended, operation proceeds from step 410 to step 412 where the routine 400 stops or ends. When the first RCS session is active, operation proceeds from step 410 to decision step 414.

In decision step 414, the first communications device, e.g., the RCS client application of the first communications device, determines whether or not the periodic timer expired. When the periodic timer has not expired, operation proceeds from step 414 to step 410. When the periodic timer has expired, operation proceeds from step 414 to decision step 416.

In decision step 416, the first communications device (e.g., the RCS client application of the first communications device) determines whether criteria are met for sharing updated location information for the first communications device. For example, in some embodiments the criteria to be met in step 416 is the expiration of the periodic timer. In such embodiments, when the periodic timer has expired the criteria is met for sharing updated location information. If the periodic timer has not expired then the criteria is not met in such embodiments. In some embodiments, the criteria to be met in step 416 is defined by a periodic event rule which defines a set of one or more criteria that must be met (e.g., (i) periodic timer has expired, (ii) location of first communications device has changed by a threshold amount since last sharing of location information with the second communications device, (iii) first communications device has authorized or consented to sharing of location information with the second communications device). When the decision in step 416 is that the criteria has not been met for sharing updated location information, operation proceeds from step 416 to step 426. When the decision in step 416 is that the criteria is met for sharing updated location information operation proceeds from step 416 to step 418.

In step 418, updated position location information for the first communications device is generated at the first communications device (e.g., updated GPS coordinates for the first communications device). Operation proceeds from step 418 to step 420.

In step 420, the first communications device shares the updated position location information for the first communications device with the second communications device and/or requesting entities (e.g., requesting devices such as the RCS server). In some embodiments, step 420 includes one or more sub-steps 422 and 424. In sub-step 422, one or more RCS location update messages which include the updated position location information for the first communications device (e.g., either a session control message (e.g., SIP MESSAGE method with location information or SIP UPDATE message with location information) and/or session content message (e.g., MSRP message including location information)) is generated by the first communications devices (e.g., by the RCS client application). In sub-step 424, the first communications device transmits from the first communications device the one or more RCS location update messages to the second communications device and/or requesting entities. Operation proceeds from step 420 to step 426.

In step 426, the first communications device, e.g., the RCS client application of the first communications device, resets and/or refreshes the periodic timer. In some embodiments, the periodic timer counts up to the expiration value so that resetting the expiration value includes resetting the timer to a value of zero and allowing the timer to continue to run from that time to the expiration value. In other embodiments, the timer is a count down timer and resetting the expiration timer includes setting it to the expiration value (e.g., 30 seconds) from which it is to count down to zero. Operation proceeds from step 426 back to decision step 410 where the steps of the routine are repeated.

As previously discussed, FIG. 5 illustrates a flowchart of an exemplary event based location update mobility event routine 5000 in accordance with an embodiment of the present invention. While it will be readily understood that additional steps are performed in connection with communicating information, data, and messages between devices, the routine 5000 focuses on and discusses the steps for understanding the invention. The routine 5000 will be discussed in connection with the exemplary system 1000 but is not limited to being implemented on system 1000 and can be implemented on other systems.

The exemplary event based location update mobility event routine 5000 is initiated by the first communications device (e.g., by the RCS client application executing on the first communications device) in step 5002 shown on FIG. 5. Operation proceeds from step 5002 to step 5004.

In step 5004, the first communications device (e.g., the RCS client application of the first communications device) monitors for movement of the first communications device (e.g., change of position location of the first communications device from the last position location shared with the second communications device and/or requesting entity). In some embodiments, monitoring for is performed for movement beyond a first threshold amount (e.g., greater than 100 ft) and/or at a speed greater than a first speed threshold value (e.g., greater than 1.5 miles per hour). In some embodiments, step 5004 includes one or more sub-steps 5006 and 5008. In sub-step 5006, the first communications device monitors for change of GPS coordinates of the first communications device. In sub-step 5008, the first communications device measures and/or obtains first communications device location, speed and/or velocity. Operation proceeds from step 5004 to decision step 5010.

In decision step 5010, the first communications device, e.g., the RCS client application of the first communications device, determines whether the first RCS session is still active. In decision step 5010, when the first RCS session is not active but has ended, operation proceeds from step 5010 to step 5012 where the routine 5000 stops or ends. When the first RCS session is active, operation proceeds from step 5010 to decision step 5014.

In decision step 5014, the first communications device, e.g., the RCS client application of the first communications device, determines whether or not movement of the first communications device has been detected by the monitoring. Movement of the first communications device is a mobility event. When the mobility event or movement has not been detected, operation proceeds from step 5014 to step 5004. When a mobility event or movement has been detected by the monitoring, operation proceeds from step 5014 to decision step 5016.

In decision step 5016, the first communications device (e.g., the RCS client application of the first communications device) determines whether criteria are met for sharing updated location information for the first communications device. For example, in some embodiments the criteria to be met in step 5016 is whether movement of the first communications device has been detected. In such embodiments, when movement has been detected the criteria is met for sharing updated location information. If no movement of the first communications device has been detected then the criteria is not met in such embodiments. In some embodiments, the criteria to be met in step 5016 is defined by a mobility event rule which defines a set of one or more criteria that must be met (e.g., (i) movement of the first communications device by an amount greater than a first threshold amount of movement has been detected, (ii) the movement of the first communications device is at a speed greater than a first speed threshold value or level, and (iii) the first communications device has authorized or consented to sharing of location information with the second communications device). When all of the defined criteria of the set defined by the mobility event rule has been met, the decision in step 5016 in such embodiments is that the criteria has been met for sharing updated location information. When not all of the criteria of the set defined by the mobility event rule have been met, then the decision in step 5016 is that the criteria has not been met for sharing location information. When the decision in step 5016 is that the criteria has not been met for sharing updated location information operation proceeds from step 5016 to step 5004. When the decision in step 5016 is that the criteria is met for sharing updated location information operation proceeds from step 5016 to step 5018.

In step 5018, updated position location information for the first communications device is generated at the first communications device (e.g., updated GPS coordinates for the first communications device). Operation proceeds from step 5018 to step 5020.

In step 5020, the first communications device shares the updated position location information for the first communications device with the second communications device and/or requesting entities (e.g., requesting devices such as the RCS server). In some embodiments, step 5020 includes one or more sub-steps 5022 and 5024. In sub-step 5022, one or more RCS location update messages which include the updated position location information for the first communications device (e.g., either a session control message (e.g., SIP MESSAGE method with location information or SIP UPDATE message with location information) and/or session content message (e.g., MSRP message including location information)) is generated by the first communications devices (e.g., by the RCS client application). In sub-step 5024, the first communications device transmits from the first communications device the one or more RCS location update messages to the second communications device and/or requesting entities. Operation proceeds from step 5020 to step 5004 where the steps of the routine are repeated.

As previously discussed, FIG. 6 illustrates a flowchart of an exemplary event based location update communications device (e.g., UE) attributes/conditions event routine 6000 in accordance with an embodiment of the present invention. While it will be readily understood that additional steps are performed in connection with communicating information, data, and messages between devices, the routine 6000 focuses on and discusses the steps for understanding the invention. The routine 6000 will be discussed in connection with the exemplary system 1000 but is not limited to being implemented on system 1000 and can be implemented on other systems.

The exemplary event based location update communications device (e.g., UE) attributes/conditions event routine 6000 is initiated by the first communications device (e.g., by the RCS client application executing on the first communications device) in step 6002 shown on FIG. 6. Operation proceeds from step 6002 to step 6004.

In step 6004, the first communications device (e.g., the RCS client application of the first communications device) monitors attributes and/or conditions of the first communications device (e.g., battery level, battery capacity, radio frequency (RF) signal power and/or RF signal quality, RF channel quality, type of data being shared over the RCS session, mobility state of the first communications device (e.g., station or moving), accuracy of measured GPS coordinates, GPS signal conditions being experienced by the GPS receiver). In some embodiments, step 6004 includes one or more sub-steps 6006. In sub-step 6006, the first communications device measures and/or obtains first communications device attributes and/or conditions being experienced by the first communications device (e.g., the attributes and/or conditions being monitored for changes). Operation proceeds from step 6006 to decision step 6008.

In decision step 6008, the first communications device, e.g., the RCS client application of the first communications device, determines whether the first RCS session is still active. In decision step 6008, when the first RCS session is not active but has ended, operation proceeds from step 6008 to step 6010 where the routine 6000 stops or ends. When the first RCS session is active, operation proceeds from step 6008 to decision step 6012.

In decision step 6012, the first communications device, e.g., the RCS client application of the first communications device, determines whether or not a change of the monitored device attributes/conditions has been detected by the monitoring. When a change of the monitored device attributes/conditions has not been detected, operation proceeds from step 6012 to step 6004. When a change of the monitored device attributes/conditions has been detected by the monitoring, operation proceeds from step 6012 to decision step 6014.

In decision step 6014, the first communications device (e.g., the RCS client application of the first communications device) determines whether criteria are met for sharing updated location information for the first communications device. For example, in some embodiments the criteria to be met in step 6014 is whether one or more of the monitored device attribute(s)/condition(s) have changed to be outside of or beyond defined limits or thresholds. In such embodiments, when one or more of the monitored device attribute(s)/condition(s) of the first communications device have been changed to be outside of or beyond defined limits or thresholds then the criteria is met for sharing updated location information. If none of the monitored device attribute(s)/condition(s) have changed to be outside of or beyond defined limits or thresholds then the criteria is not met in such embodiments. In some embodiments, the criteria may require more than one or all of the monitored device attribute(s)/condition(s) to have changed to be outside of or beyond defined limits or thresholds for the criteria to be met. In some embodiments, the criteria to be met in step 6014 is defined by an device attributes event rule which defines a set of one or more criteria that must be met (e.g., (i) a specified set of device attributes of the first communications have changed to be outside of or beyond defined limits or threshold values (e.g., radio frequency signal quality level has changed beyond a defined radio frequency quality threshold level, radio frequency signal strength/power has changed beyond a defined radio frequency signal strength/power threshold), and (ii) the first communications device has authorized or consented to sharing of location information with the second communications device). When all of the defined criteria of the set defined by the device attributes event rule have been met, the decision in step 6014 in such embodiments is that the criteria has been met for sharing updated location information. When not all of the criteria of the set defined by the device attributes event rule have been met, then the decision in step 6014 is that the criteria has not been met for sharing location information.

When the decision in step 6014 is that the criteria has not been met for sharing updated location information operation proceeds from step 6014 to step 6004. When the decision in step 6014 is that the criteria has been met for sharing updated location information operation proceeds from step 6014 to step 6016.

In step 6016, updated position location information for the first communications device is generated at the first communications device (e.g., updated GPS coordinates for the first communications device). Operation proceeds from step 6016 to step 6018.

In step 6018, the first communications device shares the updated position location information for the first communications device with the second communications device and/or requesting entities (e.g., requesting devices such as the RCS server). In some embodiments, step 6018 includes one or more sub-steps 6020 and 6022. In sub-step 6020, one or more RCS location update messages which include the updated position location information for the first communications device (e.g., either a session control message (e.g., SIP MESSAGE method with location information or SIP UPDATE message with location information) and/or session content message (e.g., MSRP message including location information)) is generated by the first communications devices (e.g., by the RCS client application). In sub-step 6022, the first communications device transmits from the first communications device the one or more RCS location update messages to the second communications device and/or requesting entities. Operation proceeds from step 6018 to step 6004 where the steps of the routine are repeated.

As previously discussed, FIG. 7 illustrates a flowchart of an exemplary event based location update network attributes/conditions event routine 700 in accordance with an embodiment of the present invention. While it will be readily understood that additional steps are performed in connection with communicating information, data, and messages between devices, the routine 700 focuses on and discusses the steps for understanding the invention. The routine 700 will be discussed in connection with the exemplary system 1000 but is not limited to being implemented on system 1000 and can be implemented on other systems.

The exemplary event based location update network attributes/conditions event routine 700 is initiated by the first communications device (e.g., by the RCS client application executing on the first communications device) in step 702 shown on FIG. 7. Operation proceeds from step 702 to step 704.

In step 704, the first communications device (e.g., the RCS client application of the first communications device) monitors attributes and/or conditions of a communications network (e.g., a first network such a wireless network or a wired network) through which the first communications device is being provided RCS services (e.g., network identity, network type (e.g., wired network type, wireless network type, wireless network type—cellular, wireless network type—CBRS, wireless network type-Wi-Fi, amount of network delay being experienced, network signaling conditions (e.g., poor, good, excellent, or no network connection). In some embodiments, step 704 includes one or more sub-steps 706. In sub-step 706, the first communications device measures and/or obtains network attributes and/or conditions for the communications network to which the first communications device is connected and through which the first communications device is being provided RCS services. For example, the communications network on which the first RCS session has been established. Operation proceeds from step 706 to decision step 708.

In decision step 708, the first communications device, e.g., the RCS client application of the first communications device, determines whether the first RCS session is still active. In decision step 708, when the first RCS session is not active but has ended, operation proceeds from step 708 to step 710 where the routine 700 stops or ends. When the first RCS session is active, operation proceeds from step 708 to decision step 712.

In decision step 712, the first communications device, e.g., the RCS client application of the first communications device, determines whether or not a change of the monitored network attributes/conditions has been detected by the monitoring. When a change of the monitored network attributes/conditions has not been detected, operation proceeds from step 712 to step 704. When a change of the monitored network attributes/conditions has been detected by the monitoring, operation proceeds from step 712 to decision step 714.

In decision step 714, the first communications device (e.g., the RCS client application of the first communications device) determines whether criteria are met for sharing updated location information for the first communications device.

For example, in some embodiments the criteria to be met in step 714 is whether one or more of the monitored attribute(s)/condition(s) of the communications network have changed to be outside of or beyond defined limits or thresholds. In such embodiments, when one or more of the monitored network attribute(s)/condition(s) have been changed to be outside of or beyond defined limits or thresholds then the criteria is met for sharing updated location information. If none of the monitored network attribute(s)/condition(s) have changed to be outside of or beyond defined limits or thresholds then the criteria is not met in such embodiments. In some embodiments, the criteria may require more than one or all of the monitored network attribute(s)/condition(s) to have changed to be outside of or beyond defined limits or thresholds for the criteria to be met. In some embodiments, the criteria to be met in step 714 is defined by an network attributes event rule which defines a set of one or more criteria that must be met (e.g., (i) a specified set of network attributes/conditions of the first communications have changed to be outside of or beyond defined limits or threshold values, and (ii) the first communications device has authorized or consented to sharing of location information with the second communications device). When all of the defined criteria of the set defined by the network attributes event rule have been met, the decision in step 714 in such embodiments is that the criteria has been met for sharing updated location information. When not all of the criteria of the set defined by the network attributes event rule have been met, then the decision in step 714 is that the criteria has not been met for sharing location information. When the decision is that the criteria has not been met for sharing updated location information operation proceeds from step 714 to step 704. When the decision is that the criteria has been met for sharing updated location information operation proceeds from step 714 to step 716.

In step 716, updated position location information for the first communications device is generated at the first communications device (e.g., updated GPS coordinates for the first communications device). Operation proceeds from step 716 to step 718.

In step 718, the first communications device shares the updated position location information for the first communications device with the second communications device and/or requesting entities (e.g., requesting devices such as the RCS server). In some embodiments, step 718 includes one or more sub-steps 720 and 722. In sub-step 720, one or more RCS location update messages which include the updated position location information for the first communications device (e.g., either a session control message (e.g., SIP MESSAGE method with location information or SIP UPDATE message with location information) and/or session content message (e.g., MSRP message including location information)) is generated by the first communications devices (e.g., by the RCS client application). In sub-step 722, the first communications device transmits from the first communications device the one or more RCS location update messages to the second communications device and/or requesting entities. Operation proceeds from step 718 to step 704 where the steps of the routine are repeated.

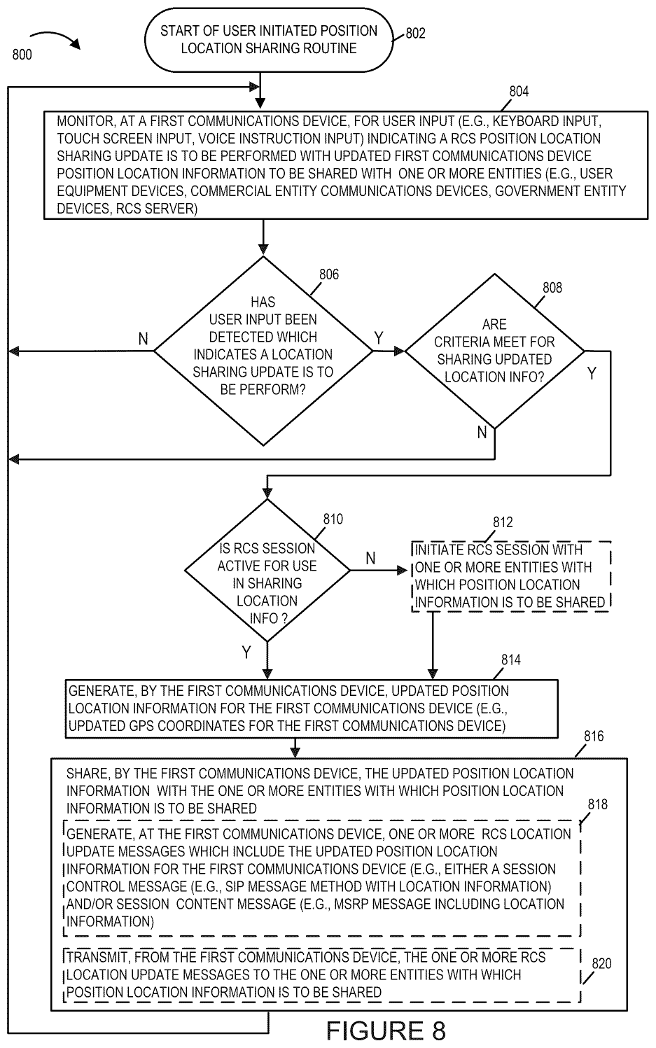

FIG. 8 illustrates a flowchart of an exemplary user initiated position location sharing routine/method 800 in accordance with an embodiment of the present invention. While it will be readily understood that additional steps are performed in connection with communicating information, data, and messages between devices, the routine 800 focuses on and discusses the steps for understanding the invention. The routine 800 will be discussed in connection with the exemplary system 1000 but is not limited to being implemented on system 1000 and can be implemented on other systems.

The exemplary user initiated position location sharing routine/method 800 starts and/or is initiated by the first communications device (e.g., by the RCS client application executing on the first communications device) in step 802 shown on FIG. 8. Operation proceeds from step 802 to step 804.

In step 804, the first communications device (e.g., the RCS client application of the first communications device) monitors for user input (e.g., keyboard input, touch screen input, voice instruction input) indicating a RCS position location sharing update is to be performed with updated first communications device position location information to be shared with one or more entities (e.g., user equipment devices, commercial entity communications devices, government entity communications devices, RCS server). Operation proceeds from step 804 to decision step 806.

In decision step 806, the first communications device (e.g., the RCS client application of the first communications device) determines whether or not a user input has been detected by the monitoring which indicates a location sharing update is to be performed. When the decision is that a user input indicating that a location sharing update is to be performed has not been detected by the monitoring, operation proceeds from step 806 to step 804 wherein the routine continues as previously described. When the decision is that a user input indicating that a location sharing update is to be performed has been detected by the monitoring, operation proceeds from step 806 to decision step 808.

In decision step 808, the first communications device (e.g., the RCS client application of the first communications device) determines whether criteria are met for sharing updated location information for the first communications device. When the decision is that the criteria has not been met for sharing updated location information operation proceeds from step 808 to step 804. In some embodiments, a message is provided to the user by the first communications device indicating the reason the updated location information is not being shared (e.g., the criteria which was not met which has prevented the sharing of the updated location information). For example, GPS location information is not available (e.g., GPS receiver not receiving a signal or GPS signal is determined not to be accurate), sharing of location information via RCS services has been disabled, location has not changed from last update, no network connection, network through which RCS services provided disabled for use in sharing location updates (e.g., user has only enabled sharing of updated location information to be performed when connected to specific networks for which the user does not have to pay fees and the current network is not one of these specific networks). When the decision is that the criteria has been met for sharing updated location information, operation proceeds from decision step 808 to decision step 810.

In decision step 810, the first communications device, e.g., the RCS client application of the first communications device, determines whether one or more RCS sessions are active for use in sharing location information with the one or more entities identified by the user for the location sharing update (e.g., if the user initiated location sharing update included the second communications device and a third communications device in step 810 the first communications device would determine is there was an active session with the second communications device and the third communications device for sharing the location information). For example, assume that the one or more entities is the second communications device and a third communications device. The first RCS session is still active between the first communications device and the second communications device but no RCS session is active between the first communications device and the third communications device. The first communications device in determine whether an RCS session is active with respect to the sharing of location information to the second communications device determines yes because the first RCS session is still active. Operation proceeds from step 810 to step 814 for sharing the location information with the second communications device. However, with respect to the third communications device, in step 810 the determination is that there is no active RCS session so operation proceeds from step 810 to step 812 with respect to the third communications device.

In decision step 810, when a RCS session is active for sharing location information to a user identified entity (i.e., one of the one or more entities identified by the user indicated for which RCS position location information sharing is to be performed), then operation proceeds from step 810 to step 814 with respect to that entity. In decision step 810, when a RCS session is not active for sharing location information to a user identified entity, then operation proceeds from step 810 to step 812 with respect to that entity.

In step 812, the first communications device initiates and/or establishes an RCS session with one or more entities with which position location information is to be shared but for which no RCS session is currently active. Operation proceeds from step 812 to step 814.

In step 814, updated position location information for the first communications device is generated at the first communications device (e.g., updated GPS coordinates for the first communications device). Operation proceeds from step 814 to step 816.

In step 816, the first communications device shares the updated position location information for the first communications device with the one or more entities with which the position location information is to be shared based on the user input and the determined criteria. In some embodiments, step 816 includes one or more sub-steps 818 and 820. In sub-step 818, one or more RCS location update messages which include the updated position location information for the first communications device (e.g., either a session control message (e.g., SIP MESSAGE method with location information or SIP UPDATE message with location information) and/or session content message (e.g., MSRP message including location information)) is generated by the first communications devices (e.g., by the RCS client application). In sub-step 820, the first communications device transmits from the first communications device the one or more RCS location update messages to the one or more entities with which position location information is to be shared. Operation proceeds from step 816 to step 804 where the steps of the routine are repeated.

In some embodiments, step 812 is optional as the first communications device may determine to send a RCS location based update as a RCS notification (e.g., SIP MESSAGE method or SIP NOTIFICATION message) which does not require the establishment of a RCS session.

In some embodiments, the routine 800 is a method which is always executing as part of the RCS client application of the communications device on which the RCS client application is executing.

In some embodiments, the sharing of the location information is done by the first communications device sharing the updated location information with the RCS server with instructions which in turn shares it with the one or more entities (e.g., communications devices identified by user input). In some embodiments, the one or more entities includes the RCS server when the first communications device has enabled public sharing of its location information and the location information is sent to the RCS server which shares it with other entities (e.g., other user equipment devices, government entity devices, and/or commercial entity devices) based on the first communications device instructions and/or location sharing information included in the first communications device profile provided to the RCS server when the first communications device registered with the RCS server for RCS services.

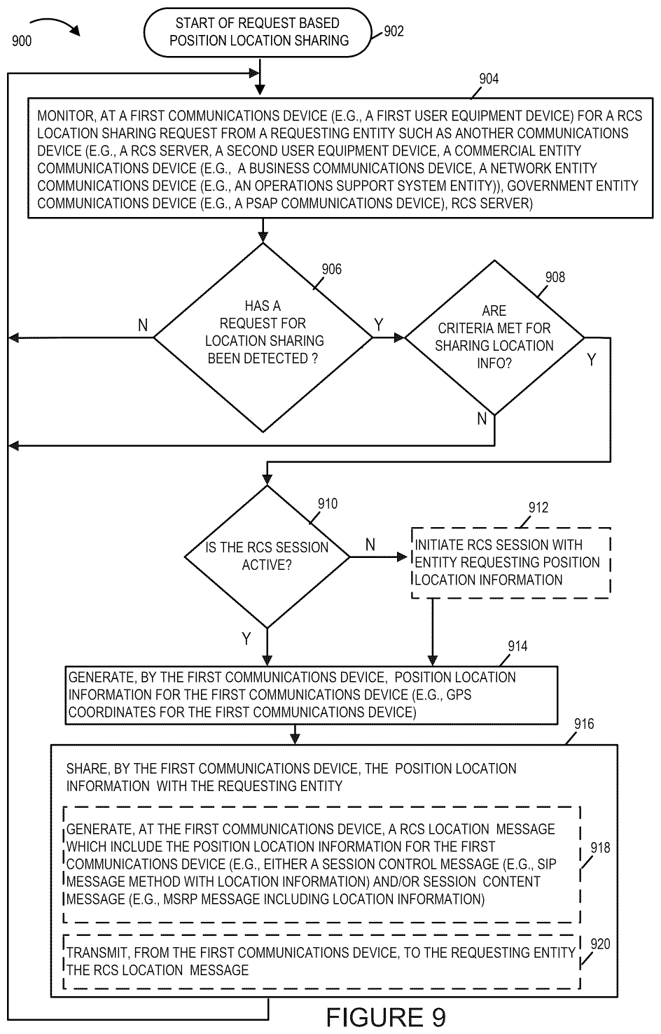

FIG. 9 illustrates a flowchart of an exemplary RCS request based position location sharing routine/method 900 in accordance with an embodiment of the present invention. While it will be readily understood that additional steps are performed in connection with communicating information, data, and messages between devices, the routine/method 900 focuses on and discusses the steps for understanding the invention. The routine/method 900 will be discussed in connection with the exemplary system 1000 but is not limited to being implemented on system 1000 and can be implemented on other systems.

The exemplary request based position location sharing routine/method 900 starts and/or is initiated by the first communications device (e.g., by the RCS client application executing on the first communications device) in step 902 shown on FIG. 9. Operation proceeds from step 902 to step 904.

In step 904, the first communications device (e.g., the RCS client application of the first communications device) monitors for a RCS location sharing request from a requesting entity such as for example another communications device/entity (e.g., another user equipment device, a commercial entity communications device (e.g., a business communications device, a network entity communications device (e.g., an Operations Support Systems communications device)), a government entity communications device (e.g., a PSAP communications device), RCS server). Operation proceeds from step 904 to decision step 906.

In decision step 906, the first communications device (e.g., the RCS client application of the first communications device) determines whether or not a request for RCS location sharing has been detected by the monitoring. When the decision is that a request for RCS location sharing has not been detected, operation proceeds from step 906 to step 904 wherein the routine continues as previously described. When the decision is that a request for location has been detected, operation proceeds from step 906 to decision step 908.

In decision step 908, the first communications device (e.g., the RCS client application of the first communications device) determines whether criteria are met for sharing location information for the first communications device. For example, criteria can include: (i) accurate location information is available, and (ii) user has authorized RCS location sharing with the requesting entity or if no authorization there is a public safety exception (e.g., PSAP entity device making the request) or user provides authorization for sharing location with requesting entity after being prompted when not previously authorized. When these criteria are met then the decision is that the criteria for sharing location information is met in step 908. When these criteria are not met, then the decision in step 908 is that the criteria for sharing location information has not been met. When the decision in step 908 is that the criteria has not been met for sharing location information, operation proceeds from step 908 to step 904. When the decision in step 908 is that the criteria has been met for sharing location information, operation proceeds from decision step 908 to decision step 910.

In decision step 910, the first communications device, e.g., the RCS client application of the first communications device, determines whether a RCS session is active for use in sharing location information with the requesting entity.

In decision step 910, when a RCS session is not active with the requesting entity, then operation proceeds from step 910 to step 912.

In step 912, the first communications device initiates and/or establishes an RCS session with the requesting entity with which position location information is to be shared but for which no RCS session is currently active. Operation proceeds from step 912 to step 914.

In decision step 910, when a RCS session is active with the requesting entity, then operation proceeds from step 910 to step 914.

In step 914, position location information for the first communications device is generated at the first communications device (e.g., GPS coordinates for the first communications device). Operation proceeds from step 914 to step 916.

In step 916, the first communications device shares the position location information for the first communications device with the requesting entity. In some embodiments, step 916 includes one or more sub-steps 918 and 920. In sub-step 918, one or more RCS location messages which include the position location information for the first communications device (e.g., either a session control message (e.g., SIP MESSAGE method with location information or SIP message with location information) and/or session content message (e.g., MSRP message including location information)) is generated by the first communications devices (e.g., by the RCS client application). In sub-step 920, the first communications device transmits from the first communications device the RCS location messages to the requesting entity. Operation proceeds from step 916 to step 904 where the steps of the routine are repeated.

In some embodiments, step 912 is optional as the first communications device may determine to send the location information via a RCS notification (e.g., SIP MESSAGE method or SIP NOTIFICATION message) which does not require the establishment of a RCS session.

In some embodiments, the routine 900 is a method which is always executing as part of the RCS client application of the communications device on which the RCS client application is executing.

In some embodiments, the sharing of the location information is done by the first communications device sharing the location information with the RCS server with instructions which in turn shares it with the requesting entity (e.g., a communications device identified in the instructions provided to the RCS server). In some embodiments, the requesting entity requests the RCS server provide the first communications location information for example when the first communications device has enabled public sharing of its location information and the location information is sent to the RCS server which shares it with other entities (e.g., other user equipment devices, government entity devices, and/or commercial entity devices) based on the first communications device instructions and/or location sharing information included in the first communications device profile provided to the RCS server when the first communications device registered with the RCS server for RCS services.

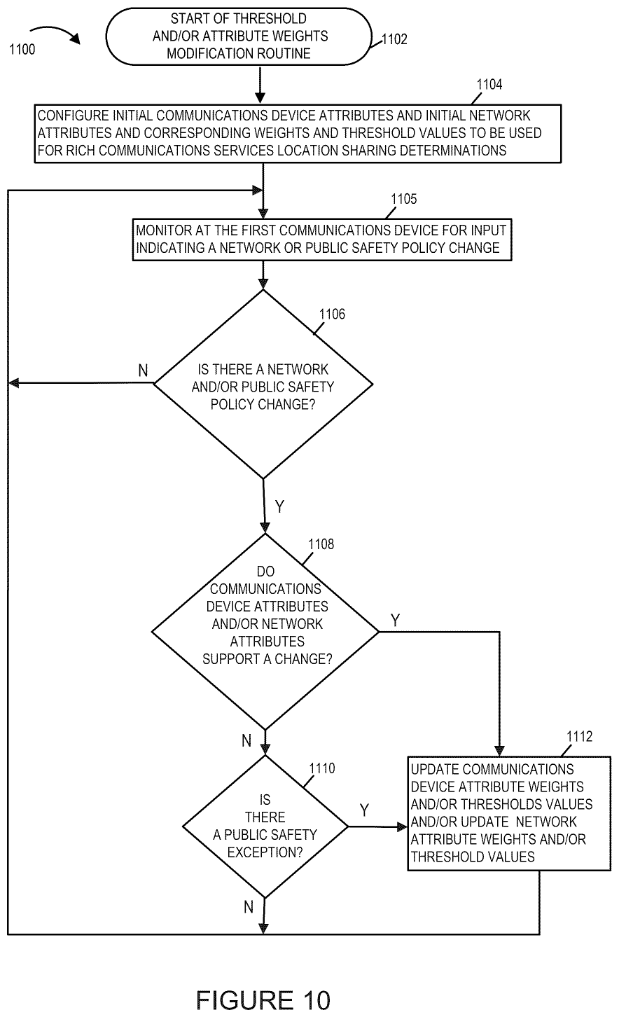

FIG. 10 illustrates a flowchart of an exemplary routine or method 1100 of setting and modifying attribute weights and threshold values used for determining RCS location information sharing with other entities in response network and/or public safety policy changes. The exemplary routine 1100 is explained using user equipment device 1110 and system 1000, but is not limited to system 1000 and may be, and in some embodiments is, implemented on other systems and/or communications devices with RCS location information sharing.

Operation begins in start step 1102. Operation proceeds from start step 1102 to step 1104. In step 1104, initial communications device attributes, corresponding weights and threshold values are configured in the first communications device for use in making RCS location sharing determinations by the first communications device. Also initial network device attributes, corresponding weights and threshold values are configured in the first communications device for use in making RCS location sharing determinations by the first communications device. In some embodiments, the configuration of the communications device attributes and/or network device attributes, corresponding weights and threshold values for determining when to RCS location information sharing is to implemented is configured as elements of the RCS profile for the first communications device and/or as part of one or more criteria which are evaluated when determining when RCS location information sharing and/or location information updating and/or refreshing is to be performed by the first communications device.

Operation proceeds from step 1104 to step 1105. At step 1105, the first communications device (e.g., UE 1 1110), e.g., the RCS client application 1112 of the first communications device, monitors for an input indicating a network and/or public safety policy change (e.g., an input from the user of the first communications device and/or from the RCS server). Operation proceeds from step 1105 to decision step 1106. In decision step 1106, the first communications device, e.g., the RCS client application of the first communications device, determines whether or not there is a network and/or public safety policy change which has been detected in the monitoring step 1105. When the decision in step 1106 is yes that there has been a network and/or public safety policy change, then operation proceeds from step 1106 to step 1108. When the decision in step 1106 is no that there has not been a network or public safety policy change then operation proceeds from step 1106 back to monitoring step 1105 where the routine/method 1100 continues.

In decision step 1108, the first communications device determines whether there are communications device attributes and/or network attributes that support a change in view of the network and/or public safety policy change detected. When the answer is yes, then operation proceeds from step 1108 to step 1112. When the answer is no, then operation proceeds from step 1108 to step 1110. In step 1110, the first communications device determines whether there is a public safety exception that overrides the communications device attributes and/or network attributes which do not support a change. When in step 1110 the determination is no, operation proceeds from step 1110 to monitoring step 1105 where the routine/method 1100 continues with the first communications device monitoring for another input indicating that there has been another network and/or public safety policy change. When in step 1110 the determination is yes, operation proceeds from step 1110 to step 1112.

In step 1112, the first communications device, e.g., the RCS client application of the first communications device, updates communications device attribute weights and/or threshold values and/or updates network attribute weights and/or threshold values to implement the network and/or public safety policy change. Operation proceeds from step 1112 to monitoring step 1105 where the routine/method 1100 continues with the first communications device monitoring for another input indicating that there has been another network and/or public safety policy change.

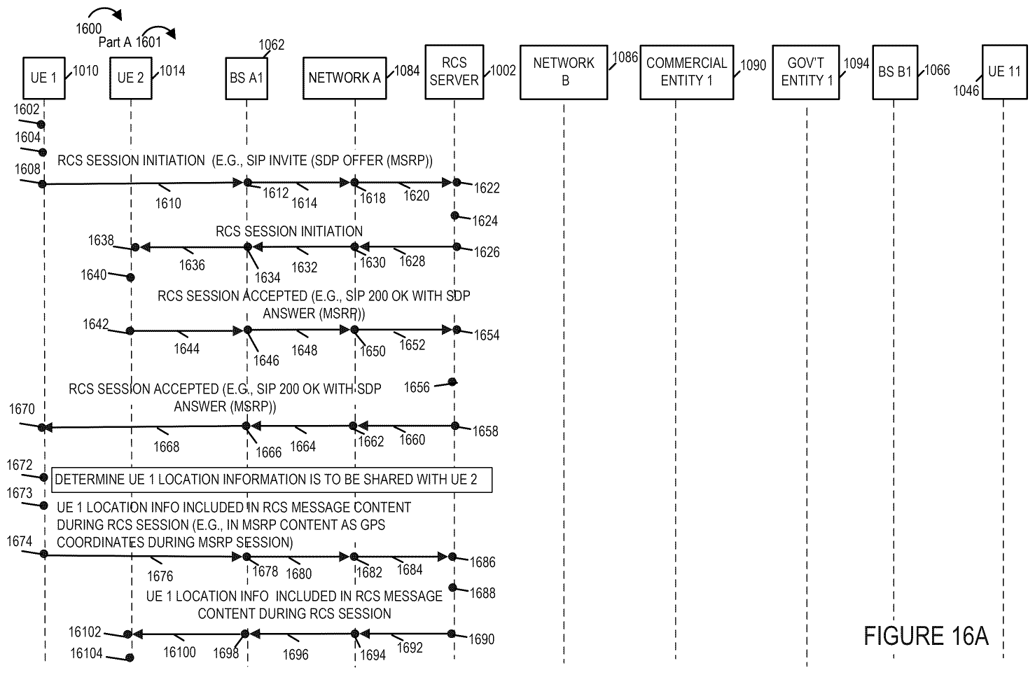

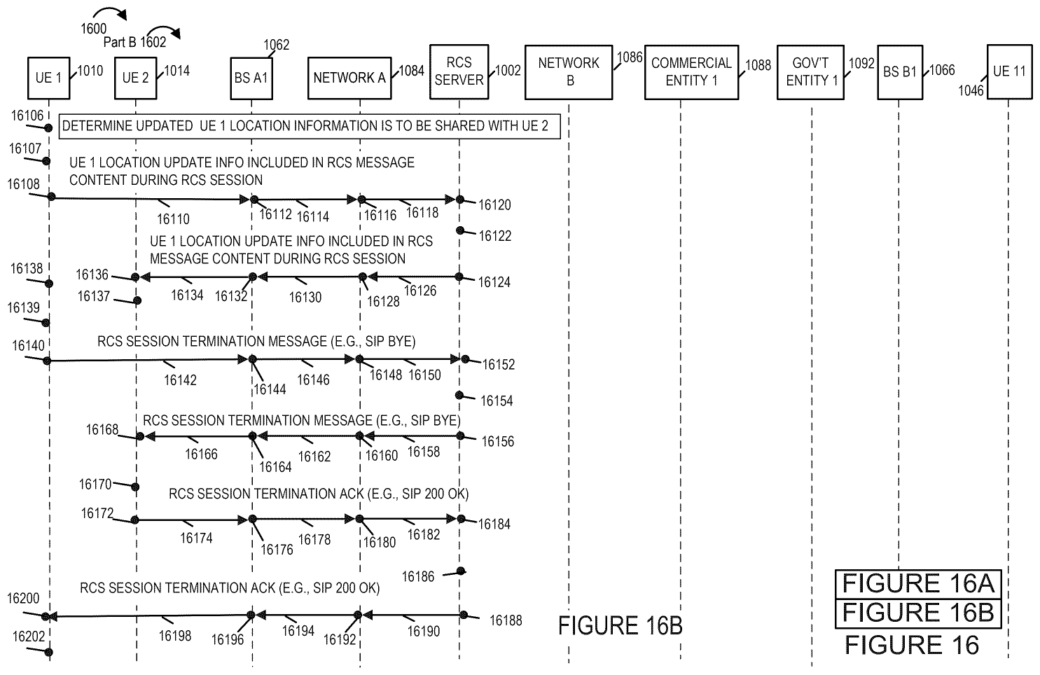

FIG. 16 comprises FIG. 16A and FIG. 16B. FIG. 16A is the first part of a signaling diagram which illustrates the steps and signaling of an exemplary method 1600 in accordance with an embodiment of the present invention. FIG. 16B is the second part of a signaling diagram which illustrates the steps and signaling of an exemplary method 1600 in accordance with an embodiment of the present invention.

The signaling diagram/method 1600 has been shown being implemented using elements of exemplary system 1000 of FIG. 1. While it will be readily understood that additional steps and signaling are performed in connection with communicating information, messages, and packets between devices, the signaling diagram/method 1600 focuses on and discusses the steps and signaling for understanding the invention.

It should be understood that the method 1600 is not limited to the exemplary system 1000 and may be, and is used, on other systems including systems with other configurations. The signaling diagram/method 1600 illustrates exemplary signaling and steps for managing Rich Communications Services location sharing during a RCS session in accordance with an exemplary embodiment of the present invention. In this example, the location information of an RCS client device is illustrated as being sent in the content of RCS messages of an on-going RCS session. These messages will typically be encrypted using end-to-end encryption so the location information of the RCS client is secure and only accessible to the end users of the RCS session.

Operation commences in start step 1602 of method 1600 shown on FIG. 16A. Operation proceeds from start step 1602 to step 1604. In step 1604, the UE 1 1010 generates a RCS session initiation message 1610 (e.g., a SIP INVITE request message including a SDP offer message with information for establishing a Message Relay Session Protocol session) between UE 1 1010 and UE 2 1014. Operation proceeds from step 1604 to step 1608.

In step 1608, UE 1 1010 transmits the RCS session initiation message 1610 to RCS server 1002 (via the BS A1 1062 and network A 1084) to be communicated and/or delivered by the RCS server 1002 to the UE 2 1014 (via network A 1084 and BS A1 1062) as will now be explained. The RCS session initiation message 1610 is transmitted from UE 1 1010 wirelessly to base station A1 1062. Operation proceeds from step 1608 to step 1612. In step 1612, the base station A1 1062 receives the RCS session initiation message 1610, generates RCS session initiation message 1614 based on the received RCS session initiation message 1610, and transmits the generated RCS session initiation message 1614 to network A 1084. Operation proceeds from step 1612 to step 1618. In step 1618, the network A 1084 receives the RCS session initiation message 1614, generates RCS session initiation message 1620 based on the received RCS session initiation message 1614, and transmits the generated RCS session initiation message 1620 to RCS server 1002. Operation proceeds from step 1618 to step 1622. In step 1622, the RCS server 1002 receives the RCS session initiation message 1620. Operation proceeds from step 1622 to step 1624. In step 1624, the RCS server 1002 generates RCS session initiation message 1628 based on the received RCS session initiation message 1620. In some embodiments, the RCS server 1002 modifies the RCS session initiation message 1620 to include information for directing RCS messages of the session to be routed to the RCS session for delivery. For example, if the RCS session initiation message is a SIP INVITE message including a SDP offer message for a MSRP session, the SDP offer message is modified to include information directing MSRP messages from the UE 2 1014 to be routed to the RCS server 1002 for delivery to the UE 1 1010. The RCS server 1002 becomes an anchor or relay entity/server for both RCS session control messages (e.g., SIP messages) and session content messages (e.g., MSRP messages) for the RCS session which is to be established between UE 1 1010 and UE 2 1014. Operation proceeds from step 1624 to step 1626.

In step 1626, RCS server 1002 transmits the RCS session initiation message 1628 to UE 2 1014 (via network A 1084 and BS A1 1062). The RCS session initiation message 1628 is transmitted in step 1626 from RCS server 1002 to network A 1084. Operation proceeds from step 1626 to step 1630. In step 1630, the network A 1084 receives the RCS session initiation message 1628, generates RCS session initiation message 1632 based on the received RCS session initiation message 1628, and transmits the generated RCS session initiation message 1632 to BS A1 1062. Operation proceeds from step 1630 to step 1634. In step 1634, BS A1 1062 receives the RCS session initiation message 1632, generates RCS session initiation message 1636 based on the received RCS session initiation message 1632, and transmits the generated RCS session initiation message 1636 wirelessly to UE 2 1014. Operation proceeds from step 1634 to step 1638. In step 1638, UE 2 1014 receives and processes the RCS session initiation message 1636 (e.g., a SIP INVITE message including a SDP offer message for a MSRP session with UE 1 1010). Operation proceeds from step 1638 to step 1640. As part of processing the RCS session initiation message from UE 1 1010 (e.g., the SIP INVITE request with SDP offer message for a MSRP session), the UE 2 1014 determines to accept the RCS session request from UE 1 1010. Operation proceeds from step 1638 to step 1640.

In step 1640, the UE 2 1014 generates a RCS session acceptance response message 1644 (e.g., a SIP 200 Ok response message including a SDP answer message with information for establishing the Message Relay Session Protocol session) between UE 1 1010 and UE 2 1014. Operation proceeds from step 1640 to step 1642.

In step 1642, UE 2 1014 transmits the RCS session acceptance response message 1644 to RCS server 1002 (via the BS A1 1062 and network A 1084) to be communicated and/or delivered by the RCS server 1002 to the UE 1 1010 (via network A 1084 and BS A1 1062) as will now be explained. The RCS session acceptance response message 1644 is transmitted from UE 2 1014 wirelessly to base station A1 1062. Operation proceeds from step 1642 to step 1646. In step 1646, the base station A1 1062 receives the RCS session acceptance response message 1644, generates RCS session acceptance response message 1648 based on the received RCS session acceptance response message 1644, and transmits the generated RCS session acceptance response message 1648 to network A 1084. Operation proceeds from step 1646 to step 1650. In step 1650, the network A 1084 receives the RCS session acceptance response message 1648, generates RCS session acceptance response message 1652 based on the received RCS session acceptance response message 1648, and transmits the generated RCS session acceptance response message 1652 to RCS server 1002. Operation proceeds from step 1650 to step 1654. In step 1654, the RCS server 1002 receives the RCS session acceptance response message 1652. Operation proceeds from step 1654 to step 1656. In step 1656, the RCS server 1002 generates RCS session acceptance response message 1660 based on the received RCS session acceptance response message 1652. In some embodiments, the RCS server 1002 modifies the RCS session acceptance response message 1652 to include information for directing RCS messages of the session to be routed to the RCS session for delivery. For example, if the RCS session acceptance response message is a SIP 200 Ok response message including a SDP answer message for a MSRP session, the SDP answer message is modified to include information directing MSRP messages from the UE 1 1010 to be routed to the RCS server 1002 for delivery to the UE 2 1014. As previously explained the RCS server 1002 becomes an anchor or relay entity/server for both RCS session control messages (e.g., SIP messages) and session content messages (e.g., MSRP messages) for the RCS session which is to be established between UE 1 1010 and UE 2 1014. Operation proceeds from step 1656 to step 1658.

In step 1658, RCS server 1002 transmits the RCS session acceptance response message 1660 to UE 1 1010 (via network A 1084 and BS A1 1062) as will now explained. The RCS session acceptance message 1660 is transmitted in step 1658 from RCS server 1002 to network A 1084. Operation proceeds from step 1658 to step 1662. In step 1662, the network A 1084 receives the RCS session acceptance response message 1660, generates RCS session acceptance response message 1664 based on the received RCS session acceptance response message 1660, and transmits the generated RCS session acceptance response message 1664 to BS A1 1062. Operation proceeds from step 1662 to step 1666. In step 1666, BS A1 1062 receives the RCS session acceptance response message 1666, generates RCS session acceptance message 1668 based on the received RCS session acceptance response message 1664, and transmits the generated RCS session acceptance response message 1668 wirelessly to UE 1 1010. Operation proceeds from step 1666 to step 1670. In step 1670, UE 1 1010 receives and processes the RCS session acceptance message 1668 (e.g., a SIP 200 Ok message including a SDP answer message with information for a MSRP session between UE 1 1010 and UE 2 1014). Operation proceeds from step 1670 to step 1672.

In step 1672, UE 1 1010 determines that UE 1 location information (e.g., UE 1 GPS coordinates) is to be shared with UE 2 1014. Operation proceeds from step 1672 to step 1673. In step 1673, UE 1 1010 generates UE 1010 location information (e.g., UE 1 GPS coordinates). Operation proceeds from step 1673 to step 1674. In step 1674, UE 1 1010 generates and transmits an RCS session message including the generated UE 1 location information to UE 2 in response to determining that the UE 1 1010 location information is to be shared with UE 2 1014. The RCS session message is transmitted via the RCS session established between UE 1 1010 and UE 2 1014 with the RCS message traversing the path of BS 1 1062, network A 1084, RCS server 1002, network A 1084, BS A1 1062 to UE 2 1014. In some embodiments, the location information is included in the message content of the RCS session message. In some embodiments, the RCS session is a MSRP session and the UE 1 1010 location information is included in one or more MSRP messages (e.g., in the content or message body of the one or more MSRP messages) of the MSRP session. In some embodiments, the UE 1 1010 encrypts the location information prior to transmitting it to UE 2 1014. In various embodiments, the content of RCS messages exchanged between endpoints of an established RCS session are encrypted by the endpoints of the RCS session. With the endpoints being the only devices with the ability to decrypt the RCS message content. For example, the RCS session may, and typically does, use End-to-End Encryption (E2EE) in which the RCS messages/message content is keep private from everyone but the endpoints of the RCS session with all of the intermediary nodes/devices including the RCS server not having the ability to decrypt the RCS messages/message content. In step 1674, UE 1 1010 generates and transmits the RCS message 1676 (e.g., an MSRP message including the generated UE 1 location information) wirelessly to base station A1 1062. The RCS message 1676 includes the generated UE 1 location information.

Operation proceeds from step 1674 to step 1678. In step 1678, the base station A1 1062 receives the RCS session message 1676, generates RCS session message 1680 based on the received RCS session message 1676, and transmits the generated RCS session message 1680 to network A 1084. Operation proceeds from step 1678 to step 1682. In step 1682, the network A 1084 receives the RCS session message 1680, generates RCS session message 1684 based on the received RCS session message 1680, and transmits the generated RCS session message 1680 to RCS server 1002. Operation proceeds from step 1682 to step 1686. In step 1686, the RCS server 1002 receives the RCS session message 1684. Operation proceeds from step 1686 to step 1688. In step 1688, the RCS server 1002 generates RCS session message 1692 based on the received RCS session message 1684. The RCS server 1002 acts a relay server for the received RCS session message (e.g., MSRP relay server when the RCS session message is a MSRP message). Operation proceeds from step 1688 to step 1690.

In step 1690, RCS server 1002 transmits the RCS session message 1692 to UE 2 1014 (via network A 1084 and BS A1 1062). The RCS session message 1692 is transmitted in step 1690 from RCS server 1002 to network A 1084. Operation proceeds from step 1690 to step 1694. In step 1694, the network A 1084 receives the RCS session message 1692, generates RCS session message 1696 based on the received RCS session message 1692, and transmits the generated RCS session message 1696 to BS A1 1062. Operation proceeds from step 1694 to step 1698. In step 1698, BS A1 1062 receives the RCS session message 1696, generates RCS session message 16100 based on the received RCS session message 1696, and transmits the generated RCS session message 16100 wirelessly to UE 2 1014. Operation proceeds from step 1698 to step 16102. In step 16102, UE 2 1014 receives and processes the RCS session message 16100 (e.g., a MSRP message including UE 1 1010 location information). Operation proceeds from step 16102 to step 16104. In step 16104, UE 2 1014 extracts the UE 1 1010 location information from the RCS session message 16100 (e.g., MSRP message including UE 1 1010 location information) and outputs the extracted location information at UE 2 1014 (e.g., displaying a map with the location of UE 1 1010, displaying an address of UE 1 1010, displaying city, state, country of UE 1 1010, providing audio output stating the address of UE 1 1010, and/or providing audio output stating the city, state, country of UE 1 1010. The information may be, and in some embodiments is displayed on a display of the UE 2 1014 or a display device connected to the UE 2 1014. When the UE 1 1010 location information is encrypted and/or the RCS message 16100 is encrypted, extracting the UE 1 1010 location information includes decrypting the encrypted location information and/or the RCS message 16100. Each of the RCS session messages 1676, 1680, 1684, 1692, 1696, and 16100 include the UE 1 1010 location information. Operation proceeds from step 16104 to step 16106 shown on FIG. 16B.

In step 1606, UE 1 1010 determines that updated UE 1 1010 location information is to be shared with UE 2 1014. In some embodiments, step 1606 includes making a determination that one or more criteria or a set of criteria are met for sharing updated location information. The one or more criteria may be based on and/or include one or more of the following: UE 1 1010 attributes and/or conditions being experienced by UE 1 1010, network attributes and/or network conditions, user input received at UE 1 1010 (e.g., user input indicating updated location information is to be shared with UE 2 1014), a request received from UE 2 1014 for updated location information, the passing of an amount of time since the UE 1 1010 last shared its location information or expiration of an RCS update location sharing periodic timer at UE 1 1010, movement and/or change of position beyond a threshold amount since the UE 1 1010 position location was shared with UE 2 1014. In some embodiments, UE 1 1010 makes the determination to share updated location information with UE 2 based upon detection of an event occurrence (e.g., change of UE 1 attributes and/or conditions beyond a predetermined threshold, change of position of UE 1, change of network attributes/conditions, receipt of a request for updated information from UE 2 1014, periodic location sharing timer expiring at UE 1, user input received at UE 1, safety policy event). Operation proceeds from step 16106 to step 16107.

In step 16107, UE 1 1010 generates updated UE 1010 location information (e.g., UE 1 GPS coordinates). Operation proceeds from step 16107 to step 16108. The process of sharing updated location information with UE 2 1014 is similar to the initial sharing of location information explained above.

In step 16108, UE 1 1010 generates and transmits an RCS session message including the generated updated UE 1 location information to UE 2 in response to determining that the updated UE 1 1010 location information is to be shared with UE 2 1014. The RCS session message is transmitted via the RCS session established between UE 1 1010 and UE 2 1014 with the RCS message traversing the path of BS 1 1062, network A 1084, RCS server 1002, network A 1084, BS A1 1062 to UE 2 1014. In some embodiments, the updated location information is included in the message content of the RCS session message. In some embodiments, the RCS session is a MSRP session and the updated UE 1 1010 location information is included in one or more MSRP messages (e.g., in the content or message body of the one or more MSRP messages) of the MSRP session. In some embodiments, the UE 1 1010 encrypts the updated location information prior to transmitting it to UE 2 1014. As previously discussed, in various embodiments, the content of RCS messages exchanged between endpoints of an established RCS session are encrypted by the endpoints of the RCS session. With the endpoints being the only devices with the ability to decrypt the RCS message content. For example, the RCS session may, and typically does, use End-to-End Encryption (E2EE) in which the RCS messages/message content is keep private from everyone but the endpoints of the RCS session with all of the intermediary nodes/devices including the RCS server not having the ability to decrypt the RCS messages/message content. In step 16108, UE 1 1010 generates and transmits the RCS message 16110 (e.g., an MSRP message including the generated updated UE 1 location information) wirelessly to base station A1 1062. The RCS message 16110 includes the generated updated UE 1 location information.

Operation proceeds from step 16108 to step 16112. In step 16112, the base station A1 1062 receives the RCS session message 16110, generates RCS session message 16114 based on the received RCS session message 16110, and transmits the generated RCS session message 16114 to network A 1084. Operation proceeds from step 16112 to step 16116. In step 16116, the network A 1084 receives the RCS session message 16114, generates RCS session message 16118 based on the received RCS session message 16114, and transmits the generated RCS session message 16118 to RCS server 1002. Operation proceeds from step 16116 to step 16120. In step 16120, the RCS server 1002 receives the RCS session message 16118. Operation proceeds from step 16120 to step 16122. In step 16122, the RCS server 1002 generates RCS session message 16126 based on the received RCS session message 16118. The RCS server 1002 acts as a relay server for the received RCS session message (e.g., MSRP relay server when the RCS session message is a MSRP message). Operation proceeds from step 16122 to step 16124.

In step 16124, RCS server 1002 transmits the RCS session message 16126 to UE 2 1014 (via network A 1084 and BS A1 1062). The RCS session message 16126 is transmitted in step 16124 from RCS server 1002 to network A 1084. Operation proceeds from step 16124 to step 16128. In step 16128, the network A 1084 receives the RCS session message 16126, generates RCS session message 16130 based on the received RCS session message 16126, and transmits the generated RCS session message 16130 to BS A1 1062. Operation proceeds from step 16128 to step 16132. In step 16132, BS A1 1062 receives the RCS session message 16130, generates RCS session message 16134 based on the received RCS session message 16130, and transmits the generated RCS session message 16130 wirelessly to UE 2 1014. Operation proceeds from step 16132 to step 161136. In step 161136, UE 2 1014 receives and processes the RCS session message 16134 (e.g., a MSRP message including updated UE 1 1010 location information). Operation proceeds from step 16136 to step 16137. In step 16137, UE 2 1014 extracts the updated UE 1 1010 location information from the RCS session message 16134 (e.g., MSRP message including updated UE 1 1010 location information) and outputs the extracted updated location information at UE 2 1014 (e.g., displaying a map with the location of UE 1 1010 on a display of UE 2 1014, displaying an address of UE 1 1010 on a display of UE 2 1014, displaying city, state, country of UE 1 1010 on a display of UE 2 1014, providing audio output stating the address of UE 1 1010, and/or providing audio output stating the city, state, country of UE 1 1010. When the updated UE 1 1010 location information is encrypted and/or the RCS message 16134 is encrypted, extracting the updated UE 1 1010 location information includes decrypting the encrypted updated location information and/or the RCS message 16134. Each of the RCS session messages 16110, 16114, 16118, 16126, 16130, and 16134 include the updated UE 1 1010 location information. Operation proceeds from step 16137 back to step 16138. While the RCS session between UE 1 1010 and UE 2 1014 is on-going, in step 16138 UE 1 1014 monitors for the detection of an occurrence of an event and/or condition (e.g., change of UE 1 attributes and/or conditions beyond a predetermined threshold, change of position of UE 1, change of network attributes/conditions, receipt of a request for updated information from UE 2 1014, periodic location sharing timer expiring at UE 1, user input received at UE 1, safety policy event) which would met criteria for UE 1 1010 to share updated location information with UE 2 1014. In the event of the detection of such an event and/or condition operation proceeds from step 16138 to step 16106.

In this example, UE 1 1010 will terminate and/or end the RCS session. When in step 16139, an input (e.g., keyboard input, touchscreen input, voice command input) is received at UE 1 1010 indicating that the RCS session with UE 2 1014 is to be terminated, operation proceeds from step 16139 to step 16140.

In step 16140, UE 1 1010 generates and transmits the RCS session termination message 16142 (e.g., a SIP BYE message) to RCS server 1002 (via the BS A1 1062 and network A 1084) to be communicated and/or delivered by the RCS server 1002 to the UE 2 1014 (via network A 1084 and BS A1 1062) as will now be explained. The RCS session termination message 16142 is transmitted from UE 1 1010 wirelessly to base station A1 1062. Operation proceeds from step 16140 to step 16144. In step 16144, the base station A1 1062 receives the RCS session termination message 16142, generates RCS session termination message 16146 based on the received RCS session termination message 16142, and transmits the generated RCS session termination message 16146 to network A 1084. Operation proceeds from step 16144 to step 16148. In step 16148, the network A 1084 receives the RCS session termination message 16146, generates RCS session termination message 16150 based on the received RCS session termination message 16146, and transmits the generated RCS session termination message 16150 to RCS server 1002. Operation proceeds from step 16148 to step 16152. In step 16152, the RCS server 1002 receives the RCS session termination message 16150. Operation proceeds from step 16152 to step 16154. In step 16154, the RCS server 1002 generates RCS session termination message 16158 based on the received RCS session termination message 16150. Operation proceeds from step 16154 to step 16156.

In step 16156, RCS server 1002 transmits the RCS session termination message 16158 to UE 2 1014 (via network A 1084 and BS A1 1062). The RCS session termination message 16158 is transmitted in step 16156 from RCS server 1002 to network A 1084. Operation proceeds from step 16156 to step 16160. In step 16160, the network A 1084 receives the RCS session termination message 16158, generates RCS session termination message 16162 based on the received RCS session termination message 16158, and transmits the generated RCS session termination message 16162 to BS A1 1062. Operation proceeds from step 16160 to step 16164. In step 16164, BS A1 1062 receives the RCS session termination message 16162, generates RCS session termination message 16166 based on the received RCS session termination message 16162, and transmits the generated RCS session termination message 16166 wirelessly to UE 2 1014. Operation proceeds from step 16164 to step 16168. In step 16168, UE 2 1014 receives and processes the RCS session termination message 16166 (e.g., a SIP BYE message). Operation proceeds from step 16168 to step 16170.

In step 16170, the UE 2 1014 generates a RCS session termination response message acknowledging termination of the RCS session 16174 (e.g., a SIP 200 Ok response message). Operation proceeds from step 16170 to step 16172.

In step 16172, UE 2 1014 transmits the RCS session termination acknowledgement message 16174 to RCS server 1002 (via the BS A1 1062 and network A 1084) to be communicated and/or delivered by the RCS server 1002 to the UE 1 1010 (via network A 1084 and BS A1 1062) as will now be explained. The RCS session termination acknowledgement message 16174 is transmitted from UE 2 1014 wirelessly to base station A1 1062. Operation proceeds from step 16172 to step 16176. In step 16176, the base station A1 1062 receives the RCS session termination acknowledgement message 16174, generates RCS session termination acknowledgement message 16178 based on the received RCS session termination acknowledgement message 16174, and transmits the generated RCS session termination acknowledgement message 16178 to network A 1084. Operation proceeds from step 16176 to step 16180. In step 16180, the network A 1084 receives the RCS session termination acknowledgement message 16178, generates RCS session termination acknowledgement message 16182 based on the received RCS session termination acknowledgement message 16178, and transmits the generated RCS session termination acknowledgement message 16182 to RCS server 1002. Operation proceeds from step 16180 to step 16184. In step 16184, the RCS server 1002 receives the RCS session termination response message 16182. Operation proceeds from step 16184 to step 16186. In step 16186, the RCS server 1002 generates RCS session termination acknowledgement message 16190 based on the received RCS session termination acknowledgement message 16182. Operation proceeds from step 16186 to step 16188.

In step 16188, RCS server 1002 transmits the RCS session termination acknowledgement message 16190 to UE 1 1010 (via network A 1084 and BS A1 1062) as will now explained. The RCS session termination acknowledgement message 16190 is transmitted in step 16188 from RCS server 1002 to network A 1084. Operation proceeds from step 16188 to step 16192. In step 16192, the network A 1084 receives the RCS session termination acknowledgement message 16190, generates RCS session termination acknowledgement message 16194 based on the received RCS session termination acknowledgement message 16190, and transmits the generated RCS session termination acknowledgement message 16194 to BS A1 1062. Operation proceeds from step 16192 to step 16196. In step 16196, BS A1 1062 receives the RCS session termination acknowledgement message 16196, generates RCS session termination acknowledgement message 16198 based on the received RCS session termination acknowledgement message 16194, and transmits the generated RCS session termination acknowledgement message 16198 wirelessly to UE 1 1010. Operation proceeds from step 16196 to step 16200. In step 16200, UE 1 1010 receives and processes the RCS session termination acknowledgement message 16198 (e.g., a SIP 200 Ok). The RCS session (e.g., SIP session with control messages and MSRP session with content) has been successfully torn down and/or terminated. Operation proceeds from step 16200 to step 16202. In step 16202, the method 1600 ends. Each of the RCS session termination messages 16142, 16146, 16150, 16158, 16162, 16166 may be a SIP BYE message when the RCS session control messages are Session Initiation Protocol messages. In such cases, each of the RCS session termination acknowledgement messages 16174, 16178, 16182, 16190, 16194, 16198 may be a SIP 200 Ok message.

In various embodiments in which the SIP protocol is used as the control protocol for the RCS session, the UE 1 location information and/or updated location information is included in one or more SIP messages instead of and/or in addition to the MSRP message. For example, UE location information may be, and in some embodiments is, included in the SIP INVITE message and/or in the SDP offer message included in the SIP INVITE message. In some embodiments, location information is included in a SIP header field (e.g., a proprietary SIP header field). In some embodiments, the location information is included in an SDP attribute field (e.g., a proprietary SDP attribute field). In some embodiments, the UE 1 1010 location information is shared with UE 2 1014 using a SIP MESSAGE method in which the UE 1 1010 location information and/or updated location information is included in a single new SIP MESSAGE method each time it is sent. This is sometimes referred to as pager mode messaging. In some such embodiments, the initial UE 1 1010 location information is sent before and/or as the RCS session between UE 1 1010 and UE 2 1014 is being established as a separate SIP MESSAGE method which includes the UE 1 1010 location information. In some embodiments, UE 2 1014 may send a SIP SUBSCRIBE message to UE 1 1010 subscribing to the UE 1 1010 providing location information upon the occurrence of one or more events and/or conditions (e.g., change of UE 1 attributes and/or conditions beyond a predetermined threshold, change of position of UE 1, change of network attributes/conditions, periodic location sharing timer expiring at UE 1, user input received at UE 1, safety policy event). When an event occurs UE 1 1010 shares and/or sends its current location to UE 2 1014 in a SIP NOTIFY message.

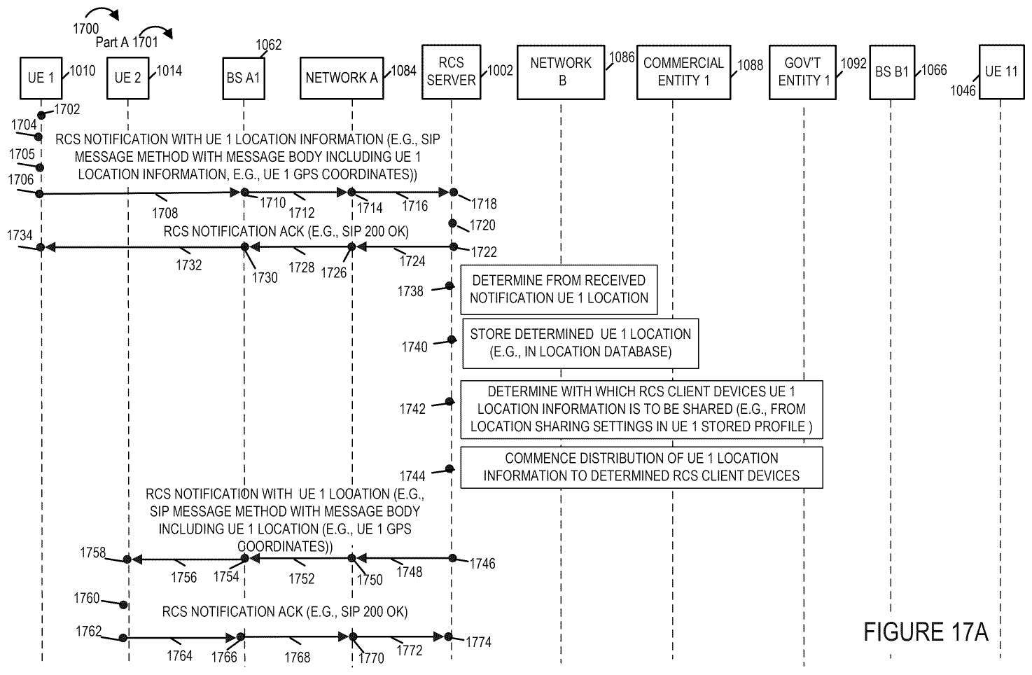

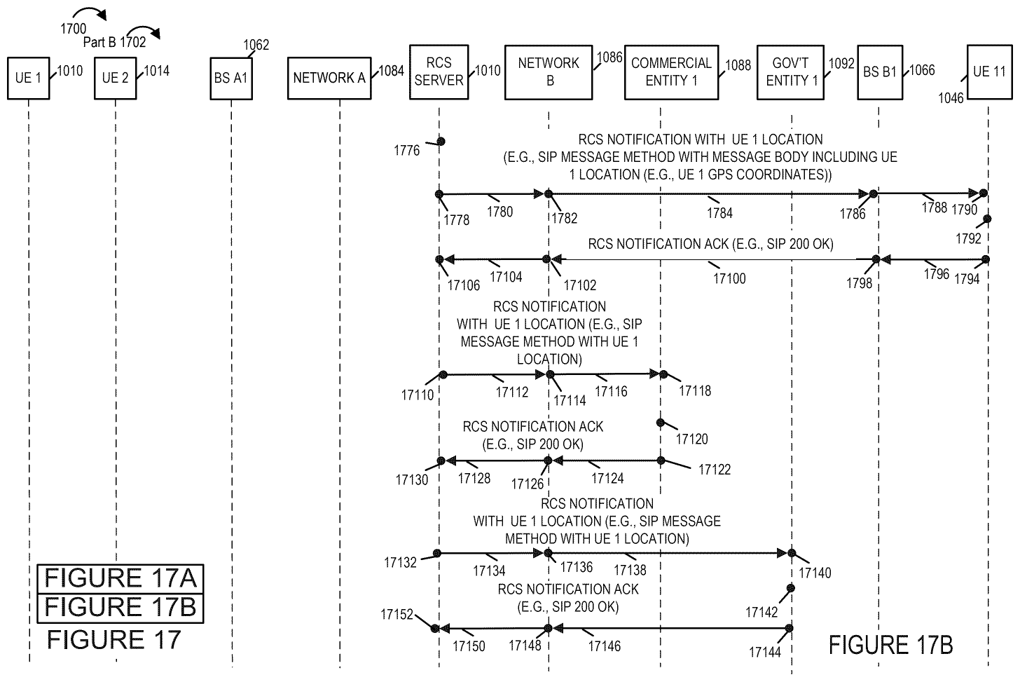

FIG. 17 comprises FIG. 17A and FIG. 17B. FIG. 17A is the first part of a signaling diagram which illustrates the steps and signaling of an exemplary method 1700 in accordance with an embodiment of the present invention. FIG. 17B is the second part of a signaling diagram which illustrates the steps and signaling of an exemplary method 1700 in accordance with an embodiment of the present invention.

The signaling diagram/method 1700 has been shown being implemented using elements of exemplary system 1000 of FIG. 1. While it will be readily understood that additional steps and signaling are performed in connection with communicating information, messages, and packets between devices, the signaling diagram/method 1700 focuses on and discusses the steps and signaling for understanding the invention.

It should be understood that the method 1700 is not limited to the exemplary system 1000 and may be, and is used, on other systems including systems with other configurations. The signaling diagram/method 1700 illustrates exemplary signaling and steps for managing Rich Communications Services location sharing wherein an RCS server receives and distributes RCS client device location information in accordance with an exemplary embodiment of the present invention. In this example, a RCS client device's profile (i.e., UE 1 client device profile) has been implemented to include information indicating what permission have been granted with respect to sharing of the RCS's client device's location including to whom the location information can be shared. In some embodiments, the location information for the RCS client device included in the RCS notification message is encrypted so that only RCS client devices which are intended destination devices are able to unencrypt and access the location information.

In various embodiments, RCS client notifications with location information may, and in some embodiments are, sent directly to other RCS client devices which have registered directly with the RCS client providing the notifications. In some such embodiments, the RCS client device providing the notification can send the notifications via a RCS session established just for sending the location information or via stand alone RCS notification messages which do not require a RCS session to be established between the RCS client device sending the notification and the RCS client device receiving the notification. All RCS messages, whether stand alone RCS messages used for notifications or RCS session messages exchanged during an RCS session, are routed through the RCS application server which performs a message relay function. If the RCS destination device is not available (e.g., not on-line or powered off) and cannot accept stand alone messages, the stand alone messages received for the RCS destination device will be temporarily stored by the RCS server in the message database 1008 and delivered once the RCS destination device is available, (e.g., on-line or powered up). The messages are stored in the same format in which they are received by the RCS server so that if they are encrypted when received they will stored in the encrypted format.

Prior to the commencement of method 1700, UE 1 1010, UE 2 1014, commercial entity 1 communications device 1088, government entity 1 communications device 1092 and UE 11 1046 are registered with the RCS server 1010 (e.g., as illustrated in method 1500 of FIG. 15). In this example, the UE 1 1010 RCS profile includes information authorizing the RCS server 1002 to publicly share UE 1 1010 location information and this authorization of the public sharing of the UE 1 1010 location information has been provided to the RCS server 1002 during registration.

Method 1700 commences in start step 1702 shown on FIG. 17A. Operation proceeds from step 1702 to step 1704.

In step 1704, UE 1 1010 determines that UE 1 location information (e.g., UE 1 GPS coordinates) is to be shared with the RCS server 1002 for distribution to other registered RCS entities. In this example, the other registered RCS entities are UE 2 1014, commercial entity 1 communications device 1088, government entity 1 communications device 1092 and UE 11 1046. In some embodiments, the registered entities with which the UE 1 1010 location information is to be shared is determined by the RCS server 1002 (e.g., based on one or more of the following: the location of the UE 1 1010, commercial entity offerings which may be of interest to UE 1 1010 based on information obtained by and/or provided to the RCS server (e.g., UE 1 profile information which includes interest in being provided information on restaurants in the vicinity of the reported UE 1 location, gas stations in the vicinity of the reported UE 1 location when UE 1 location information indicates movement in a vehicle, users and/or user equipment devices which the UE 1 has stored contact information (e.g., UE 2 1014, UE 11 1046), commercial entities which have requested location information, government entities which have requested location information for UE 1 1010, user equipment devices which have requested location information for UE 1 1010, entities identified by UE 1 1010 with which UE 1 1010 location information is to be shared (e.g., list of UEs, commercial entities, government entities)). Operation proceeds from step 1704 to step 1705. In step 1705, UE 1 1010 generates UE 1010 location information (e.g., UE 1 GPS coordinates) in response to determining that the UE 1 location information is to be shared with other registered RCS entities. Operation proceeds from step 1705 to step 1706. In step 1706, UE 1 1010 generates and transmits RCS notification message 1708 including the generated UE 1 location information (e.g., a SIP MESSAGE method including the UE 1 location information) to the RCS server 1002 in response to determining that the UE 1 1010 location information is to be shared with other registered RCS entities as will now be explained. The RCS notification message is transmitted to the RCS server 1002 via the path of BS 1 1062, network A 1084, to RCS server 1002. In some embodiments, the RCS notification message is a SIP MESSAGE method including the UE 1 location information in the message body or content portion of the SIP MESSAGE method. In some embodiments, the location information is unencrypted while in other embodiments, the UE 1 1010 encrypts the location information prior to transmitting it to RCS server 1002 with the RCS server having information necessary to decrypt the encrypted location information. In step 1706, UE 1 1010 generates and transmits the RCS notification message 1708 (e.g., a SIP MESSAGE method including the generated UE 1 location information) wirelessly to base station A1 1062. The RCS notification message 1708 includes the generated UE 1 1010 location information.

Operation proceeds from step 1706 to step 1710. In step 1710, the base station A1 1062 receives the RCS notification message 1708, generates RCS notification message 1712 based on the received RCS notification message 1708, and transmits the generated RCS notification message 1712 to network A 1084. Operation proceeds from step 1710 to step 1714. In step 1714, the network A 1084 receives the RCS notification message 1712, generates RCS notification message 1716 based on the received RCS notification message 1712, and transmits the generated RCS notification message 1716 to RCS server 1002. Operation proceeds from step 1714 to step 1718. In step 1718, the RCS server 1002 receives the RCS notification message 1716. Operation proceeds from step 1718 to step 1720. In step 1720, the RCS server processes the RCS notification message 1716 and determines it is a RCS notification message including location information from UE 1 1010. Operation proceeds from step 1720 to steps 1722 and 1738.

In step 1722, RCS server 1002 generates and transmits the RCS notification acknowledgement response message 1724 (e.g., a SIP 200 Ok response) to UE 1 1010 (via network A 1084 and BS A1 1062) in response to successfully receiving the RCS notification message 1716. The RCS notification acknowledgement response message 1714 is transmitted in step 1722 from RCS server 1002 to network A 1084. Operation proceeds from step 1722 to step 1726. In step 1726, the network A 1084 receives the RCS notification acknowledgement message 1724, generates RCS notification acknowledgement message 1728 based on the received RCS notification acknowledgement response message 1724, and transmits the generated RCS notification acknowledgement response message 1728 to BS A1 1062. Operation proceeds from step 1726 to step 1730. In step 1730, BS A1 1062 receives the RCS notification acknowledgement response message 1728, generates RCS notification acknowledgement response message 1732 based on the received RCS notification acknowledgement response message 1728, and transmits the generated RCS notification acknowledgement response message 1732 wirelessly to UE 1 1010. Operation proceeds from step 1730 to step 1734. In step 1734, UE 1 1010 receives and processes the RCS notification acknowledgement response message 1732 (e.g., a SIP 200 Ok message).

Each of the RCS notification messages 1708, 1712, and 1716 include the UE 1 1010 location information. In some embodiments, each of the RCS notification messages 1708, 1712, and 1716 is implemented as a SIP MESSAGE method including in it message body UE 1 location information and a header including information indicating the message body includes UE 1 location information. Each of the RCS notification acknowledgement response message 1724, 1728, and 1732 may be implemented as a SIP 200 Ok message when the RCS Notification message is a SIP message.

Returning to step 1738, RCS server 1002 determines and/or extracts the UE 1 location information from the received RCS notification message 1716. When the UE 1 1010 location information is encrypted and/or the RCS notification message 1716 is encrypted, determining and/or extracting the UE 1 location information includes decrypting the encrypted location information and/or the RCS notification message 1716. Operation proceeds from step 1738 to step 1740. In step 1740, the RCS server 1002 stores the determined UE 1 location information. In some embodiments, the RCS server 1002 stores the UE 1 location information in a location database (e.g., location database 1006). In some embodiments, the location information includes GPS coordinates or longitude and latitude values. In some embodiments, the location information includes a timestamp as to when the location information was generated. In some embodiments, the location information includes a velocity and heading in addition to a GPS coordinates and/or longitude and latitude values. Operation proceeds from step 1740 to step 1742.

In step 1742, the RCS server 1002 determines with which RCS client devices UE 1 location information is to be shared (e.g., from location sharing settings and/or information included in UE 1 1010 RCS profile information provided to the RCS server 1002 and stored by the RCS server 1002). In some embodiments, the RCS server 1002 determines with which RCS client devices UE 1 location information is to be shared based on information (e.g., a list of RCS client devices and/or instructions (e.g., no restrictions on sharing of UE 1 location information or only share UE 1 location information with previously list of authorized RCS client devices/users)) included in the RCS notification message 1716. In this example, the RCS server 1002 determines that the UE 1 1010 location information is to be shared with the following registered entities: UE 2 1014, commercial entity 1 communications device 1086, government entity 1 communications device 1092, and UE 11 1046. Operation proceeds from step 1742 to step 1744. In step 1744, the RCS server 1002 commences distribution of UE 1 location information to the determined RCS client devices. Operation proceeds from step 1744 to steps 1746, 1778, 17110, and 17132.

In step 1746, RCS server 1002 generates and transmits the RCS notification message 1748 (e.g., a SIP MESSAGE method including UE 1 location information (e.g., in the message body as GPS coordinates) to UE 2 1014 (via network A 1084 and BS A1 1062). The RCS notification message 1748 is transmitted in step 1746 from RCS server 1002 to network A 1084. Operation proceeds from step 1746 to step 1750. In step 1750, the network A 1084 receives the RCS notification message 1748, generates RCS notification message 1752 based on the received RCS notification message 1748, and transmits the generated RCS notification message 1752 to BS A1 1062. Operation proceeds from step 1750 to step 1754. In step 1754, BS A1 1062 receives the RCS notification message 1752, generates RCS notification message 1756 based on the received RCS notification message 1752, and transmits the generated RCS notification message 1756 wirelessly to UE 2 1014. Operation proceeds from step 1756 to step 1758. In step 1758, UE 2 1014 receives and processes the RCS notification message 1756. Processing the RCS notification message 1756 including extracting the UE 1 location information from the RCS message 1756. If the UE 1 location information and/or the RCS message 1756 is encrypted, the UE 2 1014 decrypts the UE 1 location information and/or the RCS message 1756 as part of extracting the UE 1 location information and/or processing the RCS message 1756. Operation proceeds from step 1758 to step 1760. In step 1760, UE 2 1014 outputs the extracted UE 1 location information at UE 2 1014 (e.g., displaying the UE 1 location coordinates, displaying a map with the location of UE 1 1010 on a display of UE 2 1014, displaying an address of UE 1 1010 on a display of UE 2 1014, displaying city, state, country of UE 1 1010 on a display of UE 2 1014, providing audio output stating the address of UE 1 1010, and/or providing audio output stating the city, state, country of UE 1 1010). Operation proceeds from step 1760 to step 1762.

In step 1762, UE 2 1014 generates and transmits the RCS notification acknowledgement response message 1764 (e.g., a SIP 200 Ok response) to RCS server 1002 (via BS A1 1062 and network A 1084) in response to successfully receiving the RCS notification message 1756. The RCS notification acknowledgement response message 1764 is transmitted in step 1762 from UE 2 1014 to BS A1 1062. Operation proceeds from step 1762 to step 1766. In step 1766, the BS A1 1062 receives the RCS notification acknowledgement response message 1764, generates RCS notification acknowledgement response message 1768 based on the received RCS notification acknowledgement response message 1764, and transmits the generated RCS notification acknowledgement response message 1768 to network A 1084. Operation proceeds from step 1766 to step 1770. In step 1770, network A 1084 receives the RCS notification acknowledgement response message 1768, generates RCS notification acknowledgement response message 1772 based on the received RCS notification acknowledgement response message 1768, and transmits the generated RCS notification acknowledgement response message 1772 wirelessly to RCS Server 1002. Operation proceeds from step 1770 to step 1774. In step 1774, RCS server 1002 receives the RCS notification acknowledgement response message 1772 (e.g., a SIP 200 Ok message). which indicates that the RCS notification to UE 2 1014 has been successful. Operation proceeds from step 1774 to step 1776 shown on FIG. 17B. In step 1776, the RCS server 1002 processes the received RCS notification acknowledgement response message 1772 and determines from the RCS notification acknowledgement response message that UE 2 1014 has successfully received the RCS notification with UE 1 1010 location information.

In step 1778, RCS server 1002 generates and transmits the RCS notification message 1780 (e.g., a SIP MESSAGE method including UE 1 location information (e.g., in the message body as GPS coordinates) to UE 11 1046 (via network B 1086 and BS B1 1066). The RCS notification message 1780 is transmitted in step 1776 from RCS server 1002 to network B 1086. Operation proceeds from step 1776 to step 1782. In step 1782, the network B 1086 receives the RCS notification message 1780, generates RCS notification message 1784 based on the received RCS notification message 1780, and transmits the generated RCS notification message 1784 to BS B1 1066. Operation proceeds from step 1782 to step 1786. In step 1786, BS B1 1066 receives the RCS notification message 1784, generates RCS notification message 1788 based on the received RCS notification message 1784, and transmits the generated RCS notification message 1788 wirelessly to UE 11 1046. Operation proceeds from step 1786 to step 1790. In step 1790, UE 11 1046 receives and processes the RCS notification message 1788. Processing the RCS notification message 1788 includes extracting the UE 1 location information from the RCS message 1788. If the UE 1 location information and/or the RCS message 1788 is encrypted, the UE 11 1046 decrypts the UE 1 location information and/or the RCS message 1788 as part of extracting the UE 1 location information and/or processing the RCS message 1788. Operation proceeds from step 1790 to step 1792. In step 1792, UE 11 1046 outputs the extracted UE 1 location information at UE 11 1046 (e.g., displaying the UE 1 location coordinates, displaying a map with the location of UE 1 1010 on a display of UE 11 1046, displaying an address of UE 1 1010 on a display of UE 11 1046, displaying city, state, country of UE 1 1010 on a display of UE 11 1046, providing audio output stating the address of UE 1 1010, and/or providing audio output stating the city, state, country of UE 1 1010). Operation proceeds from step 1792 to step 1794.

In step 1794, UE 11 1046 generates and transmits the RCS notification acknowledgement response message 1796 (e.g., a SIP 200 Ok response) to RCS server 1002 (via BS B1 1066 and network B 1086) in response to successfully receiving the RCS notification message 1788. The RCS notification acknowledgement response message 1796 is transmitted in step 1794 from UE 11 1046 to BS B1 1066. Operation proceeds from step 1794 to step 1798. In step 1798, the BS B1 1066 receives the RCS notification acknowledgement response message 1796, generates RCS notification acknowledgement response message 17100 based on the received RCS notification acknowledgement response message 1796, and transmits the generated RCS notification acknowledgement response message 17100 to network B 1086. Operation proceeds from step 1798 to step 17102. In step 17102, network B 1086 receives the RCS notification acknowledgement response message 17100, generates RCS notification acknowledgement response message 17104 based on the received RCS notification acknowledgement response message 17100 and transmits the generated RCS notification acknowledgement response message 17104 to RCS Server 1002. Operation proceeds from step 17102 to step 17106. In step 17106, RCS server 1002 receives and processes the RCS notification acknowledgement response message 17104 (e.g., a SIP 200 Ok message) which indicates that the RCS notification to UE 11 1046 has been successful.

In step 17110, RCS server 1002 generates and transmits the RCS notification message 17112 (e.g., a SIP MESSAGE method including UE 1 location information (e.g., in the message body as GPS coordinates) to commercial entity 1 communications device 1088 (via network B 1086). The RCS notification message 17112 is transmitted in step 17110 from RCS server 1002 to network B 1086. Operation proceeds from step 17110 to step 17114. In step 17114, the network B 1086 receives the RCS notification message 17112, generates RCS notification message 17116 based on the received RCS notification message 17112, and transmits the generated RCS notification message 17116 to commercial entity 1 communications device 1088. Operation proceeds from step 17114 to step 17118. In step 17118, commercial entity 1 communications device 1088 receives and processes the RCS notification message 17116. Processing the RCS notification message 17116 includes extracting the UE 1 location information from the RCS notification message 17116. If the UE 1 location information and/or the RCS notification message 17116 is encrypted, the commercial entity 1 communications device 1088 decrypts the UE 1 location information and/or the RCS notification message 17116 as part of extracting the UE 1 location information and/or processing the RCS notification message 17116. Operation proceeds from step 17118 to step 17120. In step 17120, commercial entity 1 communications device 1088 outputs the extracted UE 1 location information at commercial entity 1 communications device 1088 (e.g., displaying the UE 1 location coordinates, displaying a map with the location of UE 1 1010 on a display of commercial entity 1 communications device 1088, displaying an address of UE 1 1010 on a display of commercial entity 1 communications device 1088 displaying city, state, country of UE 1 1010 on a display of the commercial entity 1 communications device 1088, providing audio output stating the address of UE 1 1010, and/or providing audio output stating the city, state, country of UE 1 1010). Operation proceeds from step 17120 to step 17122.

In step 17122, commercial entity 1 communications device 1088 generates and transmits the RCS notification acknowledgement response message 17124 (e.g., a SIP 200 Ok response) to RCS server 1002 (via network B 1086) in response to successfully receiving the RCS notification message 17116. The RCS notification acknowledgement response message 17124 is transmitted in step 17122 from commercial entity 1 communications device 1088 to network B 1086. Operation proceeds from step 17122 to step 17126. In step 17126, network B 1086 receives the RCS notification acknowledgement response message 17124, generates RCS notification acknowledgement response message 17128 based on the received RCS notification acknowledgement response message 17124 and transmits the generated RCS notification acknowledgement response message 17128 to RCS Server 1002. Operation proceeds from step 17126 to step 17130. In step 17130, RCS server 1002 receives and processes the RCS notification acknowledgement response message 17128 (e.g., a SIP 200 Ok message) which indicates that the RCS notification to commercial entity 1 communications device 1088 has been successful.

In step 17132, RCS server 1002 generates and transmits the RCS notification message 17134 (e.g., a SIP MESSAGE method including UE 1 location information (e.g., in the message body as GPS coordinates) to government entity 1 communications device 1092 (via network B 1086). The RCS notification message 17134 is transmitted in step 17132 from RCS server 1002 to network B 1086. Operation proceeds from step 17132 to step 17136. In step 17136, the network B 1086 receives the RCS notification message 17134, generates RCS notification message 17138 based on the received RCS notification message 17134, and transmits the generated RCS notification message 17138 to government entity 1 communications device 1092. Operation proceeds from step 17136 to step 17140. In step 17140, government entity 1 communications device 1092 receives and processes the RCS notification message 17138. Processing the RCS notification message 17138 includes extracting the UE 1 location information from the RCS notification message 17138. If the UE 1 location information and/or the RCS notification message 17138 is encrypted, the government entity 1 communications device 1092 decrypts the UE 1 location information and/or the RCS notification message 17138 as part of extracting the UE 1 location information and/or processing the RCS notification message 17138. Operation proceeds from step 17140 to step 17142. In step 17142, government entity 1 communications device 1092 outputs the extracted UE 1 location information at government entity 1 communications device 1092 (e.g., displaying the UE 1 location coordinates, displaying a map with the location of UE 1 1010 on a display of government entity 1 communications device 1092, displaying an address of UE 1 1010 on a display of government entity 1 communications device 1092, displaying city, state, country of UE 1 1010 on a display of the government entity 1 communications device 1092, providing audio output stating the address of UE 1 1010, and/or providing audio output stating the city, state, country of UE 1 1010). Operation proceeds from step 17142 to step 17144.

In step 17144, government entity 1 communications device 1092 generates and transmits the RCS notification acknowledgement response message 17146 (e.g., a SIP 200 Ok response) to RCS server 1002 (via network B 1086) in response to successfully receiving the RCS notification message 17138. The RCS notification acknowledgement response message 17146 is transmitted in step 17144 from government entity 1 communications device 1092 to network B 1086. Operation proceeds from step 17144 to step 17148. In step 17148, network B 1086 receives the RCS notification acknowledgement response message 17146, generates RCS notification acknowledgement response message 17150 based on the received RCS notification acknowledgement response message 17146 and transmits the generated RCS notification acknowledgement response message 17150 to RCS Server 1002. Operation proceeds from step 17148 to step 17152. In step 17152, RCS server 1002 receives and processes the RCS notification acknowledgement response message 17150 (e.g., a SIP 200 Ok message) which indicates that the RCS notification to government entity 1 communications device 1092 has been successful. Operation proceeds from step 17152 back to step 1704 where the steps of the method 1700 repeat when the UE 1 1010 determines that updated UE 1 1010 location information is to be shared with other registered RCS entities.

Each of the RCS notification messages 1748, 1752, 1756, 1780, 1784, 1788, 17112, 17116, 17134, and 17138 include the UE 1 1010 location information. In some embodiments, each of the RCS notification messages 1748, 1752, 1756, 1780, 1784, 1788, 17112, 17116, 17134, and 17138 is implemented as a SIP MESSAGE method including in its message body UE 1 location information and a header including information indicating the message body includes UE 1 location information.

Each of the RCS notification acknowledgement response messages 1764, 1768, 1772, 1796, 17100, 17104, 17124, 17126, 17146, and 17150 may be implemented as a SIP 200 Ok message when the RCS Notification message is a SIP message.

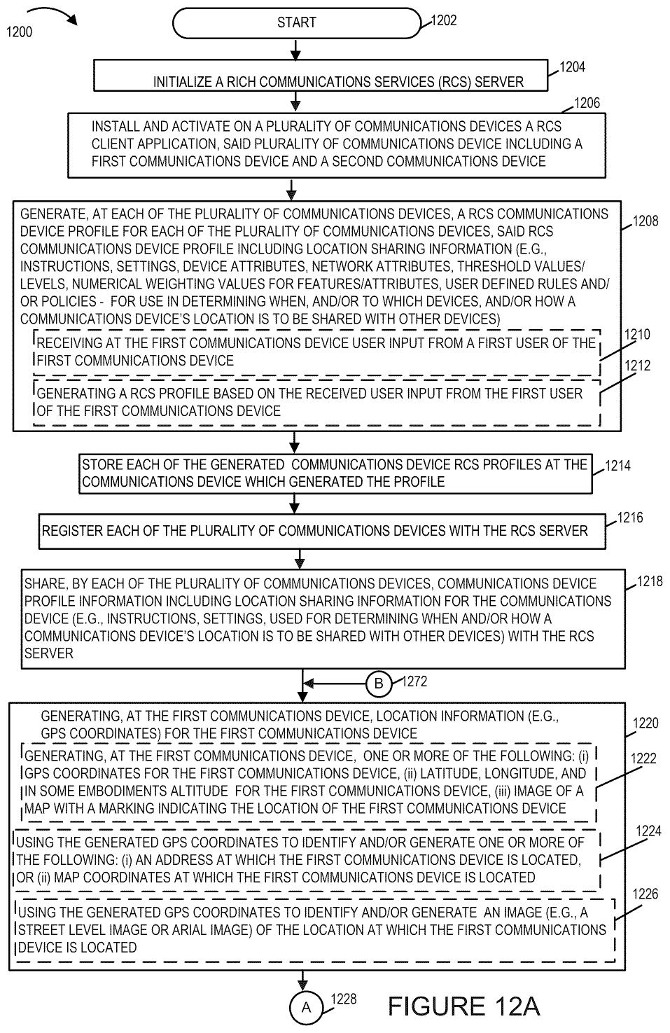

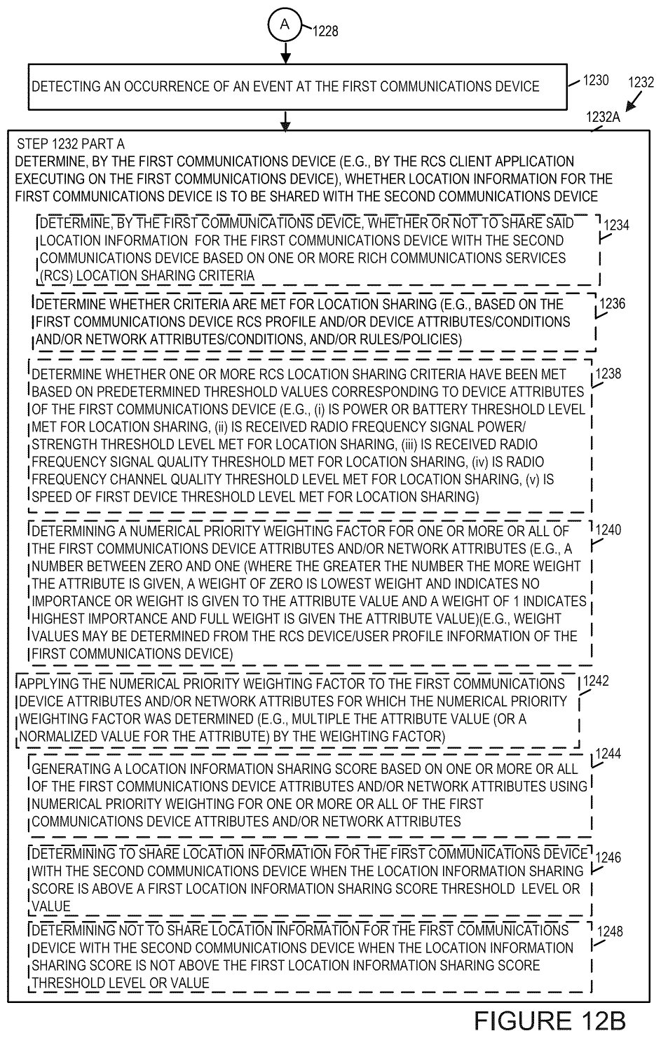

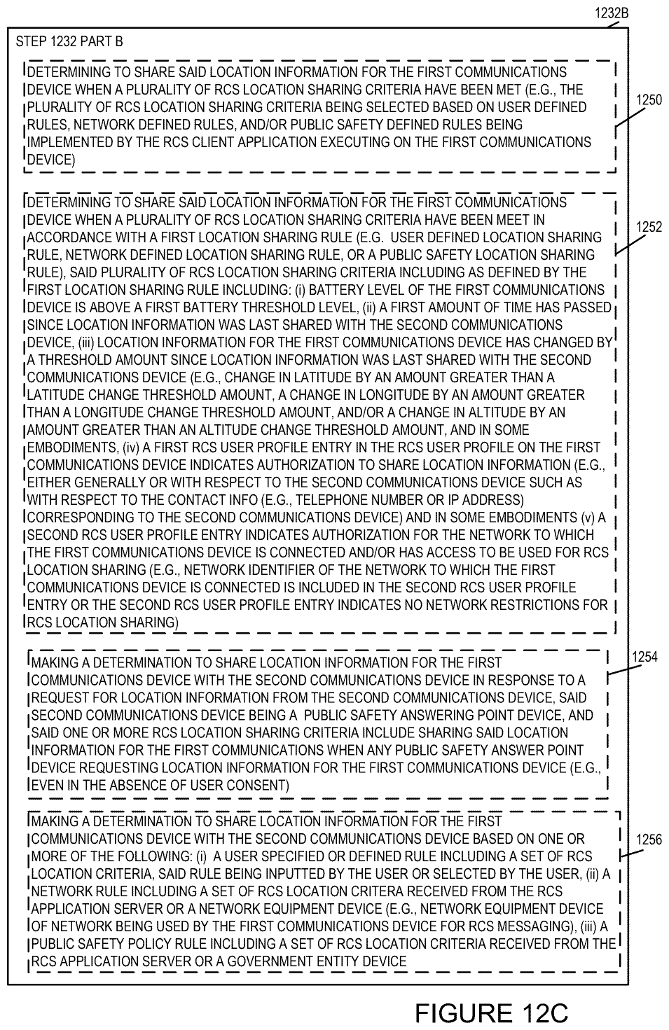

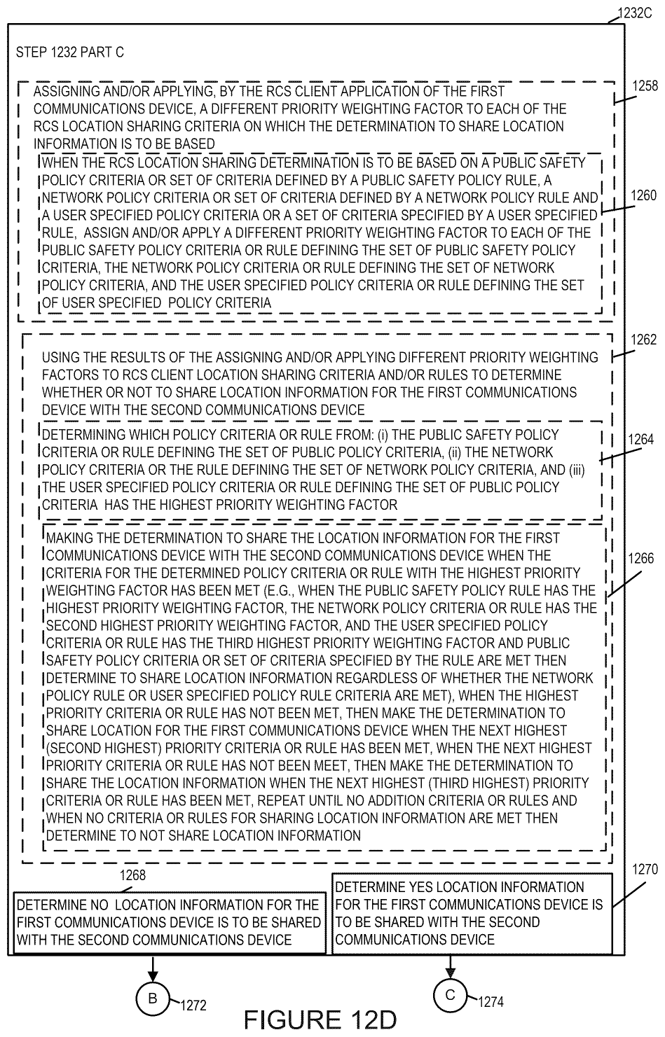

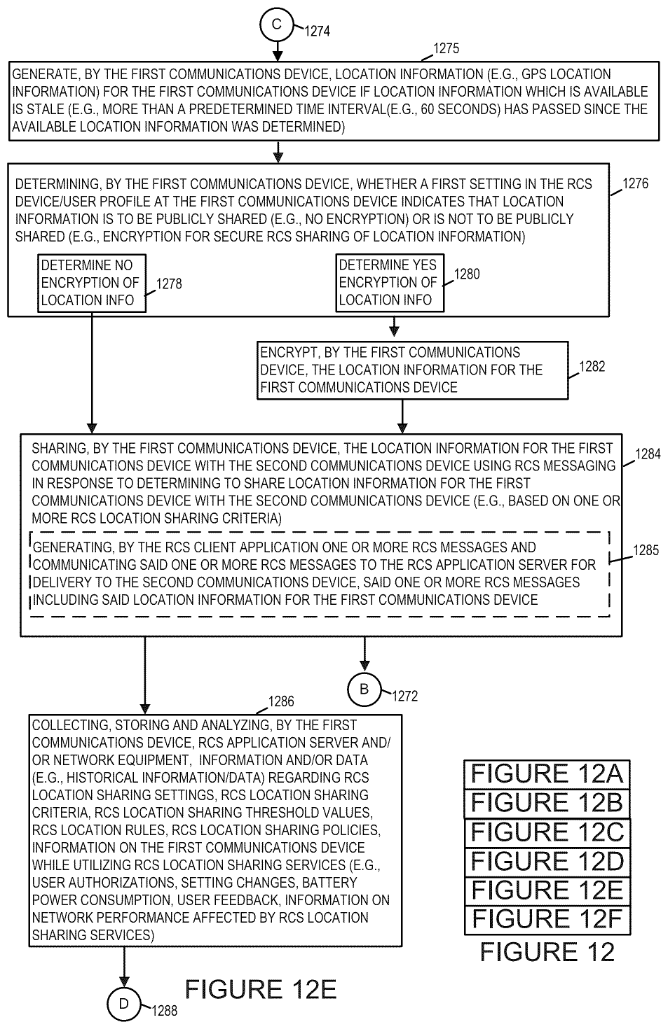

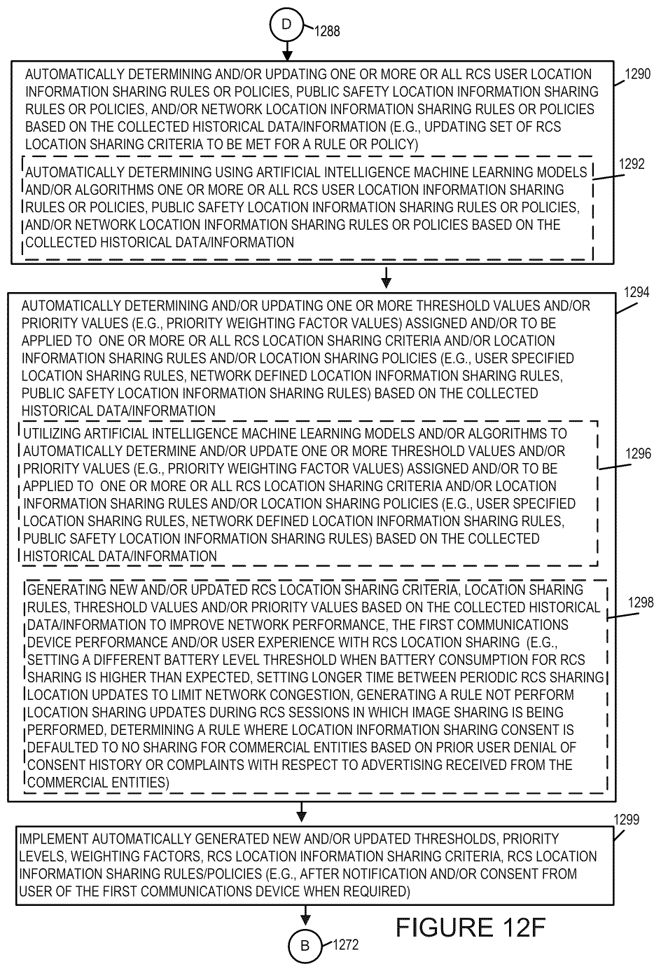

FIG. 12 comprises FIG. 12A, FIG. 12B, FIG. 12C, FIG. 12D, FIG. 12E, and FIG. 12F. FIG. 12A is the first part of a flowchart of an exemplary method 1200 in accordance with an embodiment of the present invention. FIG. 12B is the second part of a flowchart of an exemplary method 1200 in accordance with an embodiment of the present invention. FIG. 12C is the third part of a flowchart of an exemplary method 1200 in accordance with an embodiment of the present invention. FIG. 12D is a fourth part of a flowchart of an exemplary method 1200 in accordance with an embodiment of the present invention. FIG. 12E is a fifth part of a flowchart of an exemplary method 1200 in accordance with an embodiment of the present invention. FIG. 12F is a sixth part of a flowchart of an exemplary method 1200 in accordance with an embodiment of the present invention.

While it will be readily understood that additional steps are performed in connection with communicating information, data, and messages between devices, the method 1200 focuses on and discusses the steps for understanding the invention. The method 1200 will be discussed in connection with the exemplary system 1000 but is not limited to being implemented on system 1000 and can be implemented on other systems.

Method 1200 begins in start step 1202 shown on FIG. 12A. Operation proceeds from step 1202 to step 1204. In step 1204, a Rich Communications Services (RCS) application server (e.g., RCS application server 1002 of system 1000) is initialized. Operation proceeds from step 1204 to step 1206.

In step 1206, a RCS client application is installed and activated on a plurality of communications devices including a first communications device (e.g., UE 1 1010 of system 1000) and a second communications device (e.g., UE 11 1046 of system 1000). In some embodiments, the RCS client application is installed during manufacturing and/or during initial configuration. In some embodiments, the RCS client application is part of the native messaging application on the first communications device. In some embodiments, the RCS client application is downloaded from the RCS application server, a network server, or an application store. Operation proceeds from step 1206 to step 1208.

In step 1208, at each of the plurality of communications devices, a RCS communications device and/or user profile is generated. The RCS communications device profile includes location sharing information (e.g., instructions; settings; device attributes; network attributes; threshold values/levels and/or numerical weighting values for RCS location information sharing features, attributes, rules, and/or policies; user location information sharing defined rules and/or policies for RCS location information sharing (including sets of criteria for location sharing defined by the rules)—for use in determining when, and/or which devices, and/or how a communications device's location information is to be shared with other devices using Rich Communications Services. In some embodiments, step 1208 includes one or more sub-steps 1210 and 1212. In sub-step 1210, user input is received at the first communications device (e.g., by the RCS client application executing on the first communications device (e.g., RCS client application 1012 of UE 1 1010 of system 1000) from a first user of the first communications device. In sub-step 1212, a RCS profile is created and/or generated by the RCS client application of the first communications device based on the received user input from the first user of the first communications device. Operations proceed from step 1208 to step 1214.

In step 1214, each of the generated communications device RCS profiles is stored at the communications device which generated the profile (e.g., the first RCS communications device profile sometimes referred to as a first RCS user profile is stored in memory of the first communications device). Operation proceeds from step 1214 to step 1214. In step 1216, each of the plurality of communications devices register with the RCS application server so that they can obtain RCS services from the RCS application server. Operation proceeds from step 1216 to step 1218. In step 1218, each of the plurality of communications devices share their communications device profile information including location sharing information for the communications device with the RCS application server. In some embodiments, the RCS communications device profile is updated and/or generated with information from RCS application server during registration (e.g., the RCS application server can provide to the communications device rules, instructions, criteria, and/or policies for making location information sharing determination and/or decisions (e.g., Public Safety Policy location information sharing rules, network policy location information sharing rules, RCS public safety policy location information sharing criteria, RCS network policy location information sharing criteria). Operation proceeds from step 1218 to step 1220.

In step 1220 the first communications device (e.g., a GPS receiver of the first communications device) generates location information (e.g., GPS coordinates) for the first communications device. In some embodiments, step 1220 includes one or more sub-steps 1222, 1224, and 1226. In sub-step 1222, one or more of the following are generated by the first communications devices: (i) GPS coordinates for the first communications device, (ii) latitude, longitude, and sim some embodiments altitude for the first communications device, (iii) an image of a map with a marking indicating the location of the first communications device. In sub-step 1224, the first communications device (e.g., the RCS client application of the first communications device) uses generated GPS coordinates to identify and/or generate one or more of the following: (i) an address at which the first communications device is located, or (ii) map coordinates at which the first communications device is located. In sub-step 1226, the first communications device (e.g., the RCS client application of the first communications device) uses generated GPS coordinates for the first communications device to identify and/or generate one or more of the following: a street image or arial image of the location at which the first communications device is located along with a marking (e.g., a cross, X, or arrow) indicating the location of the first communications device in the image. Operation proceeds from step 1220 to step 1230 shown on FIG. 12B via connection node A 1228.

In step 1230, the first communications device detects an occurrence of an event (or one or more events) at the first communications device. In some embodiments, the first communications device constantly and/or periodically monitors conditions at the first communications device to detect the occurrence of events. Exemplary events which may be, and in some embodiments are, monitored for and detected include: (i) initiation of RCS registration of the first communications device with the second communications device, (ii) initiation of an RCS session between the first communications device and the second communications device, (iii) receipt of user input at the first communications device indicating a request to share location information for the first communications device with the second communications device, (iv) expiration of a periodic timer (e.g., during a RCS session between the first communications device and the second communications device), (v) receipt of a request at the first communications for location information for the first communications device from the second communications device, (vi) detection of a change in one or more device attributes for the first communications device (e.g., a change above a device attribute threshold level or value for the device attribute of the first device such as a device attribute of speed for the first device having a value greater than a device speed threshold value), (vii) detection of a change in one or more network attributes. In some embodiments step 1230 is optional and the determination of the whether location information is to be shared with the second communications device is not done in response to the detection of the occurrence of an event. For example, the determination to share location information may be done as part of another on-going operation being performed by the first communications device (e.g., as part of an RCS session establishment procedure). Operation proceeds from step 1230 to step 1232.

Step 1232 includes part A 1232A shown on FIG. 12B, part B 1232B shown on FIG. 12C, and part C 1232C shown on FIG. 12D. In step 1232, the first communications device (e.g., the RCS client application executing on the first communications device in response to the detection of the occurrence of an event,) determines whether location information for the first communications device is to be shared with the second communications device. In some embodiments, step 1232 includes one or more of the following sub-steps 1234, 1236, 1238, 1240, 1242, 1244, 1246, 1248, 1250, 1252, 1254, 1256, 1258, 1262, 1268, and 1274.

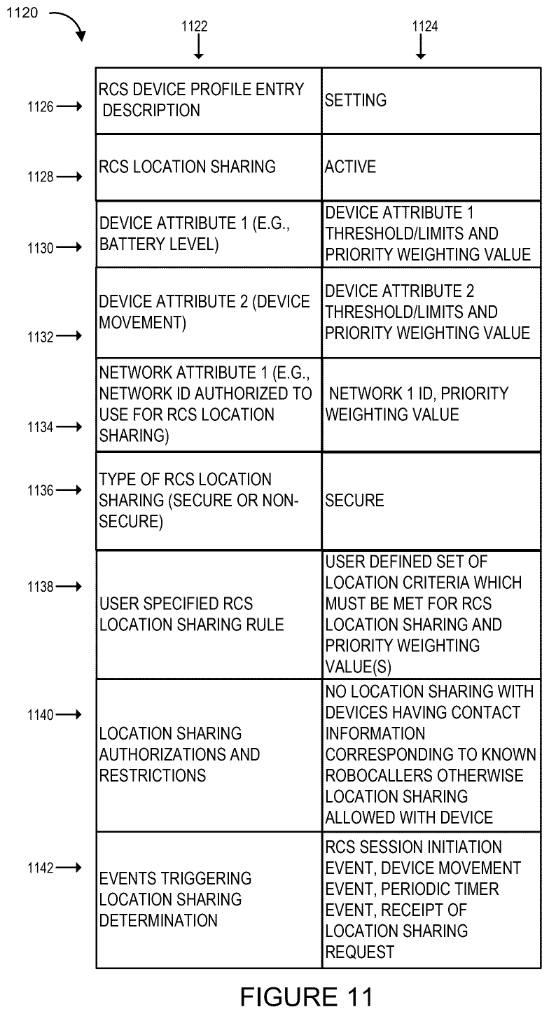

Sub-steps 1234, 1236, 1238, 1240, 1242, 1244, 1246, 1248 are shown on FIG. 11B. Sub-steps 1250, 1252, 1254, 1256 are shown on FIG. 11C. Sub-steps 1258, 1262, 1268, and 1274 are shown on FIG. 11D.

In sub-step 1234, the first communications device determines whether or not to share the location information for the first communications device with the second communications device based on one or more RCS location information sharing criteria.

In sub-step 1236, the first communications device determines whether the criteria for location sharing are met (e.g., based on the information contained in the first communications device RCS profile and/or device attributes/conditions and/or network attributes/conditions, and/or location information sharing rules and/or location information sharing policies. In some embodiments, there is one location information sharing rule for each event the occurrence of which will require a determination as to whether or not location information is to be shared. In some embodiments, the event rules includes a set of one or more criteria that must be met for a determination that location information is to be shared. The set of one or more criteria including criteria selected from among a plurality of criteria based on relevance or importance to the event. For example, if the event which triggered the determination is movement of the device than the set of criteria may include: device criteria 1—movement of device has been by an amount greater than a first threshold amount since last time location information was shared with the second communications device, device criteria 2—device profile information must indicate user consent or authorization for sharing location information location with second communications device (no restrictions on who device location information can be shared with), device criteria 3—the first communications device is moving at a speed greater than a first speed threshold amount, network criteria 1—first communications device is connected to a network with network identifier 1 (e.g., a network has a flat fee for RCS messaging identified in the RCS device profile). While other criteria such as whether a periodic timer has expired, device criteria for RF signal strength meets a threshold level, RF channel quality meets a threshold level, network congestion is below a threshold level, may not be include the set of criteria for the event movement rule for determining whether or not location information is to be shared with the second communications device.

In sub-step 1238, the first communications device determines whether one or more RCS location sharing criteria have been met based on predetermined threshold values corresponding to device attributes of the first communications device (e.g., one or more or all of the following criteria are required to be met for a determination that location information is to be shared with the second communications device: (i) is power or battery threshold level met for location sharing, (ii) is received radio frequency signal power/strength threshold level met for location sharing, (iii) is received radio frequency signal quality threshold met for location sharing, (iv) is radio frequency channel quality threshold level met for location sharing, (v) is speed of first device threshold level met for location sharing).

In some embodiments the location information sharing determination is made using numerical weighting factors which are applied to one or more of the values of the features/attributes/criteria (e.g., value of signal strength, value of radio frequency quality, value of radio frequency channel quality). The larger the numerical weighting value the more important the feature/attribute. A zero weight meaning the feature/attribute is not important and is not to be considered and a 1 indicates that the feature/attribute is of highest importance and will be given full weight. A score is then generated from the values of the weighted features/attributes and a determination is made based on the score (e.g., is the score greater than a location information sharing threshold score value if so then the determination is made to share the first communications device's location information otherwise it will not).

In sub-step 1240, the first communications device determines a numerical priority or importance weighting factor for one or more or all of the first communications device attributes and/or network attributes (e.g., a number between zero and one (where the greater the number the more weight or importance the feature/attribute is given, a weight of zero is the lowest weight and indicates no importance or weight is given to the feature/attribute value and a weight of one indicates highest priority or importance and full weight is given the feature/attribute value). In some embodiments, the weights may be determined from information included in the RCS device/user profile of the first communications device.

In sub-step 1242, the first communications device applies the numerical priority weighting factors to the first communications device attributes and/or network attributes for which the numerical priority weighting factor was determined. For example, in some embodiments this is done by multiplying the attribute value (or a normalized value for the attribute) by the weighting factor.

In sub-step 1244, the first communications device generates a location information sharing score based on one or more or all of the first communications device attributes and/or network attributes using numerical priority weighting for one or more or all of the first communications device attributes and/or network attributes. In sub-step 1246, the first communications device determines to share location information for the first communications device with the second communications device when the location information sharing score is above a first location information sharing score threshold level or value. In sub-step 1248, the first communications device determines not share location information for the first communications device with the second communications device when the location information sharing score is not above the first location information sharing score threshold level or value.

In sub-step 1250, the first communications device determines to share the location information for the first communications device when a plurality of RCS location sharing criteria have been met (e.g., the plurality of RCS location sharing criteria being selected based on user defined rules, network defined rules, and/or government policy (e.g., public safety policy) defined rules being implemented by the RCS client application executing on the first communications device). The network defines rules and/or government policy (e.g., public safety policy) rules may be received from the RCS application server and/or a network equipment device. In some embodiments, the user defined rules are based on and/or defined by settings the user inputs into the RCS device profile. In some embodiments, the user defined rules may be selected by the user from a set of different location sharing rules presented to the user by the RCS client application (e.g., during installation). Various exemplary rules include: (i) a rule in which the first communications device is not to share location information with any device having a contact address (e.g., telephone number) associated with a potential robocaller or advertising company, or (ii) a rules to only share location information with devices with which the first communications device initiates an RCS session, or (iii) a rule to only share location information during initiation of a RCS session and to perform location information sharing updates after RCS session initiation, or (iv) a rule to only share location information with devices having contact information (e.g., address or telephone number) corresponding to one listed in a pre-approved list of location sharing contact addresses/devices, (v) a rule that location information is to be shared with devices having contact information (e.g., a telephone number or IP address) included on a contact list of the first communications device, (vi) a rule to only share location information when the RCS message with the location information can be communicated over a network of a particular type or having a particular network identifier (e.g., to limit the RCS location sharing to networks which have certain features such as no charge for RCS messaging or RCS messaging not included in data consumption for the user). In many embodiments, a rule includes a set of a plurality of criteria which must be met for location sharing to be implemented.

In sub-step 1252, the first communications device determines to share said location information for the first communications device when a plurality of RCS location sharing criteria have been met in accordance with a first location sharing rule (e.g., user specified or defined location sharing rule, a network defined location sharing rule, or a public safety location sharing rule). The plurality of RCS location sharing criteria including as defined by the first location sharing rule including: (i) battery level of the first communications device is above a first battery threshold level, (ii) a first amount of time has passed since location information was last shared with the second communications device, (iii) location information for the first communications device has changed by a threshold amount since location information was last shared with the second communications device (e.g., change in latitude by an amount greater than a latitude change threshold amount, and/or a change in longitude by an amount greater than a longitude change threshold amount, and/or a change in altitude by an amount greater than an altitude change threshold amount. In some embodiments, the plurality of RCS location sharing criteria as defined by the first location sharing rule further includes: a first RCS device/user profile entry in the RCS device/user profile on the first communications device indicates authorization to share location information (e.g., either generally or with respect tot eh second communications device such as with respect to the contact information (e.g., telephone number or IP address) corresponding to the second communications device). In some embodiments, the plurality of RCS location sharing criteria as defined by the first location sharing rule further includes: a second RCS device/user profile entry in the RCS device/user profile indicates authorization for the network to which the first communications device is connected an/or has access to be used for RCS location information sharing (e.g., network identity of the network to which the first communications device is connected is included in the second RCS device/user profile entry or the second RCS device/user profile entry indicates no network restrictions for RCS location sharing).

In sub-step 1254, the first communications device makes a determination to share location information for the first communications device with the second communications device in response to a request for location information from the second communications device. The second communications device is a public safety answering point device and the one or more RCS location sharing criteria include sharing said location information for the first communications device when any public safety answering point device requests location information for the first communications device (e.g., even in the absence of user consent to share the location information).

In sub-step 1256, the first communications device makes a determination to share location information for the first communications device with the second communications device based on one or more of the following: (i) a user specified or defined rule including a set of RCS location criteria, said rule being inputted by the user or selected by the user of the first communications device, (ii) a network rule including a set of RCS location criteria received from the RCS application server or a network equipment device (e.g., network equipment device of network being used by the first communications device for RCS messaging), and (iii) a public safety policy rule including a set of RCS location criteria received from the RCS application server or a government entity device.

In sub-step 1258, the RCS client application of the first communications device assigns and/or applies a different priority weighting values or factors to each of the RCS location sharing criteria on which the determination to share location information is to be based. In some embodiments sub-step 1258 includes sub-step 1260. In sub-step 1260, when the RCS location sharing determination is to be based on a public safety policy criteria or set of criteria defined by a public safety policy rule, a network policy criteria or set of criteria defined by a network policy rule, and a user specified policy criteria or a set of criteria specified by a user specified rule, assign and/or apply a different priority weighting factor to each of the public safety policy criteria or rule defining the set of public safety policy criteria, the network policy criteria or rule defining the set of network policy criteria, and the user specified policy criteria or rule defining the set of user specified policy criteria.

In sub-step 1262, the first communications device uses the results of the assigning and/or applying different priority weighting values or factors to RCS client location sharing criteria and/or rules to determine whether or not to share location information for the first communications device with the second communications device. In some embodiments, sub-step 1262 includes one or more sub-steps 1264 and 1266. In sub-step 1264, the first communications device determines which of the following has the highest priority weighting factor or value assigned and/or applied: (i) the public safety policy criteria or rule defining the set of public safety policy criteria, (ii) the network policy criteria or rule defining the set of network policy criteria, and (iii) the user specified policy criteria or rule defining the set of user specified policy criteria.

In sub-step 1266, the first communications device makes the determination to share the location information for the first communications device with the second communications device when the criteria for the determined policy criteria or rule with the highest priority weighting factor or vale has been met (e.g., when the public safety policy rule has the highest priority weighting factor or value, the network policy criteria or rule has the second highest priority weighting factor or value, and the user specified policy criteria or rule has the third highest priority weighting factor or value and the public policy safety criteria or set of criteria specified by the public policy safety criteria rule are met then determine to share location information for the first communications device with the second communications device regardless of whether or not the network policy criteria or set of criteria defined by the network policy rule or the user specified policy criteria or set of criteria defined by the user specified policy rules are met). When the highest priority criteria or set of criteria for the highest priority rule has not been met, then make the determination to share location information for the first communications device when the next highest (second highest) priority criteria or set of criteria for second highest priority rule has been met. When the next highest (second highest) priority criteria or set of criteria for the second highest priority rule has not been met, then make the determination to share the location information for the first communications when the next highest (third highest) priority criteria or set of criteria for the third highest priority rule has been met. If the third highest priority criteria or set of criteria for the third highest priority rule has not been met then determine not to share location information for the first communications device. If more then three levels of priorities exist then the process is repeated for priority level, until the criteria or set of criteria corresponding to the lowest weighting factor or value has been tested to determine whether the criteria or set of criteria have been met or not.

In sub-step 1268, the determination is made that location information for the first communications is not to be shared with the second communications device and operation proceeds from sub-step 1268 of step 1232 via connection node B 1272 to step 1220 shown on FIG. 12A where the method continues as previously described.

In sub-step 1270, the determination is made that location information for the first communications device is to be shared with the second communications device and operation proceeds from sub-step 1270 of step 1232 via connection node C 1274 to step 1275 shown on FIG. 12E.

In step 1275, the first communications device generates location information (e.g., GPS location information) for the first communications device if location information which is available is stale (e.g., more than a predetermined time interval (e.g., 60 seconds) has passed since the available location information was determined). In some embodiments, step 1275 includes one or more sub-steps 1222, 1224, and 1226 described in connection with step 1220. Operation proceeds from step 1275 to step 1276.

In step 1276, the first communications device determines whether a first setting in the RCS device/user profile at the first communications device indicates that location information is to be publicly shared (e.g., no encryption) or is not be publicly shared (e.g., encryption for secure RCS sharing of location information (e.g., using end-to-end encryption). Operation proceeds from sub-step 1278 of step 1276 to step 1284 when the determination is that no encryption of the location information to be shared is required. Operation proceeds from sub-step 1280 of step 1276 to step 1282, when the determination is that yes encryption of location information to be shared is required. In step 1282, the first communications device encrypts the location information for the first communications device. Operation proceeds from step 1282 to step 1284.

In step 1284, the first communications device shares the location information for the first communications device with the second communications device using RCS messaging in response to determining to share location information for the first communications device with the second communications device (e.g., based on one or more RCS location sharing criteria being met). In some embodiments, step 1284 includes sub-step 1285. In sub-step 1285, the RCS client application executing generating on the first communications device generates one or more RCS messages and communicates the one or more RCS messages to the RCS application server for delivery to the second communications device. The one or more RCS messages including the location information for the first communications device. Operation proceeds from step 1284 to step 1286 shown on FIG. 12E and to step 1220 via connection node 1272. Step 1220 is shown on FIG. 12A. Operation proceeds in step 1220 as previously described.

In step 1286, the first communications device, the RCS application server, and/or a network equipment device (e.g., OSS network equipment device) collect, store and/or analyze information and/or data (e.g., historical information/data) regarding RCS location services, network performance, first communications device performance during the first communications device's utilization of the RCS location services. The information and/or data collected includes for example with respect to a plurality of different devices including the first communications device which are utilizing RCS location sharing services: RCS location sharing settings, RCS location sharing criteria, RCS location sharing threshold values, RCS location sharing rules, RCS location sharing policies, first communications devices' user authorizations, settings, battery power consumption (e.g., during RCS location sharing), user feedback for RCS location information sharing. Operation proceeds from step 1286 to step 1290 shown on FIG. 12 F via connection node D 1288.

In step 1290, one or more or all RCS user location information sharing rules or policies, public safety location information location information sharing rules or policies, and/or network location information sharing rules or policies is automatically determined and/or updated based on the collected historical data/information (e.g., updating a set of RCS location sharing criteria to be met for a rule or policy). In some embodiments step 1290, including sub-step 1292. In sub-step 1292, artificial intelligence machine learning models and/or algorithms are used in automatically determining and/or updating the or more or all RCS user location information sharing rules or policies, public safety location information location information sharing rules or policies, and/or network location information sharing rules or policies based on the collected historical data/information. In some embodiments, the first communications device performs step 1290. In some embodiments, step 1290 is performed by the RCS application server. In some embodiments, a network equipment device performs step 1290. In some embodiments, step 1290 is broken in three steps. In some such embodiments, the first step of automatically determining or updating of the RCS user location information sharing rules or policies based on collected historical data/information being performed by the first communications device. The second step of automatically determining or updating of the public safety location information sharing rules or policies based on collected historical data/information is being performed by a government entity device or the RCS application server. The third step of automatically determining or updating of the RCS network location information sharing rules or policies based on collected historical data/information is performed by a network equipment device. Operation proceeds from step 1290 to step 1294.

In step 1294, one or more threshold values and/or priority values (e.g., priority weighting factor values) assigned and/or to be applied to one or more or all RCS location sharing criteria and/or location information sharing rules and/or location sharing policies (e.g., user specified or defined location sharing rules, network defined location information sharing rules, public safety location information sharing rules) is automatically determined and/or updated based on the collected historical data/information. In some embodiments, step 1294 includes one or more sub-steps 1296 and 1298. In sub-step 1296, one or more threshold values and/or priority values (e.g., priority weighting factor values) assigned and/or to be applied to one or more or all RCS location sharing criteria and/or location information sharing rules and/or location sharing policies (e.g., user specified or defined location sharing rules, network defined location information sharing rules, public safety location information sharing rules) is automatically determined and/or updated based on the collected historical data/information utilizing artificial intelligence machine learning models and/or algorithms. In sub-step 1298, new and/or updated RCS location sharing criteria, location sharing rules, threshold values and/or priority values based on collected historical data/information are generated to improve network performance, the performance of the RCS application server, the performance of the first communications device and/or user experience with RCS location sharing at the first communications device (e.g., setting a different battery level threshold when battery consumption for RCS sharing is higher than expected, setting a longer time between periodic RCS sharing location information updates to limit network congestion, generating a rules to not perform location sharing updates during RCS session in which image sharing is being performed, determining a rule where location information sharing consent is defaulted to no location information sharing for commercial entities based on prior user denial of consent history or complaints with respect to advertising received from the commercial entities).

In some embodiments, step 1294 is performed by one or more of the following: (i) first communications device, (ii) RCS application server, (iii) a network equipment device (e.g., an OSS network equipment device), or a (iv) a government entity device. Operation proceeds from step 1294 to step 1299.

In step 1299, the automatically generated and/or determined new and/or updated thresholds, priority levels, weighting factors, RCS location information sharing criteria, RCS location information sharing rules/policies (e.g., after notification and consent form the user of the first communications device when required) are implemented. Operation proceeds from step 1299 via connection node B 1272 to step 1220 shown on FIG. 12A where method 1200 proceeds as previously described.

While various embodiments have been discussed, additional uses of the present invention include providing location based services by in chat apps which can access RCS location sharing such as Chat based reservations/ticketing, Chat based purchases, Geotagging and journaling use cases. RCS location sharing during a RCS chat session to receive appropriate service or targeted advertisements. RCS location sharing can be used to receive Public Safety Access Point based assistance in cases wherein a user could be engaged in a RCS chat session with an emergency operator rather than on a voice call. RCS location sharing query initiated by a PSAP entity device or other government safety entity in cases the user is un-responsive or reported lost to the government agency. The thresholds and weighting factors/values as discussed above can be used to determine and/or effect reporting or location sharing frequency and/or reporting and/or location sharing decisions (e.g., whether or not to report or share location information). The threshold may include for example, battery level or power, movement, access to GPS information, accuracy of location information, type of environment (urban, suburban, rural, etc.) in which the device is located, radio frequency signal strength and quality levels, types of networks that that the device has access to and time (e.g., periodicity of sharing location information). Weights may, and in some embodiments, as discussed above can be included to prioritize or de-prioritize thresholds which the location sharing or reporting decision is being made.

FIG. 11 is table 1120 illustrating an exemplary RCS device profile with exemplary RCS device profile entries in accordance with an embodiment of the present invention. The table 1120 includes columns 1122 and 1124 and rows 1126, 1128, 1130, 1132, 1134, 1136, 1138, 1140, and 1142. The entries in row 1126 are labels indicating the information contained in each column. Entries in column 1122 are descriptions of information/setting for the RCS device profile entry corresponding to the information in the row (entry row 1126, column 1122). Entries in column 1124 are the settings for the RCS device profile entry (entry row 1126, column 1124) which is in the same row. Row 1128 includes RCS location sharing information (entry row 1128, column 1122) the setting of which is active (entry row 1128, column 1124). Row 1130 includes information for device attribute 1 (e.g., battery level) (entry row 1130, column 1122) which includes settings of device attribute 1 threshold/limits and a priority weighting value (entry row 1130, column 1124). Row 1132 includes information for device attribute 2 (e.g., device movement) (entry row 1132, column 1122) which includes settings for device attribute 2 threshold/limits and a priority weighting value (entry row 1132, column 1124). Row 1134 includes information for network attribute 1 (e.g., network ID authorization for use for RCS location information sharing) (entry row 1134, column 1122) which includes a setting of network 1 ID and a priority weighting value (entry row 1134, column 1124). Row 1136 includes information for type of RCS location information sharing (e.g., secure or non-secure) (entry row 1136, column 1122) which includes a setting of secure (entry row 1136, column 1124). Row 1138 includes information for user specified RCS location sharing rule (entry row 1138, column 1122) which includes a setting of user defined set of location criteria which must be met for RCS location sharing to be implemented and priority weighting value(s) (entry row 1138, column 1124). A single weighting value can be used for the rule as well as individual weighting values for the criteria specified in the rule. Row 1140 includes information for RCS location sharing authorization and restrictions (entry row 1140, column 1122) which includes a setting of no location sharing with devices having contact information corresponding to known robocallers otherwise location sharing allowed with device (entry row 1140, column 1124). In some embodiments, the setting in 1140 can include one or more of the following: no restrictions, a list of authorized contacts, a list of non-authorized contacts. In some embodiments, separate RCS device profile entries are included for: (i) authorized contacts with which RCS location sharing is allowed, and (ii) contacts for which location sharing is not authorized. Row 1142 includes information for events triggering location sharing determination (entry row 1142, column 1122) which includes a setting of RCS session initiation event, device movement event, periodic timer event, receipt of location sharing event (entry row 1142, column 1124). The entries illustrated in RCS device profile table 1120 are only example and it is to be understand that typically many additional entries are included in a RCS device profile. As previously mentioned, RCS device profile is also sometimes referred to as a RCS user profile herein.

Additional ways in which SIP messages can be used for sharing RCS location information for a device in accordance with embodiments of the present invention will now be discussed. By indicating a presence of content in a SIP Register by modifying the content length of SIP Register, RCS location information data for a device can be provided while registering with a SIP Server entity (e.g., RCS application server). While requesting a service, RCS location data for a device can be included in a SIP INVITE in the content portion of the message. While SIP UPDATE messages are currently used to update connection/session details between peers, the SIP UPDATE message can be used to include RCS location data for a device to be shared between users.

SIP SUBSCRIBE/PUBLISH/NOTIFY messages can be used to share RCS location information for devices. For example, if subscribed to the service using SIP SUBSCRIBE messages, notifications can be received with RCS location data for a device once this information is published in the case of periodic or event driven RCS device location updates which can be provided via SIP PUBLISH or NOTIFY messages. SIP INFO message which is currently used for DTMF type operation support, with the objective of passing along information without modifying the session, can be used to share RCS location information for a device by including the information in the SIP INFO message. SIP OPTIONS messages which are used to query endpoints and to ensure a session is kept alive, can be adapted to query for RCS location information for a device.

Additionally, Session Description Protocol messages can be used for RCS location information sharing of devices in the case of multicast scenarios. The RCS location information details for a device can be included in the SDP message content to share RCS location information for the device across the session.

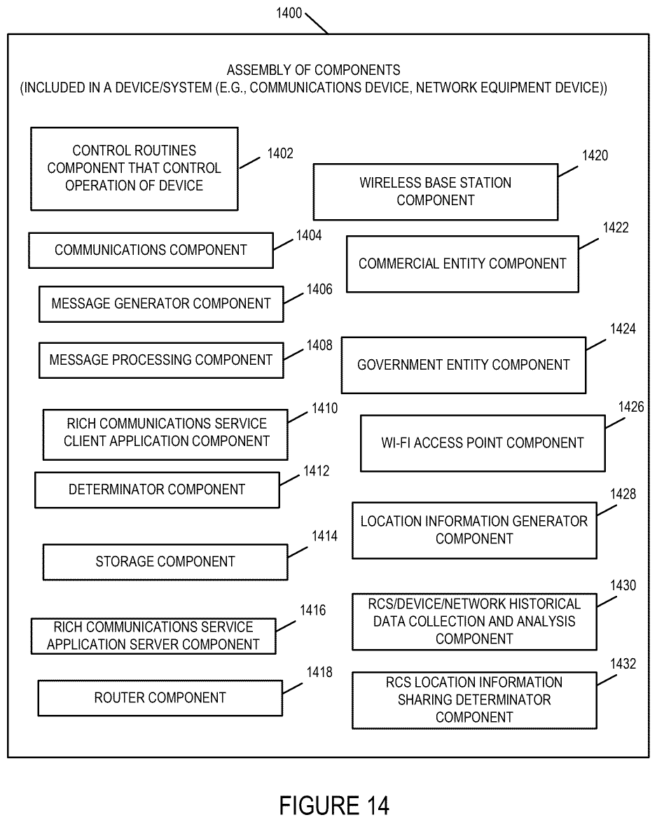

FIG. 14 is a drawing of an exemplary assembly of components 1400 which may be included in a device (e.g., communications device 500 of FIG. 2 or network equipment device 600 of FIG. 13), in accordance with an exemplary embodiment. The components in the assembly of components 1400 can, and in some embodiments are, implemented fully in hardware within a processor or one or more processors, e.g., processor(s) 506 for communications device 500 or processor(s) 606 for network equipment device 600, e.g., as individual circuits. The components in the assembly of components 1400 can, and in some embodiments are, implemented fully in hardware within the assembly of hardware components within the device (e.g., assembly of hardware components 508 for the communications device 500 or assembly of hardware components 608 for network equipment device 600), e.g., as individual circuits corresponding to the different components. In other embodiments some of the components are implemented, e.g., as circuits, within processor(s) of the device (e.g., within processor(s) 506 of communications device 500 or processor(s) 606 of network equipment device 600) with other components being implemented, e.g., as circuits within assembly of software components included in memory (e.g., assembly of components 508 of communications device 500 or assembly of components 608 in network equipment device 600), external to and coupled to the processor(s) of the device (e.g., processor(s) 506 of communications device 500 or the processor(s) 606 of the network equipment device 600). As should be appreciated, the level of integration of components on the processor and/or with some components being external to the processor may be one of design choice. Alternatively, rather than being implemented as circuits, all or some of the components may be implemented in software and stored in the memory of the device (e.g., memory 512 of communications device 500 or memory 612 of the network equipment device), with the components controlling operation of the device (e.g., communications device 500 or network equipment device 600) to implement the functions corresponding to the components when the components are executed by a processor of the device (e.g., processor 506 of communications device 500 or processor 606 of network equipment device 600). In some such embodiments, the assembly of components 1400 is included in the memory of the device as an assembly of software components (e.g., assembly of software components 516 of communications device 500 or assembly of software components 616 of network equipment device 600). In still other embodiments, various components in assembly of components 1400 are implemented as a combination of hardware and software, e.g., with another circuit external to the processor providing input to the processor which then under software control operates to perform a portion of a component's function.

When implemented in software the components include code, which when executed by a processor or one or more processors, e.g., processor(s) 506 of communications device 500 or processor(s) 606 of network equipment device 600, configure the processor(s) to implement the function corresponding to the component. In embodiments where the assembly of components 1400 is stored in the memory of the device (e.g., memory 512 of communications device 500 or memory 612 of network equipment device 600), the memory (e.g., 512 or 612) is a computer program product comprising a computer readable medium comprising code, e.g., individual code for each component, for causing at least one computer, e.g., processor 506 of communications device 500 or processor 606 of network equipment device 600, to implement the functions to which the components correspond.

Completely hardware based or completely software based components may be used. However, it should be appreciated that any combination of software and hardware, e.g., circuit implemented components may be used to implement the functions. As should be appreciated, the components illustrated in FIG. 14 control and/or configure the device (e.g., communications device 500 or network equipment device 600) or elements therein such as the processor(s) 506 or 606, to perform the functions of corresponding steps illustrated and/or described in the method of one or more of the flowcharts, signaling diagrams and/or described with respect to any of the Figures. Thus the assembly of components 1400 includes various components that perform functions of corresponding one or more described and/or illustrated steps of an exemplary method.

Assembly of components 1400 includes a control routines component 1402, a communications component 1404, a message generator component 1406, a message processing component 1408, a Rich Communications Services client application component 1410, a determinator component 1412, a storage component 1414, a Rich Communications Services application server component 1416, a router component 1418, a wireless base station component 1420, a commercial entity component 1422, a government entity component 1424, a Wi-Fi Access Point component 1426, a location information generator component 1428, a RCS/device/network historical data collection and analysis component 1430, and a RCS location information sharing determinator component 1432.

The control routines component 1402 is configured to control operation of the device. The communications component 1404 is configured to handle communications, e.g., transmission and reception of messages, and protocol signaling for the device.

The message generator component 1406 is configured to generate messages for transmission to other devices. Exemplary messages which are generated include RCS messages, Session Initiation Protocol messages, Message Session Relay Protocol messages, request messages, registration messages, and session initiation messages.

The message processing component 1408 is configured to process messages and implement procedures/operations in response to messages or based on the contents of messages. This includes messages received from other devices, e.g., messages from wireless base stations, routers, Wi-Fi Access Points, other communications devices, user equipment devices, RCS application server, database systems, commercial entity devices, government entity devices, PSAP devices.

The Rich Communications Service client application component 1410 is configured to perform all operations and functions for providing Rich Communications Services to a user of the device including for example: generating RCS device profile, communicating with the RCS application server, generating, transmitting, receiving and processing RCS messages, making RCS location information sharing determinations for the device, monitoring for and detecting events (e.g., events triggering location information sharing determinations, generation location information for the device, implementing location sharing rules and policies, collecting and analyzing device, network and RCS data, automatically updating rules, policies, threshold values, and priority weighting factors, encrypting information, decrypting information.

The determinator component 1412 is configured to make determinations and decisions for the device (e.g., RCS location information sharing determinations, determinations as to whether RCS location information sharing criteria have been met, determination as whether threshold levels/values have been met, determinations to what weighting factors or priority values are to be assigned and/or applied (e.g., to rules, policies, criteria, attributes), determinations as to whether an event has occurred, determinations as to whether an amount of time has elapsed or a timer has expired, determinations as which rules, policies, criteria and/or attributes are to evaluated when making a RCS location information sharing decision, determinations as to the type of network(s) to which the device has access to and/or is connected to, determinations as to what information has been input into a RCS communications device profile, determinations as to the type of data being exchanged during an RCS session, determinations as to the network identity of the networks to which the device is connected and/or has access to, determinations as to whether location information is to be encrypted or not when shared with other devices).

The storage component 1414 is configured to manage the storage, and retrieval of data and/or instructions to/and from memory, and/or storage devices coupled to and/or connected to and/or included in the device.

The Rich Communications Service application server component is configured to perform the operations for a RCS application server to provide RCS services to communications devices, government entity devices, commercial entity devices including for example RCS registration and de-registration of RCS client applications executing on devices, performing RCS message forwarding, distributing RCS location information sharing instructions, rules, criteria and/or policies to be implemented by registered RCS application clients, sharing of devices location information when authorized, determining and distributing device location information, RCS instant messaging between RCS client devices, collection and analysis of historical device, network and RCS client application performance for improving and/or optimizing device, network and/or RCS service performance including updating rules, policies, threshold levels, criteria, and/or weighting factors for RCS location information sharing between devices executing client applications. The RCS application server component 1416 also performs all operations and functions described in connection with RCS server in system 1000.

The router component 1418 is configured to perform routing operations such as, for example, routing of received RCS messages, SIP messages, and MSRP messages to their intended destinations. The wireless base station component 1420 implements wireless base station operations including for example, receiving and forwarding of messages between wireless and non-wireless devices. The wireless base station component further performs all operations and functions described in connection with the base stations of system 1000. The commercial entity component 1422 is configured to perform the operations described in connection with the commercial entity devices of system 1000. The government entity component 1424 is configured to perform the operations described in connection with the government entities including PSAP entities of system 1000. The Wi-Fi Access Point component 1426 is configured to provide Wi-Fi services to communications devices and perform the operations described in connection with the Wi-Fi Access Points of system 1000. The location information generator component 1428 generates information on the location or position of the device such as for example, GPS coordinates, map coordinates, image of location, map image with indicator of location, street address, etc. The RCS/Device/Network historical data collection and analysis component 1430 collects information on RCS service performance (e.g., RCS location information sharing), device performance, and network performance and analyzes the collected information to improve and/or optimize RCS service performance, network performance and/or device performance. For example, improving RCS location information sharing user experience by generating and/or updating location information sharing rules, policies, criteria, triggering events, threshold levels used in determinations and weighting factors. The RCS location information sharing determinator component is configured to make RCS location information sharing determinations for a RCS client application executing on a communications device and/or a RCS Application Server. In some embodiments, the RCS/Device/Network historical data collection and analysis component 1430 is a sub-component of the RCS client application component 1410, the RCS application server component 1416, or the determinator component 1412. In some embodiments, the RCS location information sharing determinator component is a sub-component of the of the RCS client application component 1410, the RCS application server component 1416, or the determinator component 1412.

The specific components of the assembly of components 1400 included in any particular device may, and typically does vary depending on the specific device and the functionality required for the device and/or the operations the device is responsible for performing.

Various exemplary numbered embodiments illustrating different features of the present invention will now be discussed. The various features discussed may be used in variety of different combinations. It should be appreciated that not necessarily all embodiments include the same features and some of the features described below are not necessary but can be desirable in some embodiments. The numbered embodiments are only exemplary and are not meant to be limiting to the scope of the invention. The various method embodiments may be, and in some embodiments are, implemented on system 1000 of FIG. 1.

### List of Exemplary Numbered Method Embodiments

Method Embodiment 1. A method comprising: generating, at a first communications device, location information for the first communications device; and determining, by the first communications device, whether or not to share said location information for the first communications device with a second communications device based on one or more Rich Communications Services (RCS) location sharing criteria.

Method Embodiment 1A. The method of Method Embodiment 1, further comprising: detecting the occurrence of an event at the first communications device; in response to detecting the occurrence of the event at the first communications device, performing said operation of determining, by the first communications device, whether or not to share said location information for the first communications device with a second communications device based on one or more Rich Communications Services (RCS) location sharing criteria.

Method Embodiment 1B. The method of Method Embodiment 1A, wherein the event is one of the following: (i) initiation of RCS registration of the first communications device with the second communications device, (ii) initiation of an RCS session between the first communications device and the second communications device, (iii) receipt of user input at the first communications device indicating a request to share location information for the first communications device with the second communications device, (iv) expiration of a periodic timer (e.g., during a RCS session between the first communications device and the second communications device), (v) receipt of a request at the first communications for location information for the first communications device from the second communications device, (vi) detection of a change in one or more device attributes for the first communications device (e.g., a change above a device attribute threshold level or value for the device attribute of the first device such as a device attribute of speed for the first device having a value greater than a device speed threshold value), (vii) detection of a change in one or more network attributes.

Method Embodiment 1C. The method of Method Embodiment 1B, wherein the one or more first communications device attributes include one or more of the following: (i) power or battery level, (ii) received radio frequency power level (e.g., Reference Signal Received Power (RSRP) level), (iii) received radio frequency quality level (e.g., Reference Signal Received Quality (RSRQ), (iv) radio frequency channel quality, (v) type of data being shared during a RCS session, (vi) mobility state of the first communications device (e.g., stationary or moving), (vii) speed and/or direction of movement of the first communications device, (viii) location of the first communications device (e.g., type of environment in which the first communications device is located such as urban, suburban, or rural), (ix) change in location of the first communications device, (x) accuracy of location information (e.g., GPS accuracy), and (xi) Radio Resource Control state (e.g., connected, idle, idle-limited service).

Method Embodiment 2. The method of Method Embodiment 1, wherein generating, at the first communications device, location information for the first communications device includes: generating Global Position System (GPS) coordinates for the location of the first communications device.

Method Embodiment 2A. The method of Method Embodiment 1, wherein said generating location information for the first communications device further includes: using the generated GPS coordinates to identify one or more of the following: (i) an address (e.g., street address) at which the first communications device is located, or (ii) map coordinates at which the first communications device is located.

Method Embodiment 2B. The method of Method Embodiment 1, wherein said generating location information for the first communications device further includes: generating an image of a map with an identifier (e.g., mark such as a cross or an X or an icon) indicating the location of the first communications device.

Method Embodiment 2C. The method of Method Embodiment 1, wherein said location information for the first communications device includes one or more of the following: (i) Global Position System coordinates for the first communications device, (ii) latitude and longitude information for the first communications device, (iii) latitude, longitude and altitude information for the first communications device, (iv) a street address at which the first communications device is located, (v) map coordinates for first communications device, (vi) an image of a map with an identifier indicating where on the map the first communications device is located, and (vii) a city, state, and country at which the first communications device is located.

Method Embodiment 3. The method of Method Embodiment 2, further comprising: sharing said location information with said second communications device using Rich Communications Services messaging in response to determining, by the first communications device, to share said location information for the first communications device with the second communications device based on said one or more Rich Communications Services (RCS) location sharing criteria.

Method Embodiment 3A. The method of Method Embodiment 3, further comprising: encrypting, by the first communications device, said location information for the first communications device, prior to sharing said location information of the first communications device with the second communications device.

Method Embodiment 3B. The method of Method Embodiment 3A, further comprising: prior to encrypting, by the first communications device, said location information for the first communications device, determining that a first setting in an RCS user profile at the first communications device indicates that location information is not to be publicly shared (e.g., secure or non-public information sharing is indicated) or indicates that location information is to be encrypted (e.g., secure location information sharing is indicated).

Method Embodiment 4. The method of Method Embodiment 3, wherein said operation of determining, by the first communications device, whether or not to share said location information for the first communications device with a second communications device based on one or more Rich Communications Services (RCS) location sharing criteria is performed by a RCS client application executing on the first communications device; and wherein said sharing said location information with said second communications device using Rich Communications Services messaging includes: generating by the RCS client application one or more RCS messages and communicating (e.g., transmitting) said one or more RCS messages to a RCS application server for delivery to the second communications device, said one or more RCS messages including said location information for the first communications device.

Method Embodiment 4A. The method of Method Embodiment 4, wherein said one or more generated RCS messages are one or more Session Initiation Protocol (SIP) messages.

Method Embodiment 4B. The method of Method Embodiment 4A, wherein said one or more SIP messages is a first SIP message; and wherein said location information for the first communications device is included in a SIP header of the first SIP message.

Method Embodiment 4C. The method of Method Embodiment 4A, wherein said one or more SIP messages is a first SIP message, said first SIP message being a SIP Message Method message; and wherein said location information for the first communications device is included in a message body portion of the first SIP Message Method message.

Method Embodiment 4D. The method of Method Embodiment 4, wherein said one or more generated RCS messages is a Message Session Relay Protocol (MSRP) message; and wherein said location information for the first communications device is included in a message body portion of the Message Session Relay Protocol message.

Method Embodiment 5. The method of Method Embodiment 4, wherein said one or more RCS location sharing criteria include at least one of the following: a public safety policy criteria, a network policy criteria, or a user specified policy criteria.

Method Embodiment 6. The method of Method Embodiment 5, wherein the one or more RCS location sharing criteria include a public safety policy criteria, a network policy criteria, and a user specified policy criteria; wherein the method further comprises: applying by the RCS client application a different priority weighting factor to each of the public safety policy criteria (e.g., priority weighting factor of 1), the network policy criteria (e.g., priority weighting factor of 0.5), and the user specified policy criteria (e.g., priority weighting factor of 0.7); and wherein said determining, by the first communications device, whether or not to share said location information for the first communications device with the second communications device based on one or more Rich Communications Services (RCS) location sharing criteria includes: determining which policy criteria from the public safety policy criteria, the network policy criteria, and the user specified policy criteria has the highest priority weighting factor (e.g., public safety policy criteria which has a priority weighting of 1); and making the determination to share the location information for the first communications device with the second communications device when the criteria for the determined policy criteria with the highest priority weighting factor has been met.

Method Embodiment 6A. The method of Method Embodiment 6, wherein the public safety policy criteria is met when the second communications device is a government safety entity device.

Method Embodiment 6B. The method of Method Embodiment 6, wherein the public safety policy criteria includes determining whether the second communications device is a government safety entity device; wherein the network policy criteria includes determining the identity of the network to which the first communications device is connected and only sharing location information when connected to a network having a first network identity; and wherein the user specified policy criteria includes only sharing location information on initial RCS session establishment.

Method Embodiment 7. The method of Method Embodiment 5, wherein said second communications device is a Public Safety Answering Point device requesting location information for the first communications device; wherein said one or more RCS location sharing criteria include a public safety policy criteria, said public safety policy criteria including sharing said location information for the first communications device with any Public Safety Answering Point device requesting location information for the first communications device; and wherein said determining, by the first communications device, whether or not to share said location information for the first communications device with the second communications device based on one or more Rich Communications Services (RCS) location sharing criteria includes: making a determination to share said location information for the first communications device with the Public Safety Answering Point device in response to a request for location information from the Public Safety Answering Point device.

Method Embodiment 7A. The method of Method Embodiment 7, wherein said determination to share said location information for the first communications device with the Public Safety Answering Point device is made in the absence of consent from a user of the first communications device.

Method Embodiment 8. The method of Method Embodiment 3, wherein the first communications device is a first user equipment device (e.g., a first endpoint device such as for example a first smart phone being operated by a first user); wherein the second communications device is one of the following: a second user equipment device (e.g., a second endpoint device such as for example a second smartphone being operated by a second user), a government entity device (e.g., a PSAP entity device, a government emergency rescue entity device (e.g., a park ranger rescue entity device), law enforcement entity device)), a commercial entity device (e.g., network operations device (e.g., Operations Support Systems device requesting information on network conditions at various locations), a corporate entity device (e.g., a company entity device such as a gas station company (e.g., ExxonMobile) advertising location of its gas stations), a store entity device (e.g., Shoprite grocery store) advertising locations of its stories and items available, restaurant entity device advertising location and/or menu and/or availability, entertainment entity device (e.g., casino, theater, or theme park entity device) advertising entertainment available within a geographic region)).

Method Embodiment 9. The method of Method Embodiment 1, wherein the one or more RCS location sharing criteria include one or more RCS location sharing criteria based on one or more first communications device attributes.

Method Embodiment 10. The method of Method Embodiment 9, wherein the one or more first communications device attributes include one or more of the following: (i) power or battery level, (ii) received radio frequency power level (e.g., Reference Signal Received Power (RSRP) level), (iii) received radio frequency quality level (e.g., Reference Signal Received Quality (RSRQ), (iv) radio frequency channel quality, (v) type of data being shared during an RCS session, (vi) mobility state of the first communications device (e.g., stationary or moving), (vii) speed and/or direction of movement of first communications device, (viii) location of first communications device (e.g., type of environment in which the first communications device is located such as urban, suburban, or rural), (ix) accuracy of location information (e.g., GPS accuracy), and (x) Radio Resource Control state (e.g., connected, idle, idle-limited service).

Method Embodiment 11. The method of Method Embodiment 10, wherein the one or more RCS location sharing criteria include one or more RCS location sharing criteria based on one or more network attributes, said one or more network attributes including one or more of the following: a network identifier for a network to which the first communications device is connected, and (ii) a network type for the network to which the first communications device is connected.

Method Embodiment 11A. The method of Method Embodiment 11, wherein said one or more network attributes further include one or more of the following: (i) an amount of congestion being experienced by the network to which the first communications device is connected (e.g., as reported by a base station or other network entity of the network to the first communications device; or, as determined by the first communications device based on message delay or radio reference channel interference detected by the first communications device with respect to communications with the network to which it is connected), (ii) a network identifier for each network to which the first communications device has access, and (iii) a network type for each network to which the first communications device has access.

Method Embodiment 12. The method of Method Embodiment 11, wherein said determining, by the first communications device, whether or not to share said location information for the first communications device with a second communications device based on one or more Rich Communications Services (RCS) location sharing criteria includes: determining whether one or more RCS location sharing criteria have been met based on predetermined threshold values corresponding to the first communications device attributes (e.g., (i) power or battery threshold level (e.g., minimum power or battery threshold level to be met for location information sharing), (ii) received radio frequency power threshold level for which location information sharing (e.g., Reference Signal Received Power (RSRP) threshold level to be met for location information sharing), (iii) received radio frequency quality threshold level to be met for location information sharing (e.g., Reference Signal Received Quality (RSRQ) threshold level to be met for location information sharing), (iv) radio frequency channel quality threshold level to be met for location sharing, (v) speed threshold level to be met for location sharing).

Method Embodiment 13. The method of Method Embodiment 11, wherein said determining, by the first communications device, whether or not to share said location information for the first communications device with a second communications device based on one or more Rich Communications Services (RCS) location sharing criteria includes: generating a location information sharing score based on one or more or all of the first communications device attributes and/or the network attributes using numerical priority weighting for one or more or all of the first communications device attributes and/or the network attributes.

Method Embodiment 14. The method of Method Embodiment 13, wherein prior to generating a location information sharing score based on first communications device attributes and/or the network attributes using numerical priority weighting for one or more or all of the first communications device attributes and/or the network attributes: determining a numerical priority weighting factor for one or more or all of the first communications device attributes and/or the network attributes; and applying the numerical priority weighting factor to the first communications device attributes and/or network attributes for which the numerical priority weighting factor was determined.

Method Embodiment 15. The method of Method Embodiment 14, further comprising: determining to share location information for the first communications device with the second communications device when the location information sharing score is above a first location information sharing score threshold level or value; and determining not to share location information for the first communications device with the second communications device when the location information sharing score is not above the first location information sharing score threshold level or value.

Method Embodiment 16. The method of Method Embodiment 1, wherein said determining, by the first communications device, whether or not to share said location information for the first communications device with a second communications device based on one or more Rich Communications Services (RCS) location sharing criteria includes: determining to share said location information for the first communications device when a plurality of RCS location sharing criteria have been met, said plurality of RCS location sharing criteria including: (i) battery level of the first communications device is above a first battery threshold level, (ii) a first amount of time has passed since location information has been shared with the second communications device, (iii) location information for the first communications device has changed by a threshold amount since location information was last shared with the second communications device (e.g., a change in latitude by an amount greater than a latitude change threshold amount, a change in longitude by an amount greater than a longitude change threshold amount, and/or a change in altitude by an amount greater than an altitude change threshold amount).

Method Embodiment 16A. The method of Method Embodiment 16, wherein said plurality of RCS location sharing criteria further includes: a first RCS user profile entry in a RCS user profile included in the first communications device which indicates authorization to share location information (e.g., no restriction on location sharing to any entities, or location sharing authorized for the second communications device (e.g., identified by the second communications device contact information (e.g., telephone number or IP address corresponding to the second communications device) and/or identification information)).

Method Embodiment 16B. The method of Method Embodiment 16A, wherein said plurality of RCS location sharing criteria further includes: determining a network identifier for a network to which the first communications device is connected is included in a second RCS user profile entry of the RCS user profile included in the first communications device, said inclusion of the network identifier in the second RCS user profile entry indicating authorization for the network with the network identifier to be used for sharing of location information of the first communications device using RCS messaging.

Method Embodiment 16C. The method of Method Embodiment 16, further comprising: determining, by the first communications device, whether to utilize secure RCS message signaling for location information sharing or non-secure RCS message signaling based on RCS user profile information stored at the first communications device.

Method Embodiment 17. The method of Method Embodiment 1, further comprising: prior to determining, by the first communications device, whether or not to share said location information for the first communications device with a second communications device based on one or more Rich Communications Services (RCS) location sharing criteria, receiving at the first communications device user input from a first user of the first communications device; and generating a RCS user profile based on the received user input from the first user of the first communications device.

Method Embodiment 17A. The method of Method Embodiment 17, wherein said user input includes information for determining the type of location sharing to be performed by an RCS client application executing on the first communications device (e.g., no location information sharing, secure location information sharing to selected contact addresses, public location information sharing to any contact address).

Method Embodiment 17B. The method of Method Embodiment 17A, wherein said user input further includes Rich Communications Services (RCS) location sharing criteria information (e.g., battery power threshold level to be met for location sharing, network identity of each network which user authorizes for use for RCS location information sharing (or information indicating no restrictions on network identity for networks for use for RCS location information sharing), information on network type for each network type authorized for use for RCS location information sharing (or information indicating no restrictions on type of network to be used for RCS location information sharing), information on signaling strength threshold level(s) to be met for RCS location information sharing and/or signaling quality threshold level(s) to be met for RCS location information sharing).

Method Embodiment 17C. The method of Method Embodiment 17, wherein said user input further includes a set of Rich Communications Services (RCS) user location information sharing rules or policies to be applied in determining whether the first communications device is to share location information with one or more entities.

Method Embodiment 17D. The method of Method Embodiment 17C, wherein the first communications device receives (e.g., from a RCS application server or a network equipment device) a set of Rich Communications (RCS) network location information sharing rules or policies to also be applied in determining whether the first communications device is to share location information with one or more entities.

Method Embodiment 17E. The method of Method Embodiment 17D, wherein the first communications device also receives a set of public safety location information sharing rules or policies also to be applied in determining whether the first communications device is to share location information with one or more entities.

Method Embodiment 17F. The method of Method Embodiment 17E, wherein the set of public safety location sharing rules or polices have a higher priority than the set of RCS network location sharing rules or policies; wherein the set of RCS network location sharing rules or policies have a higher priority than the set of RCS user location sharing rules or policies; and wherein location information will be shared with the second communications device when a rule with the highest priority indicates that location information for the first communications device is to be shared with the second communications device (e.g., user rule indicates no sharing of location information when power below 50% and power is below 50%, network rule indicates no sharing of location information when network congestion is above a first network congestion threshold level and the network has reported that network congestion is above the first network congestion threshold, public safety rule indicates that location information for the first communications device is to be shared when initiating a RCS session with a PSAP entity device or receiving a request for updated location information from a PSAP entity device in such an exemplary scenario if the first communications device is initiating a RCS session with the second communications device which is a PSAP entity device or has received a request from the second communications device which is a PSAP entity device requesting location information, the first communications device will provide location information as the public safety location sharing rule has a higher priority than either the RCS user location sharing rule or the RCS network location sharing rule).

Method Embodiment 17G. The method of Method Embodiment 17E, wherein priority values are assigned to one or more or all RCS user location sharing rules or policies, public safety location information sharing rules or polices, and RCS network location information sharing rules or policies; and wherein the rule or policy with the highest assigned priority value is used to determine whether or not location information for the first communications device is to be shared with the second communications device.

Method Embodiment 17H. The method of Method Embodiment 17G, further comprising: automatically determining one or more or all RCS user location rules or policies, public safety location information sharing rules or polices, and network location information sharing rules or policies based on historical data.

Method Embodiment 17H1. The method of Method Embodiment 17G or Method Embodiment 17H, further comprising: automatically determining and/or updating one or more priority values assigned one or more or all RCS user location rules or policies, public safety location information sharing rules or polices, and network location information sharing rules or policies based on historical data.

Method Embodiment 17I. The method of Method Embodiment 17H or Method Embodiment 17H1, wherein said historical data includes information on the performance of the first communications device while utilizing RCS location information sharing services.

Method Embodiment 17I2. The method of Method Embodiment 17H, Method Embodiment 17H1, or Method Embodiment 17I, wherein said historical data includes information on the performance of other communications devices while utilizing RCS location information sharing services and/or performance of a network while other communications devices are utilizing RCS location information sharing services (e.g., determining and/or updating threshold values for signaling strength, signaling quality, channel quality, minimum power, network congestion, etc. based on historical data and/or determining and/or updating rules and/or policies to optimize user RCS location sharing performance and/or experience).

### List of Exemplary Numbered Apparatus Embodiments

Apparatus Embodiment 1. A first communications device comprising: memory; and a processor that controls the first communications device to perform the following operations: generating, at the first communications device, location information for the first communications device; and determining, by the first communications device, whether or not to share said location information for the first communications device with a second communications device based on one or more Rich Communications Services (RCS) location sharing criteria.

Apparatus Embodiment 1A. The first communications device of Apparatus Embodiment 1, wherein the processor further controls the first communications device to perform the following additional operations: detecting an occurrence of an event at the first communications device; and in response to detecting the occurrence of the event at the first communications device, performing said operation of determining, by the first communications device, whether or not to share said location information for the first communications device with a second communications device based on one or more Rich Communications Services (RCS) location sharing criteria.

Apparatus Embodiment 1B. The first communications device of Apparatus Embodiment 1A, wherein the event is one of the following: (i) initiation of RCS registration of the first communications device with the second communications device, (ii) initiation of an RCS session between the first communications device and the second communications device, (iii) receipt of user input at the first communications device indicating a request to share location information for the first communications device with the second communications device, (iv) expiration of a periodic timer (e.g., during a RCS session between the first communications device and the second communications device), (v) receipt of a request at the first communications for location information for the first communications device from the second communications device, (vi) detection of a change in one or more device attributes for the first communications device (e.g., a change above a device attribute threshold level or value for the device attribute of the first device such as a device attribute of speed for the first device having a value greater than a device speed threshold value), (vii) detection of a change in one or more network attributes.

Apparatus Embodiment 1C. The first communications device of Apparatus Embodiment 1B, wherein the one or more first communications device attributes include one or more of the following: (i) power or battery level, (ii) received radio frequency power level (e.g., Reference Signal Received Power (RSRP) level), (iii) received radio frequency quality level (e.g., Reference Signal Received Quality (RSRQ), (iv) radio frequency channel quality, (v) type of data being shared during an RCS session, (vi) mobility state of the first communications device (e.g., stationary or moving), (vii) speed and/or direction of movement of first communications device, (viii) location of the first communications device (e.g., type of environment in which the first communications device is located such as urban, suburban, or rural), (ix) change in location of the first communications device, (x) accuracy of location information (e.g., GPS accuracy), and (xi) Radio Resource Control state (e.g., connected, idle, idle-limited service).

Apparatus Embodiment 2. The first communications device of Apparatus Embodiment 1, wherein said generating, at the first communications device, location information for the first communications device includes: generating Global Position System (GPS) coordinates for the location of the first communications device.

Apparatus Embodiment 2A. The first communications device of Apparatus Embodiment 1, wherein said generating location information for the first communications device further includes: using the generated GPS coordinates to identify one or more of the following: (i) an address (e.g., street address) at which the first communications device is located, or (ii) map coordinates at which the first communications device is located.

Apparatus Embodiment 2B. The first communications device of Apparatus Embodiment 1, wherein said generating location information for the first communications device further includes: generating an image of a map with an identifier (e.g., mark such as a cross or an X or an icon) indicating the location of the first communications device.

Apparatus Embodiment 2C. The first communications device of Apparatus Embodiment 1, wherein said location information for the first communications device includes one or more of the following: (i) Global Position System coordinates for the first communications device, (ii) latitude and longitude information for the first communications device, (iii) latitude, longitude and altitude information for the first communications device, (iv) a street address at which the first communications device is located, (v) map coordinates for first communications device, (vi) an image of a map with an identifier indicating where on the map the first communications device is located, and (vii) a city, state, and country at which the first communications device is located.

Apparatus Embodiment 3. The first communications device of Apparatus Embodiment 2, wherein the processor further controls the first communications device to perform the following additional operation: sharing said location information with said second communications device using Rich Communications Services messaging in response to determining, by the first communications device, to share said location information for the first communications device with the second communications device based on said one or more Rich Communications Services (RCS) location sharing criteria.

Apparatus Embodiment 3A. The first communications device of Apparatus Embodiment 3, wherein the processor further controls the first communications device to perform the following additional operation: encrypting, by the first communications device, said location information for the first communications device, prior to sharing said location information of the first communications device with the second communications device.

Apparatus Embodiment 3B. The first communications device of Apparatus Embodiment 3A, wherein the processor further controls the first communications device to perform the following additional operation prior to the first communications device encrypting said location information for the first communications device: determining that a first setting in an RCS user profile at the first communications device indicates that location information is not to be publicly shared (e.g., secure or non-public information sharing is indicated) or indicates that location information is to be encrypted (e.g., secure location information sharing is indicated).

Apparatus Embodiment 4. The first communications device of Apparatus Embodiment 3, wherein said operation of determining, by the first communications device, whether or not to share said location information for the first communications device with a second communications device based on one or more Rich Communications Services (RCS) location sharing criteria is performed by a RCS client application executing on the first communications device; and wherein said sharing said location information with said second communications device using Rich Communications Services messaging includes: generating by the RCS client application one or more RCS messages and communicating (e.g., transmitting) said one or more RCS messages to a RCS application server for delivery to the second communications device, said one or more RCS messages including said location information for the first communications device.

Apparatus Embodiment 4A. The first communications device of Apparatus Embodiment 4, wherein said one or more generated RCS messages are one or more Session Initiation Protocol (SIP) messages.

Apparatus Embodiment 4B. The first communications device of Apparatus Embodiment 4A, wherein said one or more SIP messages is a first SIP message; and wherein said location information for the first communications device is included in a SIP header of the first SIP message.

Apparatus Embodiment 4C. The first communications device of Apparatus Embodiment 4A, wherein said one or more SIP messages is a first SIP message, said first SIP message being a SIP Message Method message; and wherein said location information for the first communications device is included in a message body portion of the first SIP Message Method message.

Apparatus Embodiment 4D. The first communications device of Apparatus Embodiment 4, wherein said one or more generated RCS messages is a Message Session Relay Protocol (MSRP) message; and wherein said location information for the first communications device is included in a message body portion of the Message Session Relay Protocol message.

Apparatus Embodiment 5. The first communications device of Apparatus Embodiment 4, wherein said one or more RCS location sharing criteria include at least one of the following: a public safety policy criteria, a network policy criteria, or a user specified policy criteria.

Apparatus Embodiment 6. The first communications device of Apparatus Embodiment 5, wherein the one or more RCS location sharing criteria include a public safety policy criteria, a network policy criteria, and a user specified policy criteria; wherein the processor further controls the first communications device to perform the following additional operation: applying by the RCS client application a different priority weighting factor to each of the public safety policy criteria (e.g., priority weighting factor of 1), the network policy criteria (e.g., priority weighting factor of 0.5), and the user specified policy criteria (e.g., priority weighting factor of 0.7); and wherein said determining, by the first communications device, whether or not to share said location information for the first communications device with the second communications device based on one or more Rich Communications Services (RCS) location sharing criteria includes: determining which policy criteria from the public safety policy criteria, the network policy criteria, and the user specified policy criteria has the highest priority weighting factor (e.g., public safety policy criteria which has a priority weighting of 1); and making the determination to share the location information for the first communications device with the second communications device when the criteria for the determined policy criteria with the highest priority weighting factor has been met.

Apparatus Embodiment 6A. The first communications device of Apparatus Embodiment 6, wherein the public safety policy criteria is met when the second communications device is a government safety entity device.

Apparatus Embodiment 6B. The first communications device of Apparatus Embodiment 6, wherein the public safety policy criteria includes determining whether the second communications device is a government safety entity device; wherein the network policy criteria includes determining the identity of the network to which the first communications device is connected and only sharing location information when connected to a network having a first network identity; and wherein the user specified policy criteria includes only sharing location information on initial RCS session establishment.

Apparatus Embodiment 7. The first communications device of Apparatus Embodiment 5, wherein said second communications device is a Public Safety Answering Point device requesting location information for the first communications device; wherein said one or more RCS location sharing criteria include a public safety policy criteria, said public safety policy criteria including sharing said location information for the first communications device with any Public Safety Answering Point device requesting location information for the first communications device; and wherein said determining, by the first communications device, whether or not to share said location information for the first communications device with the second communications device based on one or more Rich Communications Services (RCS) location sharing criteria includes: making a determination to share said location information for the first communications device with the Public Safety Answering Point device in response to a request for location information from the Public Safety Answering Point device.

Apparatus Embodiment 7A. The first communications device of Apparatus Embodiment 7, wherein said determination to share said location information for the first communications device with the Public Safety Answering Point device is made in the absence of consent from a user of the first communications device.

Apparatus Embodiment 8. The first communications device of Apparatus Embodiment 3, wherein the first communications device is a first user equipment device (e.g., a first endpoint device such as for example a first smart phone being operated by a first user); wherein the second communications device is one of the following: a second user equipment device (e.g., a second endpoint device such as for example a second smartphone being operated by a second user), a government entity device (e.g., a PSAP entity device, a government emergency rescue entity device (e.g., a park ranger rescue entity device), law enforcement entity device)), a commercial entity device (e.g., network operations device (e.g., Operations Support Systems device requesting information on network conditions at various locations), a corporate entity device (e.g., a company entity device such as a gas station company (e.g., Shell) advertising location of its gas stations), a store entity device (e.g., Shoprite grocery store) advertising locations of its stories and items available, restaurant entity device advertising location and/or menu and/or availability, entertainment entity device (e.g., casino, theater, or theme park entity device) advertising entertainment available within a geographic region)).

Apparatus Embodiment 9. The first communications device of Apparatus Embodiment 1, wherein the one or more RCS location sharing criteria include one or more RCS location sharing criteria based on one or more first communications device attributes.

Apparatus Embodiment 10. The first communications device of Apparatus Embodiment 9, wherein the one or more first communications device attributes include one or more of the following: (i) power or battery level, (ii) received radio frequency power level (e.g., Reference Signal Received Power (RSRP) level), (iii) received radio frequency quality level (e.g., Reference Signal Received Quality (RSRQ), (iv) radio frequency channel quality, (v) type of data being shared during a RCS session, (vi) mobility state of the first communications device (e.g., stationary or moving), (vii) speed and/or direction of movement of first communications device, (viii) location of first communications device (e.g., type of environment in which the first communications device is located such as urban, suburban, or rural), (ix) accuracy of location information (e.g., GPS accuracy), and (x) Radio Resource Control state (e.g., connected, idle, idle-limited service).

Apparatus Embodiment 11. The first communications device of Apparatus Embodiment 10, wherein the one or more RCS location sharing criteria include one or more RCS location sharing criteria based on one or more network attributes, said one or more network attributes including one or more of the following: a network identifier for a network to which the first communications device is connected, and (ii) a network type for the network to which the first communications device is connected.

Apparatus Embodiment 11A. The first communications device of Apparatus Embodiment 11, wherein said one or more network attributes further include one or more of the following: (i) an amount of congestion being experienced by the network to which the first communications device is connected (e.g., as reported by a base station or other network entity of the network to the first communications device; or, as determined by the first communications device based on message delay or radio reference channel interference detected by the first communications device with respect to communications with the network to which it is connected), (ii) a network identifier for each network to which the first communications device has access, and (iii) a network type for each network to which the first communications device has access.

Apparatus Embodiment 12. The first communications device of Apparatus Embodiment 11, wherein said determining, by the first communications device, whether or not to share said location information for the first communications device with a second communications device based on one or more Rich Communications Services (RCS) location sharing criteria includes: determining whether one or more RCS location sharing criteria have been met based on predetermined threshold values corresponding to the first communications device attributes (e.g., (i) power or battery threshold level (e.g., minimum power or battery threshold level to be met for location information sharing), (ii) received radio frequency power threshold level for which location information sharing (e.g., Reference Signal Received Power (RSRP) threshold level to be met for location information sharing), (iii) received radio frequency quality threshold level to be met for location information sharing (e.g., Reference Signal Received Quality (RSRQ) threshold level to be met for location information sharing), (iv) radio frequency channel quality threshold level to be met for location sharing, (v) speed threshold level to be met for location sharing).

Apparatus Embodiment 13. The first communications device of Apparatus Embodiment 11, wherein said determining, by the first communications device, whether or not to share said location information for the first communications device with a second communications device based on one or more Rich Communications Services (RCS) location sharing criteria includes: generating a location information sharing score based on one or more or all of the first communications device attributes and/or the network attributes using numerical priority weighting for one or more or all of the first communications device attributes and/or the network attributes.

Apparatus Embodiment 14. The first communications device of Apparatus Embodiment 13, wherein prior to generating a location information sharing score based on first communications device attributes and/or the network attributes using numerical priority weighting for one or more or all of the first communications device attributes and/or the network attributes: determining a numerical priority weighting factor for one or more or all of the first communications device attributes and/or the network attributes; and applying the numerical priority weighting factor to the first communications device attributes and/or network attributes for which the numerical priority weighting factor was determined.

Apparatus Embodiment 15. The first communications device of Apparatus Embodiment 14, wherein the processor further controls the first communications device to perform the following additional operations: determining to share location information for the first communications device with the second communications device when the location information sharing score is above a first location information sharing score threshold level or value; and determining not to share location information for the first communications device with the second communications device when the location information sharing score is not above the first location information sharing score threshold level or value.

Apparatus Embodiment 16. The first communications device of Apparatus Embodiment 1, wherein said determining, by the first communications device, whether or not to share said location information for the first communications device with a second communications device based on one or more Rich Communications Services (RCS) location sharing criteria includes: determining to share said location information for the first communications device when a plurality of RCS location sharing criteria have been met, said plurality of RCS location sharing criteria including: (i) battery level of the first communications device is above a first battery threshold level, (ii) a first amount of time has passed since location information has been shared with the second communications device, (iii) location information for the first communications device has changed by a threshold amount since location information was last shared with the second communications device (e.g., a change in latitude by an amount greater than a latitude change threshold amount, a change in longitude by an amount greater than a longitude change threshold amount, and/or a change in altitude by an amount greater than an altitude change threshold amount).

Apparatus Embodiment 16A. The first communications device of Apparatus Embodiment 16, wherein said plurality of RCS location sharing criteria further includes: a first RCS user profile entry in a RCS user profile included in the first communications device which indicates authorization to share location information (e.g., no restriction on location sharing to any entities, or location sharing authorized for the second communications device (e.g., identified by the second communications device contact information (e.g., telephone number or IP address corresponding to the second communications device) and/or identification information)).

Apparatus Embodiment 16B. The first communications device of Apparatus Embodiment 16A, wherein said plurality of RCS location sharing criteria further includes: determining a network identifier for a network to which the first communications device is connected is included in a second RCS user profile entry of the RCS user profile included in the first communications device, said inclusion of the network identifier in the second RCS user profile entry indicating authorization for the network with the network identifier to be used for sharing of location information of the first communications device using RCS messaging.

Apparatus Embodiment 16C. The first communications device of Apparatus Embodiment 16, wherein the processor further controls the first communications device to perform the following additional operation: determining, by the first communications device, whether to utilize secure RCS message signaling for location information sharing or non-secure RCS message signaling based on RCS user profile information stored at the first communications device.

Apparatus Embodiment 17. The first communications device of Apparatus Embodiment 1, wherein the processor further controls the first communications device to perform the following additional operations prior to determining, by the first communications device, whether or not to share said location information for the first communications device with a second communications device based on one or more Rich Communications Services (RCS) location sharing criteria: receiving at the first communications device user input from a first user of the first communications device; and generating a RCS user profile based on the received user input from the first user of the first communications device.

Apparatus Embodiment 17A. The first communications device of Apparatus Embodiment 17, wherein said user input includes information for determining the type of location sharing to be performed by a RCS client application executing on the first communications device (e.g., no location information sharing, secure location information sharing to selected contact addresses, public location information sharing to any contact address).

Apparatus Embodiment 17B. The first communications device of Apparatus Embodiment 17A, wherein said user input further includes Rich Communications Services (RCS) location sharing criteria information (e.g., battery power threshold level to be met for location sharing, network identity of each network which user authorizes for use for RCS location information sharing (or information indicating no restrictions on network identity for networks for use for RCS location information sharing), information on network type for each network type authorized for use for RCS location information sharing (or information indicating no restrictions on type of network to be used for RCS location information sharing), information on signaling strength threshold level(s) to be met for RCS location information sharing and/or signaling quality threshold level(s) to be met for RCS location information sharing).

Apparatus Embodiment 17C. The first communications device of Apparatus Embodiment 17, wherein said user input further includes a set of Rich Communications Services (RCS) user location information sharing rules or policies to be applied in determining whether the first communications device is to share location information with one or more entities.

Apparatus Embodiment 17D. The first communications device of Apparatus Embodiment 17C, wherein the first communications device receives (e.g., from a RCS application server or a network equipment device) a set of Rich Communications (RCS) network location information sharing rules or policies to also be applied in determining whether the first communications device is to share location information with one or more entities.

Apparatus Embodiment 17E. The first communications device of Apparatus Embodiment 17D, wherein the first communications device also receives a set of public safety location information sharing rules or policies also to be applied in determining whether the first communications device is to share location information with one or more entities.

Apparatus Embodiment 17F. The first communications device of Apparatus Embodiment 17E, wherein the set of public safety location sharing rules or polices have a higher priority than the set of RCS network location sharing rules or policies; wherein the set of RCS network location sharing rules or policies have a higher priority than the set of RCS user location sharing rules or policies; and wherein location information will be shared with the second communications device when a rule with the highest priority indicates that location information for the first communications device is to be shared with the second communications device (e.g., user rule indicates no sharing of location information when power below 50% and power is below 50%, network rule indicates no sharing of location information when network congestion is above a first network congestion threshold level and the network has reported that network congestion is above the first network congestion threshold, public safety rule indicates that location information for the first communications device is to be shared when initiating a RCS session with a PSAP entity device or receiving a request for updated location information from a PSAP entity device in such an exemplary scenario if the first communications device is initiating a RCS session with the second communications device which is a PSAP entity device or has received a request from the second communications device which is a PSAP entity device requesting location information, the first communications device will provide location information as the public safety location sharing rule has a higher priority than either the RCS user location sharing rule or the RCS network location sharing rule).

Apparatus Embodiment 17G. The first communications device of Apparatus Embodiment 17E, wherein priority values are assigned to one or more or all RCS user location sharing rules or policies, public safety location information sharing rules or polices, and RCS network location information sharing rules or policies; and wherein the rule or policy with the highest assigned priority value is used to determine whether or not location information for the first communications device is to be shared with the second communications device.

Apparatus Embodiment 17H. The first communications device of Apparatus Embodiment 17G, wherein the processor further controls the first communications device to perform the following additional operation: automatically determining one or more or all RCS user location rules or policies, public safety location information sharing rules or polices, and network location information sharing rules or policies based on historical data.

Apparatus Embodiment 17H1. The first communications device of Apparatus Embodiment 17G or Apparatus Embodiment 17H, wherein the processor further controls the first communications device to perform the following additional operation: automatically determining and/or updating one or more priority values assigned one or more or all RCS user location rules or policies, public safety location information sharing rules or polices, and network location information sharing rules or policies based on historical data.

Apparatus Embodiment 17I. The first communications device of Apparatus Embodiment 17H or Apparatus Embodiment 17H1, wherein said historical data includes information on the performance of the first communications device while utilizing RCS location information sharing services.

Apparatus Embodiment 17I2. The first communications device of Apparatus Embodiment 17H, Apparatus Embodiment 17H1, or Apparatus Embodiment 17I, wherein said historical data includes information on the performance of other communications devices while utilizing RCS location information sharing services and/or performance of a network while other communications devices are utilizing RCS location information sharing services (e.g., determining and/or updating threshold values for signaling strength, signaling quality, channel quality, minimum power, network congestion, etc. based on historical data and/or determining and/or updating rules and/or policies to optimize user RCS location sharing performance and/or experience).

### List of Exemplary Numbered Non-transitory Computer Readable Medium Embodiments

Non-transitory Computer Readable Medium Embodiment 1. A non-transitory computer readable medium including a first set of computer executable instructions which when executed by a processor of a first communications device cause the first communications device to perform the steps of: generating location information for the first communications device; and determining whether or not to share said location information for the first communications device with a second communications device based on one or more Rich Communications Services (RCS) location sharing criteria.

The techniques of various embodiments may be implemented using software, hardware and/or a combination of software and hardware. Various embodiments are directed to apparatus, e.g., communications devices, wireless base stations, wireless access points, Wi-Fi Access Points, wireless devices, mobile terminals, network equipment, eNBs, gNBs, location database system, message data system, smart devices, user equipment devices, user devices, computers, smartphones, subscriber devices, government entity devices, PSAP entity devices, commercial entity devices, Operations Support Systems devices, Rich Communications Service application servers, servers, nodes, and/or elements. Various embodiments are also directed to machine, e.g., computer, readable medium, e.g., ROM, RAM, CDs, hard discs, etc., which include machine readable instructions for controlling a machine to implement one or more steps of a method. The computer readable medium is, e.g., non-transitory computer readable medium.

It is understood that the specific order or hierarchy of steps in the processes and methods disclosed is an example of exemplary approaches. Based upon design preferences, it is understood that the specific order or hierarchy of steps in the processes and methods may be rearranged while remaining within the scope of the present disclosure. The accompanying method claims present elements of the various steps in a sample order, and are not meant to be limited to the specific order or hierarchy presented. In some embodiments, one or more processors are used to carry out one or more steps of the each of the described methods.

In various embodiments each of the steps or elements of a method are implemented using one or more processors. In some embodiments, each of elements or steps are implemented using hardware circuitry.

In various embodiments devices, e.g., communications devices, wireless base stations, wireless access points, Wi-Fi Access Points, wireless devices, mobile terminals, network equipment, eNBs, gNBs, location database system, message data system, smart devices, user equipment devices, user devices, computers, smartphones, subscriber devices, government entity devices, PSAP entity devices, commercial entity devices, Operations Support Systems devices, Rich Communications Service application servers, servers, nodes, and/or elements described herein are implemented using one or more components to perform the steps corresponding to one or more methods, for example, generating or creating messages, implementing RCS sessions, connections, message reception, message transmission, switching modes, signal processing, sending, comparing, determining and/or transmission steps. Thus, in some embodiments various features are implemented using components or in some embodiments logic such as for example logic circuits. Such components may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more devices, servers, nodes and/or elements. Accordingly, among other things, various embodiments are directed to a machine-readable medium, e.g., a non-transitory computer readable medium, including machine executable instructions for causing a machine, e.g., processor and associated hardware, to perform one or more of the steps of the above-described method(s). Some embodiments are directed to a device, e.g., a controller, including a processor configured to implement one, multiple or all of the steps of one or more methods of the invention.

In some embodiments, the processor or processors, e.g., CPUs, of one or more devices, e.g., communications devices, wireless base stations, wireless access points, Wi-Fi Access Points, wireless devices, mobile terminals, network equipment, eNBs, gNBs, location database system, message data system, smart devices, user equipment devices, user devices, computers, smartphones, subscriber devices, government entity devices, PSAP entity devices, commercial entity devices, Operations Support Systems devices, Rich Communications Service application servers, servers, nodes, and/or elements. The configuration of the processor may be achieved by using one or more components, e.g., software components, to control processor configuration and/or by including hardware in the processor, e.g., hardware components, to perform the recited steps and/or control processor configuration. Accordingly, some but not all embodiments are directed to a device, e.g., communications devices, wireless base stations, wireless access points, Wi-Fi Access Points, wireless devices, mobile terminals, network equipment, eNBs, gNBs, location database system, message data system, smart devices, user equipment devices, user devices, computers, smartphones, subscriber devices, government entity devices, PSAP entity devices, commercial entity devices, Operations Support Systems devices, Rich Communications Service application servers, servers, nodes, and/or elements, with a processor which includes a component corresponding to each of the steps of the various described methods performed by the device in which the processor is included. In some but not all embodiments a device, e.g., communications devices, wireless base stations, wireless access points, Wi-Fi Access Points, wireless devices, mobile terminals, network equipment, eNBs, gNBs, location database system, message data system, smart devices, user equipment devices, user devices, computers, smartphones, subscriber devices, government entity devices, PSAP entity devices, commercial entity devices, Operations Support Systems devices, Rich Communications Service application servers, servers, nodes, and/or elements, includes a controller corresponding to each of the steps of the various described methods performed by the device in which the processor is included. The components may be implemented using software and/or hardware.

Some embodiments are directed to a computer program product comprising a computer-readable medium, e.g., a non-transitory computer-readable medium, comprising code for causing a computer, or multiple computers, to implement various functions, steps, acts and/or operations, e.g., one or more steps described above. Depending on the embodiment, the computer program product can, and sometimes does, include different code for each step to be performed. Thus, the computer program product may, and sometimes does, include code for each individual step of a method, e.g., a method of controlling a device, e.g., communications devices, wireless base stations, wireless access points, Wi-Fi Access Points, wireless devices, mobile terminals, network equipment, eNBs, gNBs, location database system, message data system, smart devices, user equipment devices, user devices, computers, smartphones, subscriber devices, government entity devices, PSAP entity devices, commercial entity devices, Operations Support Systems devices, Rich Communications Service application servers, servers, nodes, and/or elements. The code may be in the form of machine, e.g., computer, executable instructions stored on a computer-readable medium, e.g., a non-transitory computer-readable medium, such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a communications device such as a communications devices, wireless base stations, wireless access points, Wi-Fi Access Points, wireless devices, mobile terminals, network equipment, eNBs, gNBs, location database system, message data system, smart devices, user equipment devices, user devices, computers, smartphones, subscriber devices, government entity devices, PSAP entity devices, commercial entity devices, Operations Support Systems devices, Rich Communications Service application servers, servers, nodes, and/or elements or other device described in the present application.

Numerous additional variations on the methods and apparatus of the various embodiments described above will be apparent to those skilled in the art in view of the above description. Such variations are to be considered within the scope. Numerous additional embodiments, within the scope of the present invention, will be apparent to those of ordinary skill in the art in view of the above description and the claims which follow. Such variations are to be considered within the scope of the invention.

What is claimed is:

1. A method comprising:
generating, at a first communications device, location information for the first communications device; and
determining, by the first communications device, whether or not to share said location information for the first communications device with a second communications device based on one or more Rich Communications Services (RCS) location sharing criteria.

2. The method of claim 1, further comprising:
detecting the occurrence of an event at the first communications device; and
in response to detecting the occurrence of the event at the first communications device, performing said operation of determining, by the first communications device, whether or not to share said location information for the first communications device with a second communications device based on one or more Rich Communications Services (RCS) location sharing criteria.

3. The method of claim 2, wherein the event is one of the following: (i) initiation of RCS registration of the first communications device with the second communications device, (ii) initiation of a RCS session between the first communications device and the second communications device, (iii) receipt of user input at the first communications device indicating a request to share location information for the first communications device with the second communications device, (iv) expiration of a periodic timer, (v) receipt of a request at the first communications for location information for the first communications device from the second communications device, (vi) detection of a change in one or more device attributes for the first communications device, and (vii) detection of a change in one or more network attributes.

4. The method of claim 3, wherein the one or more first communications device attributes include one or more of the following: (i) power or battery level, (ii) received radio frequency power level, (iii) received radio frequency quality level, (iv) radio frequency channel quality, (v) type of data being shared during a RCS session, (vi) mobility state of the first communications device, (vii) speed of movement of the first communications device, (viii) location of the first communications device, (ix) change in location of the first communications device, (x) accuracy of location information, and (xi) Radio Resource Control state.

5. The method of claim 1,
wherein generating, at the first communications device, location information for the first communications device includes: generating Global Position System (GPS) coordinates for the location of the first communications device.

6. The method of claim 5, further comprising:
sharing said location information with said second communications device using Rich Communications Services messaging in response to determining, by the first communications device, to share said location information for the first communications device with the second communications device based on said one or more Rich Communications Services (RCS) location sharing criteria.

7. The method of claim 6, further comprising:
encrypting, by the first communications device, said location information for the first communications device prior to sharing said location information of the first communications device with the second communications device.

8. The method of claim 6,
wherein said operation of determining, by the first communications device, whether or not to share said location information for the first communications device with a second communications device based on one or more Rich Communications Services (RCS) location sharing criteria is performed by a RCS client application executing on the first communications device; and
wherein said sharing said location information with said second communications device using Rich Communications Services messaging includes: generating by the RCS client application one or more RCS messages and communicating said one or more RCS messages to a RCS application server for delivery to the second communications device, said one or more RCS messages including said location information for the first communications device.

9. The method of claim 8,
wherein the one or more RCS location sharing criteria include a public safety policy criteria, a network policy criteria, and a user specified policy criteria;
wherein the method further comprises:
applying by the RCS client application a different priority weighting factor to each of the public safety policy criteria, the network policy criteria, and the user specified policy criteria; and
wherein said determining, by the first communications device, whether or not to share said location information for the first communications device with the second communications device based on one or more Rich Communications Services (RCS) location sharing criteria includes:
determining which policy criteria from the public safety policy criteria, the network policy criteria, and the user specified policy criteria has the highest priority weighting factor; and
making the determination to share the location information for the first communications device with the second communications device when the criteria for the determined policy criteria with the highest priority weighting factor has been met.

10. The method of claim 1,
wherein the one or more RCS location sharing criteria include one or more RCS location sharing criteria based on one or more first communications device attributes.

11. The method of claim 10,
wherein the one or more RCS location sharing criteria further include one or more RCS location sharing criteria based on one or more network attributes, said one or more network attributes including one or more of the following: a network identifier for a network to which the first communications device is connected, and (ii) a network type for the network to which the first communications device is connected.

12. The method of claim 11,
wherein said determining, by the first communications device, whether or not to share said location information for the first communications device with a second communications device based on one or more Rich Communications Services (RCS) location sharing criteria includes:
determining whether one or more RCS location sharing criteria have been met based on predetermined threshold values corresponding to the first communications device attributes.

13. The method of claim 11,
wherein said determining, by the first communications device, whether or not to share said location information for the first communications device with a second communications device based on one or more Rich Communications Services (RCS) location sharing criteria includes:
generating a location information sharing score based on one or more or all of the first communications device attributes using numerical priority weighting for one or more or all of the first communications device attributes and the network attributes.

14. A first communications device comprising:
memory; and
a processor that controls the first communications device to perform the following operations:
generating, at the first communications device, location information for the first communications device; and
determining, by the first communications device, whether or not to share said location information for the first communications device with a second communications device based on one or more Rich Communications Services (RCS) location sharing criteria.

15. The first communications device of claim 14, wherein the processor further controls the first communications device to perform the following additional operations:
detecting an occurrence of an event at the first communications device; and
in response to detecting the occurrence of the event at the first communications device, performing said operation of determining, by the first communications device, whether or not to share said location information for the first communications device with a second communications device based on one or more Rich Communications Services (RCS) location sharing criteria.

16. The first communications device of claim 15, wherein the event is one of the following: (i) initiation of RCS registration of the first communications device with the second communications device, (ii) initiation of a RCS session between the first communications device and the second communications device, (iii) receipt of user input at the first communications device indicating a request to share location information for the first communications device with the second communications device, (iv) expiration of a periodic timer, (v) receipt of a request at the first communications for location information for the first communications device from the second communications device, (vi) detection of a change in one or more device attributes for the first communications device, and (vii) detection of a change in one or more network attributes.

17. The first communications device of claim 16, wherein the one or more first communications device attributes include one or more of the following: (i) power or battery level, (ii) received radio frequency power level, (iii) received radio frequency quality level, (iv) radio frequency channel quality, (v) type of data being shared during a RCS session, (vi) mobility state of the first communications device, (vii) speed of movement of the first communications device, (viii) location of the first communications device, (ix) change in location of the first communications device, (x) accuracy of location information, and (xi) Radio Resource Control state.

18. The first communications device of claim 14,
wherein said generating, at the first communications device, location information for the first communications device includes: generating Global Position System (GPS) coordinates for the location of the first communications device.

19. The first communications device of claim 18, wherein the processor further controls the first communications device to perform the following additional operation:
sharing said location information with said second communications device using Rich Communications Services messaging in response to determining, by the first communications device, to share said location information for the first communications device with the second communications device based on said one or more Rich Communications Services (RCS) location sharing criteria.

20. A non-transitory computer readable medium including a first set of computer executable instructions which when executed by a processor of a first communications device cause the first communications device to perform the steps of:
generating location information for the first communications device; and
determining whether or not to share said location information for the first communications device with a second communications device based on one or more Rich Communications Services (RCS) location sharing criteria.
